(19) United States
(12) Patent Application Publication
(10) Pub. No.: US 2005/0018882 A1
(43) Pub. Date: Jan. 27, 2005

(54) Controlled surface wave image velocimetry

(75) Inventors: Marian Muste, Iowa City, IA (US); Jean-Dominique Creutin, Grenoble (FR); Jorg Schone, Leipzig (DE)

Correspondence Address: MCKEE, VOORHEES & SEASE, P.L.C., 801 GRAND AVENUE, SUITE 3200, DES MOINES, IA, 50309-2721, US

(73) Assignee: Iowa University Research Foundation, Iowa City, IA (US)

(21) Appl. No.: 10/879,646

(22) Filed: Jun. 29, 2004

Related U.S. Application Data
(60) Provisional application No. 60/484,017, filed on Jun. 30, 2003.

(51) Int. Cl. G06K 9/00

(52) U.S. Cl. 382/107

(57) ABSTRACT

An apparatus, method, and system of gathering information useful to derive the velocity of the free surface liquid flow in an open channel flow. The method involves recording successive images of controlled surface waves on the open channel flow with sufficient resolution to derive spread of fronts of the controlled surface waves, using image velocimetry to derive celerity of controlled surface waves, and inferring the velocity vector field of the underlying liquid flow using wave theory elements or calibrations. An apparatus according to one aspect of the invention uses an artificial nonintrusive mechanism to set up the controlled surface waves, uses artificial light to illuminate the controlled surface wave to accentuate its affronts, digital camera to capture the successive images. Software can be used to utilizes image velocimetry and to infer the velocity vector field.

### RELATION TO PRIOR APPLICATION

This application is related under 35 U.S.C. §119(e) and claims priority to U.S. provisional application Ser. No. 60/484,017, filed Jun. 30, 2003.

### INCORPORATION BY REFERENCE

The contents of U.S. provisional application Ser. No. 60/484,017, filed Jun. 30, 2003, is incorporated by reference herein in their entirety.

### I. BACKGROUND OF THE INVENTION

A. Field of the Invention

The present invention relates to a method, apparatus and system to measure the total free-surface velocity vector field of a moving body of liquid in field and laboratory conditions.

B. Problems in the Art

A need exists for effective and efficient nonintrusive measurement or monitoring of velocities of free surface flows. Benefits exist in at least industrial, environmental, and research contexts.

A variety of methodologies have been developed towards this end for measurement of flow velocities in a body of moving liquid. However, many are labor intensive and cumbersome. Many are usable only in a narrow set of circumstances. Many also lack accuracy or reliability. Most of the existing methods cannot measure the velocity at the free surface.

Recently, some fairly technical systems have been developed for measurement of free-surface velocities. Examples are well known in the art and include particle image velocimetry (PIV) and large scale particle image velocimetry (LSPIV). In these methods, physical particles or markers are distributed into the fluid flow. Images of the particles are recorded and software utilized to evaluate the images. Essentially, the software evaluates successive images to derive displacement of a particle or particles in the flow over time. This information allows derivation of velocity of the particle or particles, and thus determination of velocity magnitude and direction of fluid flow.

While this technology has been used and is well known, problems and deficiencies still exist. Examples of such problems and deficiencies are discussed further herein.

For example, the PIV and LSPIV methodologies are quasi-intrusive. They require introduction of foreign particles into the fluid flow to visualize the flow motion. Those methodologies tend to add complexity, are relatively expensive, and labor intensive. They require substantial resources to set up. Furthermore, they have limitations regarding efficacy, particularly regarding slow flows or shallow flows. They are also difficult to apply to large parts of flow fields.

### II. SUMMARY OF THE INVENTION

It is therefore a principle object, feature, aspect and/or advantage of the present invention to provide an apparatus, method, and system for what will be called controlled surface wave image velocimetry which solves or improves over problems and deficiencies in the art. Further objects, features, aspects and/or advantages of the present invention include an apparatus, method, and system as above described which:
a. Can be non-intrusive to the flow;
b. Is effective for complicated flows;
c. Allows measurement of large parts of flow fields;
d. Allows for a variety of measurements and derivations;
e. Is relatively inexpensive and non-complex;
f. Is easy to set up, operate, and maintain;
g. Is flexible and adaptable to a variety of applications and contexts;
h. Is stand-alone, relatively efficient and cost effective; and/or
i. Can take many forms and embodiments.

An apparatus, system, and method according to the present invention includes deriving the velocity vector field of a free surface flow of fluid by creating controlled surface waves on the free surface of an open channel flow that move with the velocity of the underlying flow. Velocities of the surface waves are quantified non-intrusively by using a vision or imaging system that records the surface wave propagation in the flow over time, and the free-surface velocity vector field of the underlying flow is derived.

Preferably the controlled surface waves are created non-intrusively. Different methodologies can be used to evaluate the recorded images of the flow and determine the free-surface velocities. One example is a directional approach. Another approach is a global approach.

Post processing options are available through software or other means.

### III. BRIEF DESCRIPTION OF THE DRAWINGS

The patent or application file contains at least one drawing executed in color. Copies of this patent with color drawings(s) will be provided by the Patent and Trademark Office upon request and payment of necessary fee.

FIG. 1.1 is a diagram of a system according to one exemplary embodiment of the present invention.

FIG. 1.2 is a diagram depicting specular reflections produced by the interaction of wave fronts with incident illumination from the system of FIG. 1.1.

FIGS. 1.3(a)-(h) are diagrams and photos of principles regarding an aspect of the present invention.

FIGS. 1.4(a) and (b) are graphs comparing performance of an embodiement of the present invention with other alternative measurement techiques.

FIG. 2.1 is a diagram of a general algorithm for PIV image processing.

FIG. 2.2 [not used]

FIG. 2.3 is a diagram of LSPIV arrangement of the experiment.

FIG. 2.4 [not used]

FIG. 2.5 [not used]

FIG. 2.6 is a diagram of definition of a sine wave.

FIG. 2.7 is a schematic representation of wave types and their describing factors.

FIG. 2.8 is a diagram of wave propagation after an initial energy input at three different points of time.

FIG. 2.9 is a diagram of boundary layer between (assumed) flow profiles in water and air.

FIG. 2.10 is a diagram of stream-function contours of air flow over surface waves.

FIG. 2.11 is a diagram of longitudinal cross-section of the flume—side view of the fan.

FIG. 2.12 [not used].

FIG. 2.13 is a diagram of the velocities of the reflections and the celerities of the waves match.

FIG. 2.14 is a diagram of fan inducing gravity-capillary waves above a still and moving water surface.

FIG. 2.15 is a diagram of principle of superposition in the vicinity of the fan.

FIG. 3.1 is a schematic of the sediment recirculating flume used in the experiments.

FIG. 3.2 [not used].

FIG. 3.3 [not used].

FIG. 3.4 [not used].

FIG. 3.5 is a diagram of side view of the experimental setup.

FIG. 3.6 is a diagram of top view of the setup experimental setup.

FIG. 3.7 [not used].

FIG. 3.8 [not used].

FIG. 3.9 is a photo of velocity map of the downstream flow of the fan.

FIG. 3.10 is a photo of symmetrical reflections due to a vertical illumination for a still water surface (left).

FIG. 3.11 is a photo of grid to be recorded before each experiment—centered on the image/flume (right).

FIG. 3.12 is a photo of evenly distributed particles in the recording area forming clusters.

FIG. 3.13 [not used].

FIG. 3.14 is a photo of distorted image of the Iowa River, Iowa City.

FIG. 3.15 is a photo of the same but undistorted image (after application of IIHR-LSPIV software).

FIG. 3.16 is a representation of a Ed-PIV window with evaluation settings used for the experiments.

FIG. 3.17 is an example of an output file for Tecplot opened in Notepad (excerpt).

FIG. 4.1 is a photo of single Frame for a setup of direct illumination near the water surface (left).

FIG. 4.2 is a photo of Tecplot Output of an evaluation for this type of setup for a given flow (right).

FIG. 4.3 is a photo of Single Frame for a setup of direct illumination from an elevation at 1.25 m (left).

FIG. 4.4 is a photo of Tecplot Output of an evaluation for this type of setup for a given flow (right).

FIG. 4.5 is a photo of Single frame for a setup of vertical illumination (left).

FIG. 4.6 is a photo of Tecplot Output of an evaluation for this type of setup for a given flow (right).

FIG. 4.7 is a photo of Black board placed on the flume bottom for a direct illumination (elev. 1.25 m) (left).

FIG. 4.8 is a photo of Black board placed on the flume bottom for vertical illumination (right).

FIG. 4.9 is a photo of Single frame for a setup of indirect illumination on the right side (left).

FIG. 4.10 is a photo of Tecplot Output of an evaluation for this type of setup for a given flow (right).

FIG. 4.11 is a photo of Single frame for direct illumination under field conditions (left).

FIG. 4.12 is a photo of Tecplot Output of an (estimated) evaluation for these conditions (right).

FIG. 4.13 is a photo of Single frame for indirect illumination due to diffuse light under field conditions (left).

FIG. 4.14 is a photo of Tecplot Output of an (estimated) evaluation for these conditions (right).

FIG. 4.15 is a photo of Single Frame, dir. illumination, Big fan running at 70% of max. rot. speed (left).

FIG. 4.16 is a photo of Tecplot Output of an evaluation for this type of setup for a still water surface (right).

FIG. 4.17 is a photo of Single Frame, dir. illumination, Big fan running at 100% of max. rot. speed (left).

FIG. 4.18 is a photo of Tecplot Output of an evaluation for this type of setup for a still water surface (right).

FIG. 4.19 is a photo of Evaluation with an Interrogation Area of 32×32 pixels (left).

FIG. 4.20 is a photo of Evaluation with an Interrogation Area of 64×64 pixels (right).

FIG. 4.21 is a photo of Evaluation with an expected maximum displacement of 10 pixels (left).

FIG. 4.22 is a photo of Evaluation with an expected maximum displacement of 20 pixels (right).

FIG. 4.23 is a photo of Evaluation of (low quality) data with Ed-PIV (left).

FIG. 4.24 is a photo of Evaluation of the identical data with IMHR-LSPIV (right).

FIG. 5.1 is a photo of Vector field for waves induced by the fan above a still water surface (no flow) (left).

FIG. 5.2 is a photo of Vector field for waves induced by a fan above a moving water surface (flow) (right).

FIG. 5.3 is a photo of Velocities at the centerline of the flume for still water and a given flow.

FIG. 5.4 is a photo of Streamlines for an evaluation of a recording of still water (Video 14).

FIG. 5.5 is a photo of Vorticity output for a recording of a still water surface (Video 14).

FIG. 5.6 is a photo of Vorticity output for a recording of a given flow (Video 15).

FIG. 5.7 is a photo of Wave celerities on the upstream and downstream side for various water depths.

FIG. 5.8 is a photo of Wave celerities on the upstream and downstream side for various slow flows.

FIG. 5.9 is a photo of Standing wave showing typical reflections on the downstream side of the fan (left).

FIG. 5.10 is a photo of Tecplot Output lacking data for this case of a very fast flow (right).

FIG. 5.11 is a photo of Wave celerities on the upstream and downstream side for a fast flow.

FIG. 5.12 is a photo of Wave celerities for a flow recorded under several simulated field conditions.

FIG. 5.13 is a photo of Tecplot output for waves induced by a fan on the upstream side of the setup (left).

FIG. 5.14 is a photo of Tecplot output: Two fans running simultaneously (adverse field condition) (right).

FIG. 5.15 is a photo of Single frame of a recording of the Iowa River on a cloudy, windy day (left).

FIG. 5.16 is a photo of Output after evaluation of the recorded data (right).

FIG. 5.17 is a photo of Example of a recording to be investigated in all directions from the fan (left).

FIG. 5.18 is a graph of definition of cross-sections (right).

FIG. 5.19 is a photo of Wave celerities for several cross-sections of a given flow.

FIG. 6.1(a) and (b) is a graph illustrating experimental results according to one aspect of the invention.

FIG. 6.2 is a table of experimental set up for an experiment regarding one aspect of the invention.

### IV. DETAILED DESCRIPTION OF EXEMPLARY EMBODIMENTS

A. Overview

For a better understanding of the invention, exemplary embodiments will now be described in detail. These are examples of forms the invention can take, and are not inclusive or exclusive. These examples are illustrations of some forms the invention can take and are intended to assist in an understanding of the invention.

Reference in this description will sometimes be made to the drawings. Reference numbers or letters may sometimes be used to identify certain parts and locations in the drawings. The same reference numbers or letters will be used to indicate the same or similar parts or locations throughout the drawings, unless otherwise indicated,

B. Exemplary System

One exemplary embodiment includes a fan positioned above the surface of the flow. The fan is operated and positioned to produce a controlled pattern of surface waves. Preferably the pattern emanates in all directions in the plane of the fluid surface. Illumination (natural or artificial) of the surface around the fan creates distinguishable parts of the controlled surface wave that can be tracked on consecutive video images of the surface. Image velocimetry algorithms can be used to derive wave propagation velocity (celerity) of the controlled surface waves. Wave theory elements or calibrations can then be used to derive the velocity vector field for the underlying flow.

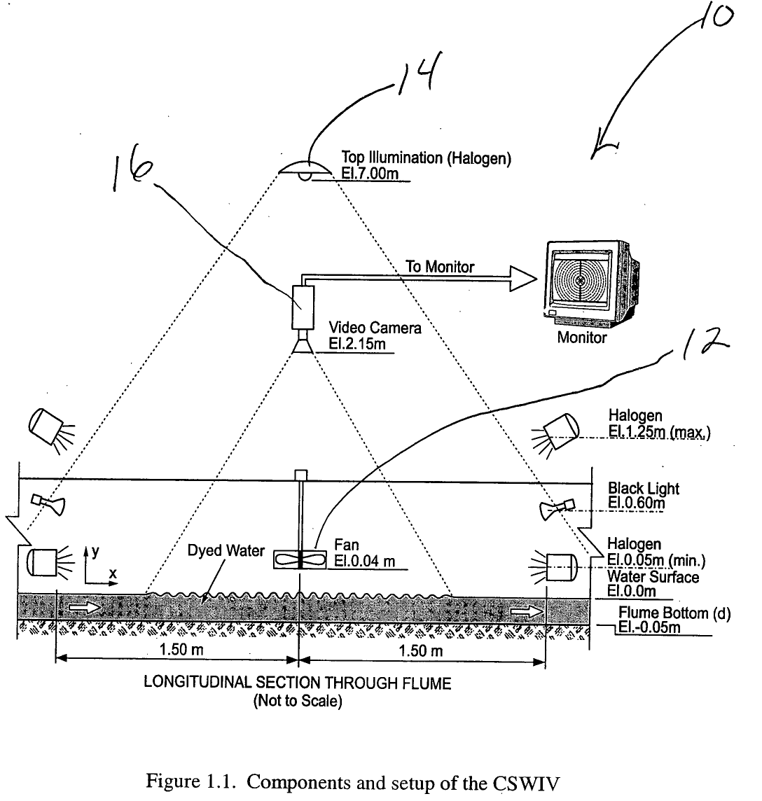

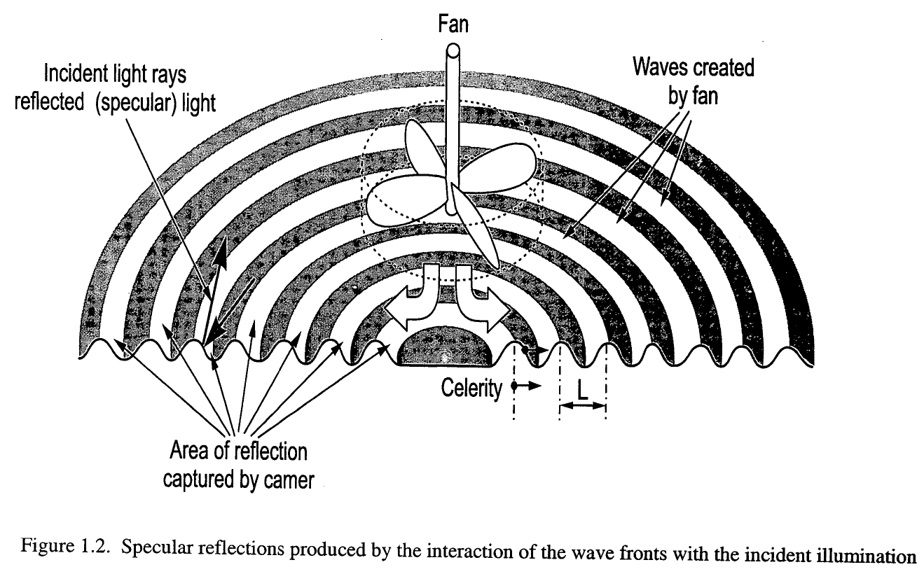

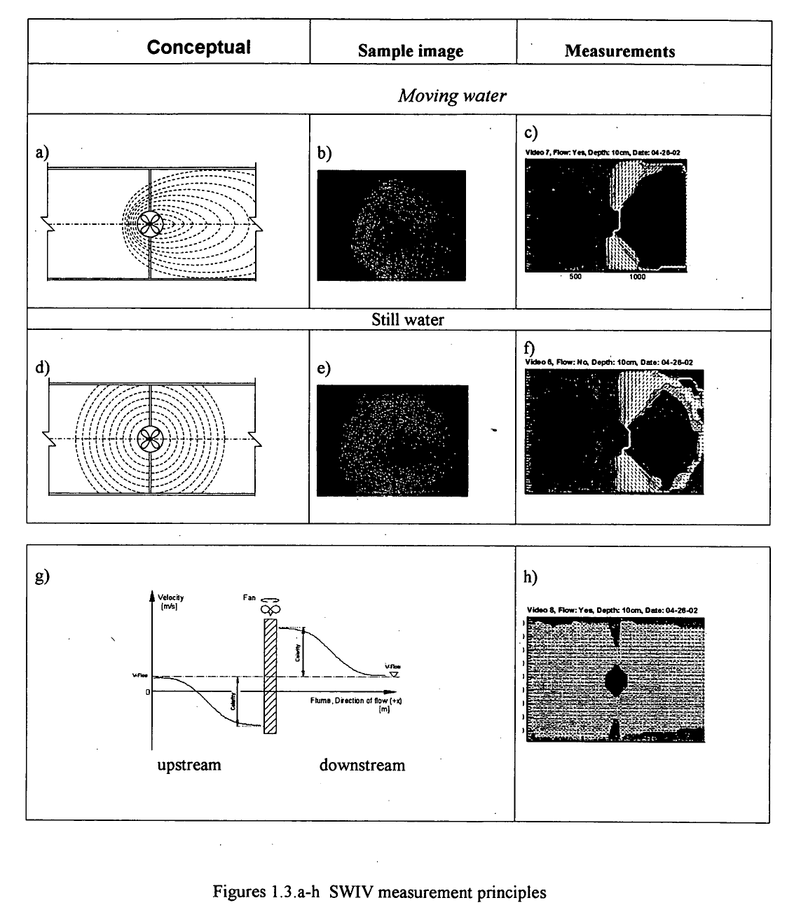

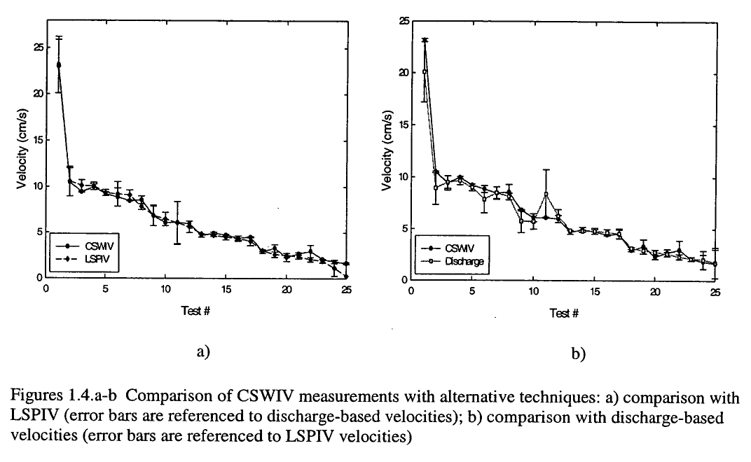

With particular reference to FIGS. 1.1 through 1.4 of the drawings, below is a description of one system of this type.

The system (referred to sometimes herein as the instrument 10 or the system 10, and/or Controlled Surface Wave Image Velocimetry-CSWIV) is a video-based instrument that uses controlled image patterns to measure two velocity components in free-surface flows. The instrument comprises:
air-jet generator (here fan 12)
illumination source (here lamp 14)
imaging device or video camera (here camera 16).

The air jet from fan 12 generates controlled patterns consisting of concentric waves that are convected by the underlying open-channel flow. Pattern motion is captured by the imaging device 16 using appropriate illumination 14. Image velocimetry algorithms, such as are known in the art, applied to the recorded images determine the wave propagation velocity (celerity). The determined wave velocities in combination with wave theory elements or suitable calibrations, also such as known in the art or within the skill of those skilled in the art, can be used to infer the free-surface velocity of the underlying channel flow.

The instrument 10 can be used to measure non-intrusively the total velocity vector of a moving body of water in field and laboratory conditions.

The instrument 10 measures non-intrusively two velocity components in normal and extreme flow situations in a cost- and time-effective manner with very little site preparation. Major commercial potential is related to measurements of very low and shallow flows in field conditions, where there are no alternative measurement instruments. Measurements in lakes and slow and shallow rivers or streams are such examples. These measurements are crucial for numerous water resources agencies involved in the management and water quality monitoring in natural body of waters. Another major commercial potential is related to measurements of corrosive/hazardous chemical spills or other industrial processes where measurements can be made only with non-intrusive techniques in order to not affect the instrument sensor. The technique can be applied for laboratory conditions too.

As indicated previously, current technology does not measure non-intrusively instantaneous free surface velocity in rivers, open channels, and lakes. Moreover, for natural scale low-velocity flows there are no means to measure velocity at all. Such conditions are common in lakes and marshes where the velocities are from several cm/s to near zero.

The primary fields of application are free-surface measurement in rivers and lakes for monitoring and management purposes. The technique can also be used for laboratory and industrial situations where non-intrusive free-surface velocity measurements of free-surface flows are required.

CSWIV is unique through its capabilities to measure two velocity components in free-surface flows with superior efficiency (operational approach, time, and cost). As discussed previously, particle image velocimetry (PIV) is a known velocity measurement technique based on image analysis (Adrian, R. J. (1991). “Particle-Imaging Techniques for Experimental Fluid Mechanics,” Ann. Rev. Fluid Mech., 23, pp. 261-304; incorporated by reference herein). PIV was extended to measurements of the free-surface velocity in laboratory flows (Fujita, I., Muste, M. and Kruger, A. (1998). “Large-Scale Particle Image Velocimetry for Flow Analysis in Hydraulic Applications,” J. Hydr. Res., 36(3), pp. 397-414; incorporated by reference herein).

That new technique, labeled Large-Scale Particle Image Velocimetry (LSPIV), has been successfully used since then in various field and laboratory applications. However, a major shortcoming of LSPIV is the need for tracing the free surface of the flow in order to detect the flow motion. The tracing is usually achieved by seeding the flow free surface with particles lighter than water that travel on the free surface with the flow velocity. Flow seeding is a quite intensive effort in any measurement situations, but it is a major concern when the spatial extent of the measured flow is large, such as in rivers and lakes.

Instrument 10 traces the surface without use of particles. Specifically, a controlled disturbance (i.e., concentric waves) is created on the flow free surface that is used to trace the underlying flow. The disturbance is non-intrusive and, as described below, it is a reliable procedure for determining the velocity of the body of water on which the waves are superposed.

Components and setup of instrument 10 and the velocity measurement method are shown in FIG. 1.1.

The measurement method used with instrument 10 entails several steps grouped in two phases:

Phase A. Image recording at the location of the measurement (field/laboratory)

Phase B. Image processing and velocity inference (computer-based post-processing)

Phase A
A.1. Create controlled concentric waves on the free surface at the location where the velocity measurements are desired. The waves can be created in various ways; the method used herein is a remote, non-intrusive approach where the waves are generated by a fan positioned perpendicular to the flow free surface, as shown in FIG. 1.2. The waves are essentially small gravitational and/or capillary waves generated by the pressure field acting locally on the free surface. The wave amplitudes exhibit no directional dependence. The waves are slowly attenuated away from the fan due to internal dissipation.
A.2. Set an imaging device above the fan, on the same vertical (see FIG. 1.1).
A.3. Set illumination source(s) such that the incoming light is reflected onto the sensitive area of an imaging device. FIG. 1.1 shows various types of illumination sources and layouts that were tested during preliminary measurements (i.e., lateral and close to the surface, oblique, top) to enhance the recording of the wave front movement. During these tests it was found that the optimum images are captured using the top illumination. For this later arrangement, the specular reflection occurs on the wave fronts as illustrated in FIG. 1.2.
A.4. Frame the area to be measured in the imaging device. The imaging capabilities of the recording device, illumination characteristics (intensity, light type), the strength of the ripple generator, and the distance of the wave generator from the free surface are all involved in establishing the size of the recorded image.
A.5. Record images of the traveling waves.

Phase B
B.1. Quantify the velocity of the moving waves using image velocimetry algorithms. Essentially, these algorithms (cross-correlation, autocorrelation, etc) are statistical concepts similar to those involved in motion detection by human vision (Fujita et al., 1998).
B.2. Calculate the velocity vector field of the underlying flow. Distinction should be made between two measuring situations:
   controlled waves applied to a moving body of water. The measured velocity at any location in the image (as recorded by a fixed observer) is a superposition of velocities of two motions, wave propagation and the movement of the underlying flow, as shown in FIGS. 1.3.a and 1.3.b.
   controlled waves applied to a body of still water. The measured velocity is that of the waves propagating outwards at a constant speed in opposite directions (away from the fan), as shown in FIG. 1.3.d and 1.3.e.
The free-surface velocity of the underlying flow can be calculated using two approaches.
B.2.1. Directional approach (FIG. 1.3.g). The free-surface velocity of the underlying flow along any pre-established direction is the average of the wave velocities of two homologous waves, (symmetrically positioned upstream and downstream) from the fan along that direction. i.e.,

$$⌊ + {V}_{wave}^{upstream} + ( - {V}_{wave}^{downstream} ) ⌋ / 2$$
B.2.2. Global approach (FIG. 1.3.h). The whole- field free-surface velocity of the underlying flow is obtained by subtracting the velocity field determined for the waves moving in still water (FIG. 1.3.f) from the one obtained in moving water (FIG. 1.3.c). The subtraction assumes that the controlled waves are identical for moving and still water situations. The vector field for the still water conditions can be determined prior to the measurements through a calibration measurement (preferable in laboratory conditions). The measurements in moving water should be made using identical conditions (fan type, rotational speed, distance from the free surface, illumination positioning) with those in calibration.
   The following aspects characterize the measurement method:
1. controlled free surface waves are used to trace the motion of the underlying body of water instead of seeding particles
2. self-contained (the method is independent of environmental illumination)
3. remote and non-intrusive
4. independent of the flow depth
5. wide velocity measurement range (of special importance is the very low velocity range, where there are no alternative measurement methods)

The instrument has variable measurement volume, which implies that different instrument configurations need to be designed for measurements of small or large scale flows.

The technique has been verified in a series of laboratory tests. The CSWIV velocities compared with measurements made with LSPIV (an already well established technique, Fujita et al., 1998) and velocities determined using the measured channel discharge show good agreement. The comparison of CSWIV measurements with the two alternative techniques over a large range of velocities is shown in FIG. 1.4.

As can be seen from FIGS. 1.1 to 1.4, instrument 10 can be a portable, non-intrusive way to capture information from free surface fluid flow and derive flow characteristics. It does not rely on introduction of the probe into the fluid. The captured information from instrument 10 can be used with image velocimetry algorithms to derive wave celerity, which then allows inference of the free-surface velocity vector field for the underlying flow. It compares favorably to PIV and LSPIV, and has advantages, as discussed.

### V. OPTIONS AND ALTERNATIVES

It will be appreciated that the present invention can take many forms and embodiments. The exemplary embodiments shown and described herein are for illustration only and not by way of limitation. Variations obvious to those skilled in the art will be included within the invention.

Preceding discussion specifically mentions some options and alternatives. While most of the discussion is in the context of an experimental setup, some of the descriptions relate to and can be applied to non-experimental setting such as rivers, lakes, marshes, etc. The invention applies to free surface open channel flows of any liquid or fluid, including but not limited to water.

The controlled pattern made by a fan, as described above is an example of a non-intrusive generation of a controlled pattern. Other methods are possible. A general goal is to create a surface wave of known properties. Somewhat intrusive methods might be used. One example might be a mechanically moved paddle or member. It could be moved back and forth in the fluid, or moved into and out of the fluid, to set up a controlled surface wave.

With the example of a fan, size and pressure can be selected for each application. Considerations, and some compromises, regarding generation of the controlled wave are discussed previously.

Recording of images is preferably digital and of sufficient resolution. Some of the considerations and compromises are discussed previously. The goal is to get information sufficient to derive the spread of the fronts of the controlled waves from the images.

Illumination can be ambient or artificial light. Discussion has been given previously of considerations regarding type, amount, angle, and other factors for illuminating the surface being measured. One exemplary embodiment includes UV light as an illumination source. Other examples include, but are not limited to, halogen, and even sunlight.

As indicated, the algorithms and evaluation of the images is by well known methods. Examples of cross-correlation algorithms are given. Software embodying these well known techniques is well within the skill of those skilled in the art. An example of software that can be used for evaluation of the images includes the following: “FlowMap”, “ePIV Multi-Phase Software”, available from Dantec Dynamics DK-2740 Skovlunde, Denmark; “Pixel Flow”® from VioSense Corporation, Pasadena, Calif.; “ViseLace”, from Oxford Lasors, Littleton, Mass. The software can also be obtained from companies such as Tis, Inc. and LaVision.

Likewise, there are different ways to evaluate the data derived from the image velocimetry methods to then produce the velocity vector field. Some of these options and features are discussed above.

It has been found that the present invention has wide application to a variety of flow situations. For example, it has been found to work well for very low velocity flows (almost down to zero velocity). It has been shown to render good results down to 0.5 cm per second flow velocities. Also, it has been shown to work well in shallow flows. There may be need to filter out or process out from the images such things as bottom or side reflections caused by shallow clear water or narrow flow channel. Techniques to handle the same are discussed previously.

Additionally the invention is useful in looking at velocities in all directions for the flow, not just in the main flow direction. Also, the system can derive information about the flow, or allow extrapolation regarding the flow, that might not be easily done with the currents systems.

One example of a system according to the invention that could be used for relatively large areas of flow would be a helicopter on which is mounted imaging equipment and possibly an illuminating system. The helicopter could be brought down and hovered over the target surface to produce a controlled surface wave pattern and carry on board the imaging and illumination equipment to pick up images needed to then process into the velocity vector field.

It can therefore be seen that the invention achieves at least all the stated objectives and is adaptable to different forms and embodiments as will be appreciated by those skilled in the art.

### VI. FURTHER BACKGROUND AND DETAILS

The preceding description provides the general elements of an exemplary instrument 10 and how it can be utilized. As can be appreciated, there is background and foundational information that relate to instrument 10 and its use. There are also a variety of considerations and variations that relate to instrument 10 and its application to a variety of uses.

The following provides additional detail on these and other points. It discusses certain aspects of the invention according to exemplary embodiments thereof, sometimes referred to herein as Surface Wave Image Velocimetry (SWIV). These are excerpts from the thesis by Jorg Schone, entitled “SWIV-An Image-Based Technique For Low Velocity Free-Surface Flows”, which is incorporated by reference herein and is referenced in the provisional application from which this is based. Numbered headings in this section relate to Chapters 1 to 5 of the thesis.

Surface Wave Image Velocimetry (SWIV) is a new video-based technique aimed at measuring wave celerity. SWIV uses specular reflections of direct or diffuse natural light on the wave crest to track the movement of the waves. The wave velocity is obtained by way of correlation techniques applied to successive image pairs, similarly to conventional Particle Image Velocimetry.

SWIV has been developed to overcome the drawbacks of Large Scale Particle Image Velocimetry (LSPIV), a well-established free-surface velocity measurement method based on particle imaging. Specifically, SWIV does not need seeding particles on the free surface to track the flow motion.

Combining principles of image velocimetry and wave theory, SWIV has capabilities to measure free-surface velocities in open-channel flows using waves produced by a controlled wave generator instead. The nature of the generated waves and the appropriate positioning of the illumination sources are crucial for successful implementation of the technique.

This discussion describes principles, configuration, and optimal condition for SWIV usage. The thesis extensively illustrates the implementation of SWIV in practical laboratory applications; namely, measurement of free-surface velocity in open-channel flows characterized by very low velocities and shallow depth.

The agreement between velocity measurements conducted with alternative instrumentation and the sensitivity analysis conducted on a wide range of laboratory flow situations demonstrate the capabilities of SWIV for laboratory use. It can be extended to natural scale flows.

### 1 Introduction

1.1 General Statement

In the last three decades, Particle Image Velocimetry (PIV) has experienced considerable improvement in terms of hardware and software and has been adapted to a variety of practical applications. The intensive and extensive development of PIV is closely related to the simplicity of its underlying principles, ease in operation, and efficiency of the technique compared to alternative velocity measurement methods. Originally, the imaged-based techniques have had only qualitative aspects. Currently, they become powerful flow diagnostic tools with quantitative connotations.

Currently, image-based techniques continue to gain popularity. Efforts are underway to pursue volume (three-dimensional) measurements with increased temporal and spatial resolution. Similarly, Large Scale Particle Image Velocimetry (LSPIV), a method with its origin in PIV, is increasingly used for laboratory and field measurements of the free-surface velocity in open-channel flows. LSPIV is unique among the other measurement alternatives¹ through its capabilities to provide instantaneous 2-dimensional velocity fields. The technique is accurate and non-intrusive and has been successfully applied to laboratory and field applications as well.
¹Over the same period of time several alternative methods for flow observation were developed ranging from a comparatively simple current meter, over Acoustic Doppler Velocimetry (ADV) to the Laser Doppler Velocimetry (LDV) just to mention a few.

1.2 Motivation and Objectives

One of the components of conventional LSPIV is seeding of the flow area to be measured. Seeding does not pose major problems for laboratory conditions, but, it becomes a major drawback for an application in field conditions. That shortcoming is the principal motivation for the present work. In addition, during the development of the technique it was early noticed that the technique is very suitable for a measurement situation where there are no alternative approaches; i.e., very slow flows and, often times, shallow channel flows.

The newly developed technique, Surface Wave Image Velocimetry (SWIV), utilizes a completely new approach for “seeding”, namely, tracking of ripples or waves traveling on the water free surface. SWIV uses specular reflections of direct or diffuse natural light on the wave crests to track the movement of the waves. Therefore, one aspect of SWIV would be quantification of the wave velocity. This application of the technique is straightforward and it is just briefly referred in the present work. SWIV in combination with wave superposition relationships can be innovatively used to efficiently determine free-surface velocities in open-channel flows.

Low velocity flows are relevant for an important area of applications such as lakes, marshes, and deltas. Marshes are characterized by near-zero flow velocities where, often time, even the direction of flow is unknown. SWIV can be successfully used in such situations; it provides instantaneous free-surface velocities, velocity-derived quantities (e.g., vorticity, streamlines), as well as other useful data that enables further assessment of the aquifer.

Quantification of such information enables a better understanding of processes such as river and lake sedimentation, pollutant transport, and considerably aids the design of hydraulic structures and the management of surface aquifers.

### 2 SWIV—Theoretical Background

2.1 PIV—Background of the Method

The purpose of this chapter is to show the general background of the technique of Particle Image Velocimetry (PIV). Furthermore the specific branches derived from the original PIV method will be introduced. In the next section then the technique of Large Scale PIV (LSPIV) will be covered in detail, because the SWIV method originates from this technique.

### Principles of PIV

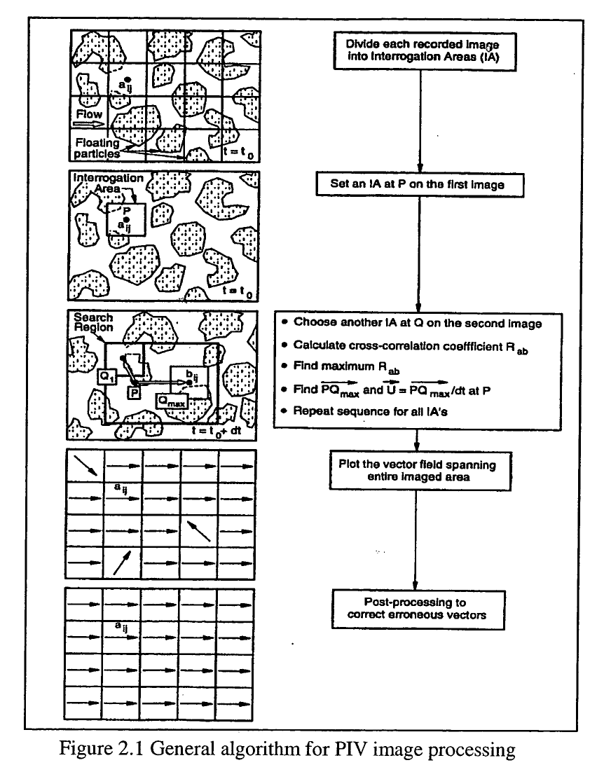

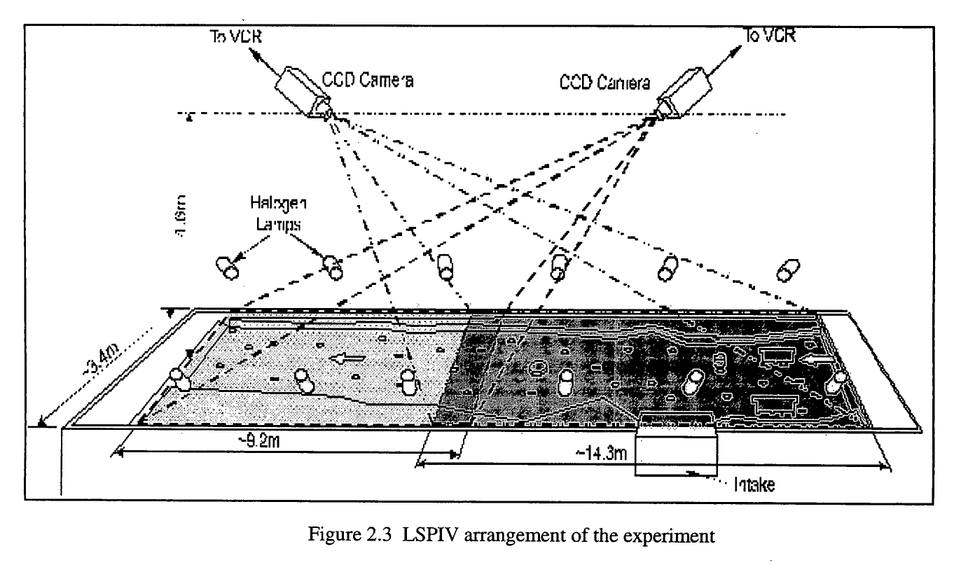

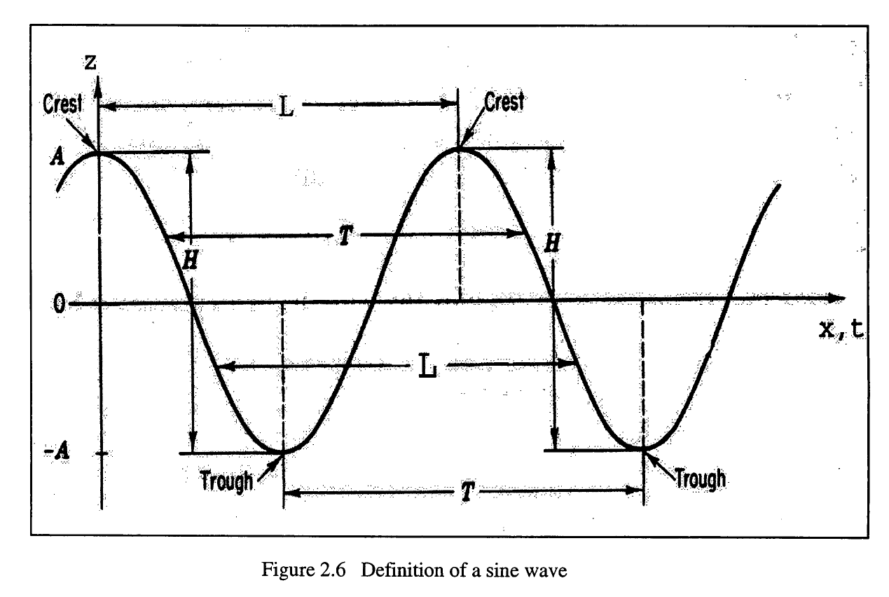

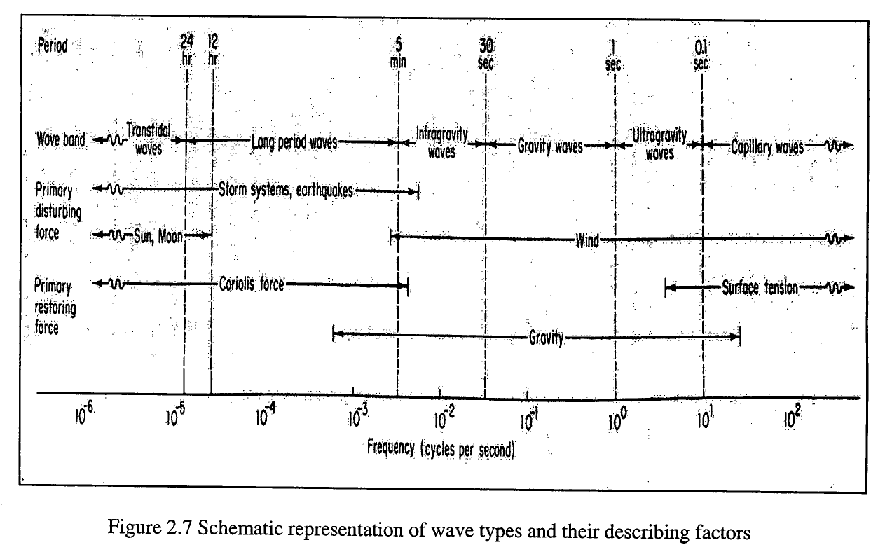

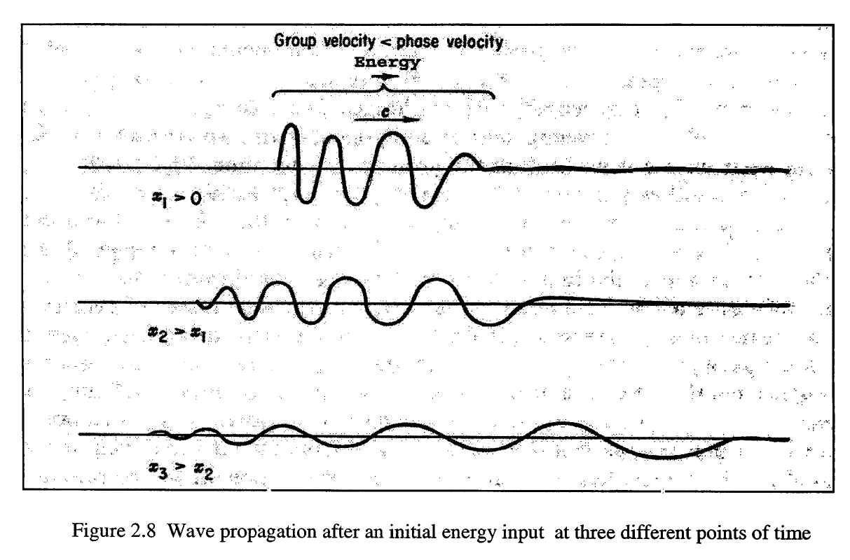

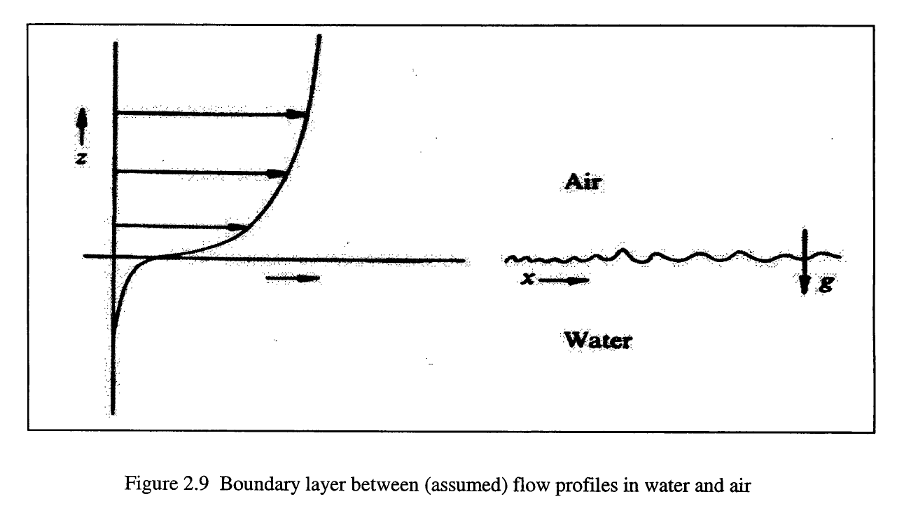

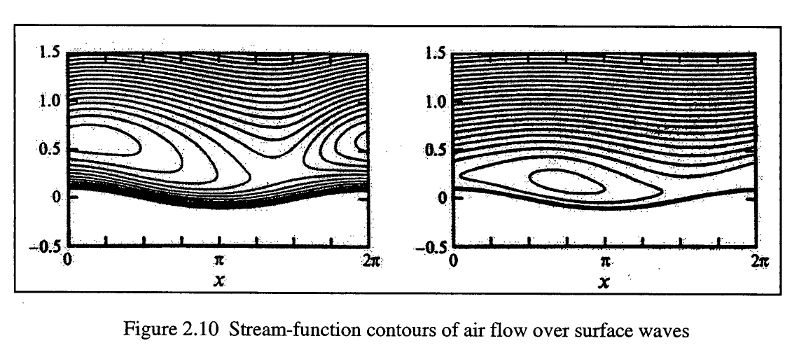

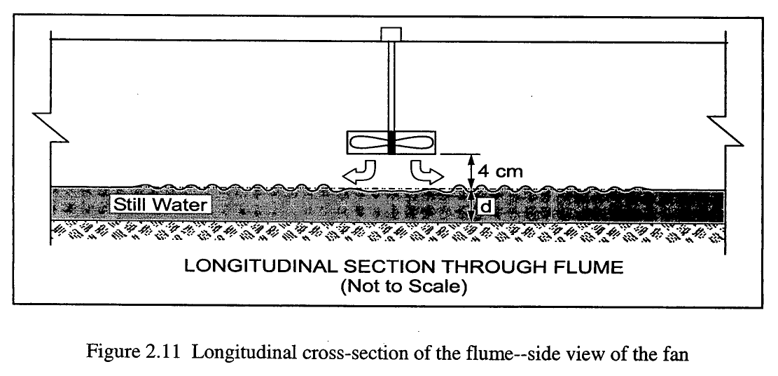

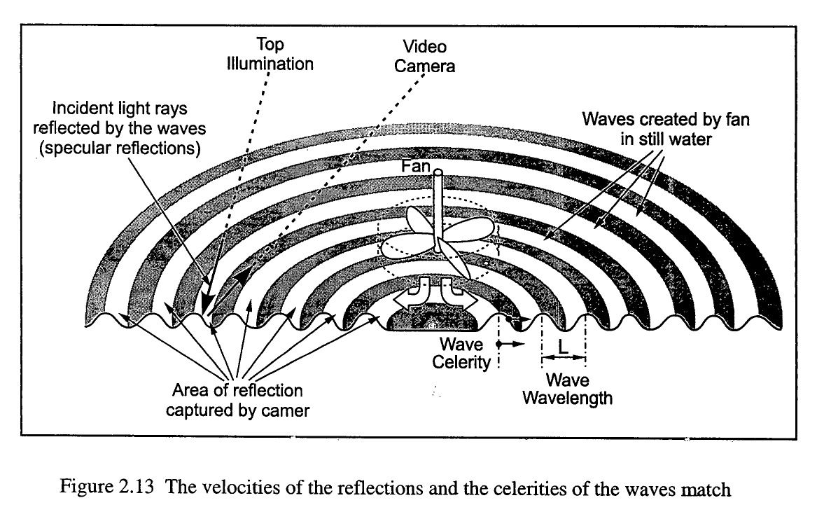

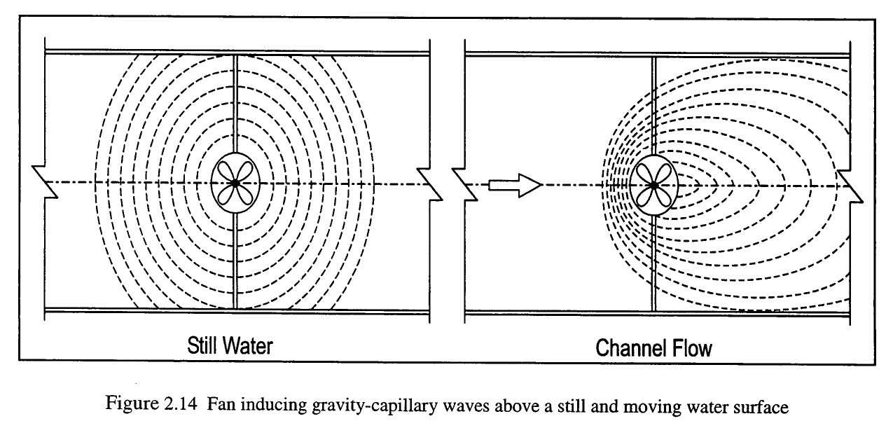

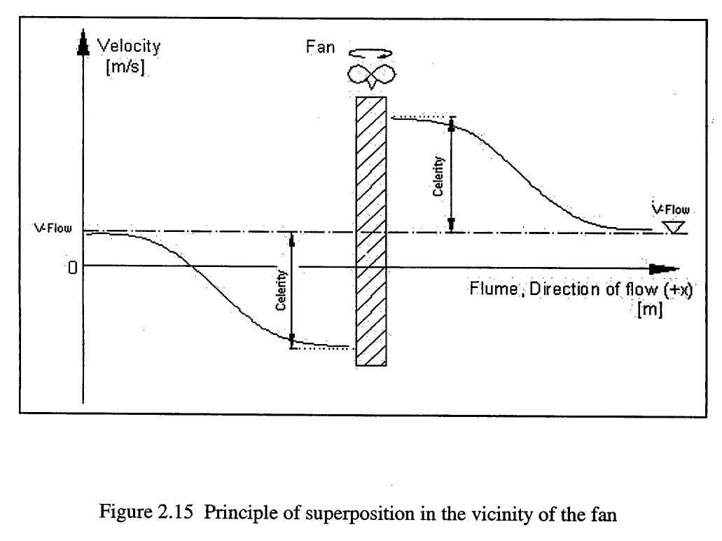

The central goal of an imaging technique is to measure the displacement of marked regions of a gaseous or liquid flow by observing the location of these markers in the image at two or more times. The magnitude of the marker displacements between two successive images can be determined in small regions, called interrogation areas. By means of a statistical method (e.g. cross-correlation) the displacement can be determined and finally a velocity vector for each interrogation area can be determined by dividing the displacement by the time interval between two successive recordings. The final vector field is determined by repeating this step for each interrogation area contained in the field of view (FIG. 2.1).

This process of determination of qualitative and quantitative information about the flow is called Particle Image Velocimetry. PIV is a whole-flow-field technique providing instantaneous velocity vector measurements in a cross-section of a flow. It is a strong experimental tool that allows for rapid and accurate measurements from few microns up to tens of meters per second.

The whole procedure that is typical for every PIV experiment consists basically of the four main steps
illumination,
seeding,
recording and
image evaluation
   of the flow. They are necessary parts of the method to be able to successfully determine the aquifers properties or special characteristics. Illumination

A plane of interest in the flow which is to be recorded has to be illuminated by a strong light source. Typically a laser with its accompanying light sheet optics is used but Halogen spots and other light sources are also feasible.

### Seeding

Depending on the characteristics of a flow a suitable type of markers (seeding material) is added to this flow. The choice of the marking material and its way of addition to the flow is crucial because its properties like size, density and light-scattering behavior have a significant impact on the result of an experiment.

If chosen correctly, a floating particle is assumed to follow the flow identically (e.g. without time-lag) and the light reflection on its surface makes it possible to track the actual position of this particle at all times.

### Recording

The particle positions in a given flow can be recorded on a medium, e.g. a charge coupled device (CCD), photographic film or the tape of a video camera. Particles positioned in the field of view (plane in the flow) will be captured on the array of the recording medium (imaging plane) at several (known) time-intervals.

### Image Evaluation

Special software for PIV evaluation handles the data material gained in the previous step of recording. The particle displacements are determined by statistical means. A two-dimensional correlation (usually cross-correlation) is carried out for successive pairs of images.

Once a sequence of consecutive frames is recorded, they are divided into small subsections called interrogation areas (IA). The interrogation areas from each frame are cross-correlated with each other, pixel by pixel. The result of the correlation produces a signal peak, identifying the most likely particle displacement for the investigated IA.

Sub-pixel interpolation allows a more accurate measurement of the displacement and thus of the velocity, which is finally calculated by dividing the displacement by the time span between the two investigated frames. The velocity vector map for the whole target area (cross-section) is obtained by repeating the correlation for each IA in the two frames.

Given a probabilistic method used to determine the particle displacements and imperfections of the recorded images most likely a few spurious vectors are returned after processing. Numerous algorithms exist to correct the erroneous vectors and thus this step of data post-processing concludes the fourth step of PIV.

FIG. 2.1 gives an overview about the general algorithm for PIV image evaluation.

Three more general aspects of PIV should be mentioned here. PIV enables nonintrusive velocity measurements. In contrast to techniques employing pressure tubes or hot wires the PIV technique works completely image based. This feature is a major advantage because even complicated flows can be investigated: No probes have to be submerged which might disturb the flow.

Furthermore PIV measures velocities indirectly. Not the fluid elements themselves but seeding particles that were previously added to the flow are traced and evaluated.

A feature, which is unique to the PIV technique, has been already mentioned above: Most other techniques only allow velocity measurements for a single point in the flow. PIV however, allows measurements of large parts of flow fields and extracts the velocity information out of the recorded frames. Primary this whole-field feature represents an improvement in terms of expenditure of time.

### Errors in Imaging Techniques

The overall measurement accuracy in PIV is a combination of a variety of aspects from the recording process all the way to the methods of evaluation. The total measurement error in the estimation of a single displacement (and thus velocity) vector can be decomposed into the groups of bias and random errors.

The bias errors have a systematic character and comprise all errors which arise due to the inadequacy of the statistical method in the evaluation of the data material. Such errors follow a consistent trend which makes them predictable. They can be reduced or even removed. Bias errors can arise due to an inappropriate particle size, finite resolution or noise of the image support (e.g. video tape), lens distortion or an oblique imaging angle just to mention a few.

Random errors always remain in the form of a measurement uncertainty even when all systematic errors have been removed. Inappropriate particle density and background noise represent examples for this type of error.

Errors in PIV are almost unavoidable. Experiments should be planned and carried out carefully; if possible a backup of the results with alternative measurement methods (e.g. Laser Doppler Velocimetry (LDV)) is recommended.

### Modes of Operation

Basically four methods originating from the same imaging technique need to be mentioned here. All of them make use of the same principles but they differ in terms of tracer concentration in the flow and thus their application.

### Particle Tracking Velocimetry (PTV)

This low-image-density mode of PIV shows some special characteristics. The concentration of particles in a frame is very low and thus individual particle images dominate. So it becomes feasible to measure the displacement or follow the movement of these single particles. PTV allows the detection of the image of an individual particle and the identification of the image of the same particle originating from a different illumination (consecutive frame).

### Particle Image Velocimetry (PIV)

In the case of medium image density the images of individual particles can be detected as well. However, the images do not overlap and do not form speckle patterns. Furthermore it is no longer possible to identify image pairs on successive frames. For PIV it is assumed that the group of particles in an IA does not change its relative position considerably in the time interval between two frames. The particles form a constant pattern which can be tracked by the correlation method.

### Laser Speckle Velocimetry (LSV)

In the high-image-density mode of PIV it is no longer possible to detect individual images of particles; they overlap in the image plane. The random phase differences between the images of individual randomly located particles create interference patterns called laser speckles. The velocity can be measured by tracing the speckle displacement.

### Large Scale PIV (LSPIV)

LSPIV is an extension of conventional PIV for velocity measurements in large-scale flows. Thus this method uses basically the same steps and procedures to investigate the characteristics of a given flow. In the next chapter the whole technique is explained in detail.

### Surface Wave Image Velocimetry (SWIV)

Due to drawbacks of LSPIV the SWIV technique has been developed during our experiments. SWIV is an extension of LSPIV and comprises a completely new approach of providing “particles” that can be tracked during the step of recording.

2.2 LSPIV—Explanation of the Technique

On the basis of an example “Large-scale particle image velocimetry—a reliable tool for physical modeling” [30] the technique of LSPIV will be introduced and the single components explained.

### Introduction

LSPIV is an extension of conventional PIV for velocity measurements in large-scale flows. It is a well established measurement technique for determining free-surface velocities spanning large surfaces in open channel flows. LSPIV has been successfully applied for mapping of uniform and non-uniform velocity fields in laboratory and field conditions respectively. Furthermore LSPIV can provide spatial and temporal features of the flow (recirculations, interactions) and in conjunction with bathymetry information and an assumed velocity distribution over the depth the discharge of the investigated flow can be estimated.

This features make LSPIV a cost- and time effective, flexible flow diagnostic tool for various applications. It can be employed successfully in surveillance planning, design, operation and management in water-related activities.

### Components

A LSPIV system basically comprises the same four major components like a conventional PIV system: illumination, seeding, recording and image processing. The image- and data processing algorithms are very similar but some adjustments are required for the steps of illumination, seeding and pre-processing of the recorded images. Adjustments are mainly due to feature of recording large areas (4 m² up to more than 10.000 m²) in an oblique angle.

A model of a river and an intake facility was constructed with the purpose of investigating sediment management schemes.

### Illumination

The two imaging areas were uniformly illuminated using 500 W Halogen lamps distributed along the model length. Light reflections on the model free surface adversely affect the image processing algorithm. Thus they were kept small by a strategically positioning of the lamps around the model.

### Seeding

The way of adding tracers to a flow (seeding strategies) and the choice of the appropriate seeding material are crucial steps for a successful outcome of an LSPWV experiment. A highly non-uniform open channel flow (as the case for the model) put even more emphasis on this decision.

Two seeding materials were used for the experiment: Biodegradable foam peanuts (cornstarch with additives) and grain straw (a plant residue). Many more materials can be used, however both materials are fully compatible for field conditions and harmless for the environment. They are lighter than water, adequately follow the motion of the flow, provide sufficient contrast to the background color of natural waterways² to be easily identified in the recorded images but are quite cost-effective. The biodegradable foam proved to be the superior material because it showed less delicateness to the impact of wind³.
² For this laboratory experiment the contrast was increased by adding dye to the flow. ³ In field conditions particles floating on the water surface may be subject to additional motion due to wind. This behavior negatively impacts the accurate tracing of the underlying flow.

With local and general seeding two strategies were investigated during the experiments. General seeding entailed a uniform release of particles over the entire imaged area, whereas local seeding implied a release of particles over parts of the model only. For this case the seeding location experienced a progressive shift over the entire cross-section and the final vector field was assembled by superposition of the fields obtained using the partial seeding procedure.

Three seeding concentrations⁴ (sparse, medium, high) were tested and finally the ideal circumstances for field applications of LSPIV were found out: Best results to reasonable costs could be obtained with sparse local seeding on small areas of the flow. ⁴ Concentration: Number of particles in an interrogation area of a chosen size.

### Recording

A digital camera, setup at a height of 4.60 m above the model, was used to record the images. The size of the model and the limited available height imposed the use of two camera positions (see FIG. 2.3). The images from the two viewing angles were overlapped in the central region of the model such that markers of known coordinates located in this area were enclosed in each set of images. The final velocity field over the entire model area was assembled in post-processing using the recordings made from the two positions.

### Image Evaluation (and Pre-Processing)

Before the conventional algorithm for an evaluation of the images (FIG. 2.1) could be applied, the distorted images had to be transformed into real-world coordinates first. This transformation, required due to the oblique recording angle, was made using the reference points⁵ located along the model banks. FIG. 2.4 shows the undistorted upstream reach. The velocity vectors in this (somewhat awkward but now realistic) “top view” are already included.
⁵ A geodetic survey was conducted for determining their coordinates.

Then the final step of extracting velocity information from the images was carried out by using PIV software applying a conventional two-dimensional cross-correlation algorithm. Superposing the two final vector maps until the coordinates of the marker points enclosed in the common areas coincided and cropping this assembly yielded in the final result of this experiment, shown in FIG. 2.5.

### Results and Conclusion

The mean vector field was found by averaging instantaneous vector fields. They were obtained by processing each time two successive undistorted images 0.5 s apart. The visual inspection shows that LSPIV was capable of capturing the non-uniform flow features in the upstream region of the model and the recirculation area just downstream the river contraction. Spatial and temporal patterns of the flow could be analyzed. At selected cross-sections statements about the vorticity at the free surface could be made.

The quality of the results obtained from this LSPIV experiment was compared to the outcome of a test carried out with an Acoustic Doppler Velocimeter (ADV) and a numerical simulation for the same model. Compared to ADV the values for velocities and the discharge differed less than 5%, the differences to the result of the numerical simulation were 14.4% but could be explained with the backwater effect due to the tailgate of the model.

The technique of LSPIV is capable to accurately determine whole-field velocities and derived quantities, such as flow patterns (streamlines, pathlines) and discharges for surface flows even with a high degree of non-uniformity. LSPIV is adaptable to various seed materials, concentrations and strategies. Like PIV as a whole field method it is cost- and time-efficient compared with existing local velocity measurement instruments.

The method is fully digital at all stages and thus provides advantages in storage, transfer, handling, and visualization of the data. Raw information and results of this technique are easily to be interpreted by the investigator making it a feasible real-time measurement tool.

2.3 Wave Theory and Wind-Water Interaction

Gravity-capillary waves are an interesting phenomenon on top of a moving water surface. Their appearance is already used for applications of different remote sensing techniques, e.g. radar backscattering etc.

However, comprehensive, full understanding of their properties is not given so far. Numerous theoretical and numerical models have been developed in the recent years with the attempt to describe the complex processes of wind-water interaction or the wave behavior itself.

Coverage of these models would not match the intention of this chapter, thus they are not mentioned here. A list about this special topic is included in the references.

### Wave Properties

Waves have their origin in a more or less intense supply of energy to the considered aquifer. The energy that was brought into the system must move away from its source. The consequence is the appearance of waves; they are initiated to enable this energy transport. FIG. 2.6 gives an overview about the characteristics of a simple sine wave.

Waves can be categorized in many ways. For instance they can be distinguished in the two and three-dimensional type. For two-dimensional waves the shape and the characteristics change only in two directions—a wave approaching a beach is good example for this case. Three-dimensional waves are more complicated in their structure. The well-known effect after a stone was dropped into pond illustrates this type. Replacing the stone and pond by a fan in a water flume gives a first idea about the process that was investigated during the experiments.

Waves can also be classified according to their period (wavelength), main disturbing or restoring force or the wave band they reflect. FIG. 2.7 gives an overview about these types.

The waves induced by our fan can be classified as (ultra) gravity-capillary waves⁶. Gravity waves are driven by a balance between the fluids inertia and its tendency under gravity to return to a state of a stable equilibrium. Capillary waves are affected by an additional restoring force. Adjacent elements in the water pull on each other with an equal but opposite force. This property is expressed as the surface tension of the fluid (Tw=0.074 N/m).
⁶ This classification of the type will be proven later in Chapter 5.

A combination of both effects was observed for the tests in the flume. In literature gravity-capillary waves are frequently called ripples with wavelengths of about 1 cm. However, pure capillary waves can have wavelengths as short as 3 mm, while gravitational waves with lengths of several meters can be observed.

### Wave Celerity and Group Velocity

An example, similar to the observations in the flume, will be given here to get a comprehensive understanding about the wave processes induced by the fan. When referring to the velocity of waves one has to distinguish between the wave celerity of a single wave and the group velocity of a packet of such waves. For SWIV this difference is of importance and will be explained here.

The well-known experiment of a stone dropped into a pond is used as a reference here. Due to the impact of the stone isotropic⁷ waves are produced on the fluid. After the first splash a complicated initial disturbance is formed at the water surface and very soon afterwards a regular, concentric pattern of circular wave crests that are spreading away from the energy source can be observed. A close inspection of the moving wave packet shows differences in speed and size of the single waves. The ones close to the center are smaller in wavelength while the wavelets
⁷ Definition: For isotropic waves the properties (e.g. celerities) in all directions of propagation are equal because the restoring force of gravity cannot make a distinction between different horizontal directions. The energy is propagated radially from the center of the energy source at right angles to the wave crests. traveling at the front of the wave packet have a longer extension and greater celerities. This phenomenon can be seen in FIG. 2.8.

The energy that was brought into the system by the dropped stone is trapped in such a wave packet of several waves. A part of this energy (E_{POT}) is contained in deformations of the water surface while the other part (E_{KIN}) is found in motion and moves with the packet at a velocity U, called the group velocity.

Depending on the ratio of water depth to wavelength (h/λ) specific correlations between the wave celerity and group velocity exist for the two types of waves mentioned above. For gravity waves in deep water⁸ (h/λ>0.5) the group velocity is only half the celerity of the waves (U=0.5*c). Pure capillary waves enable a significantly higher group velocity (U=1.5*c). Waves under such conditions are called dispersive: The speed of propagation for single waves does not match the group velocity at which the energy is propagated; their celerities vary with changing wavelengths.
⁸ These waves are also called ‘Short Waves’. Waves in shallow water are called ‘Long waves’ respectively.

For gravity waves in shallow water (h/λ<0.05) group velocity and wave celerity match due to their non-dispersive behavior (U=c). Here the celerity is independent from the wavelength. However, the group velocity of pure capillary waves is twice the celerity for this case (U=2*c).

Table 2.1 gives an overview about the important governing equations for the small amplitude wave theory.

TABLE 2.1
Overview: Equation of wave celerity and
its relationship to the group velocity

| | | | Radian |
|---|---|---|---|
| Wave Celerity c | Wave Number k | Wave Period T | Frequency ω |
| $c = \frac{λ}{T} [ 1 ]$ | $k = \frac{2 \cdot π}{λ} = \frac{ω}{c} [ 2 ]$ | $T = \frac{2 \cdot π}{ω} [ 3 ]$ | $ω = \frac{2 \cdot π}{T} [ 4 ]$ |

| Wavelength λ | $λ = \frac{g \cdot {T}^{2}}{2 \cdot π} tanh ( \frac{2 \cdot π \cdot h}{λ} ) [ 5 ]$ | |
|---|---|---|
| Wave Celerity C (No consideration of sur-face tension, General form) | ${c}^{2} = ( \frac{g}{k} ) tanh ( k \cdot h ) [ 6 ]$ | |
| Wave Celerity c (With consideration of sur-face tension, General form) | ${c}^{2} = ( \frac{g}{k} ) tanh ( k \cdot h ) + \frac{k \cdot {T}_{w}}{ρ} {( 1 + \frac{{π}^{2} \cdot {a}^{2}}{4 \cdot {λ}^{2}} )}^{- \frac{1}{2}} [ 7 ]$ | |
| Wave Celerity c (Deep Water, h/λ > 0.5, dispersive) | ${c}^{2} = \frac{g}{k} + \frac{k \cdot {T}_{w}}{ρ} {( 1 + \frac{{π}^{2} \cdot {a}^{2}}{4 \cdot {λ}^{2}} )}^{- \frac{1}{2}} [ 8 ]$ | |
| Group Velocity | Gravity Waves: | Capillary Waves: |
| (Deep Water) | U = 0.5 c [9] | U = 1.5 c [10] |
| Wave Celerity c (Shallow Water, h/λ <0.05, non- dispersive) | ${c}^{2} = g \cdot h + \frac{k \cdot {T}_{w}}{ρ} {( 1 + \frac{{π}^{2} \cdot {a}^{2}}{4 \cdot {λ}^{2}} )}^{- \frac{1}{2}} [ 11 ]$ | |
| Group Velocity | Gravity Waves: | Capillary Waves: |
| (Shallow Water) | U = c [12] | U = 2 c [13] |

Compared to the example given above, the supply of energy was continuous and not just for an instant of a second. Waves were created permanently and formed crests of identical properties that traveled in a concentric manner radially away from the center of the fan.

This raised the question which velocity would be actually tracked by the SWIV technique either wave celerities or the group velocity.

We believe the light reflections that were recorded by the camera and finally evaluated by the software were propagating at wave celerity for dispersive waves.

### Wave Generation

There exists an abundance of models, which describe the interaction of a wind flow over a water surface and the properties of consequent waves. The references [7], [8], [11], [13] and [18] give a good overview about some of them.

The growth of waves on the interface of air-water interface can be considered as a perturbation of an equilibrium at this boundary (FIG. 2.9).

The initial growth of gravity-capillary waves is almost certainly due to the instability of the coupled laminar shear flow in the air and the water. Thus, there are basically three ways of a possible energy transfer from the wind flow onto the water.

Waves can be induced or enlarged by the direct push of the wind on the water surface if they are propagating slower than the wind itself. Another way of energy transfer is the frictional drag (tangential stress) of the air on the surface of the fluid. Acting on the entire wave profile this process can speed up the wave or slow it down. Drag forces due to pressure differences in the air complement the reasons for wave generation.

FIG. 2.10 gives examples for airflow streamlines about a water surface.

The initial stage of development is exponential: Little ripples or wavelets are the first waves that are generated by the wind and their growth rate is very sensitive to the environment, e.g. the shape of the wind profile above the water. Capillaries are overrun by new induced wavelets until they reach a wavelength of about 1.73 cm (celerity of 24 cm/s). All larger ones are then called gravity waves by definition.

A few seconds after the initial disturbance saturation sets in and other mechanisms come into effect. In all phases the waves are changing their shape while they are combining and recombining all the time. Besides this wave-wave interaction a constantly changing interference pattern can be observed, while waves are piling up or vanishing in the next moment. Further phenomena like the sheltering effect, capillary blockage or parasitic capillaries can be observed. The final stage of wind-wave interaction is marked by a constant flow of energy from the air towards the waves⁹.
⁹ All recordings were done in this stage. Some time after turning on the fan (≈30 s) the wave field could be considered as constant in its shape.

Capillary waves can be significantly steeper that gravity waves. For them the maximum ratio between wave amplitude and wavelength cannot exceed the limit of 0.142 while the steepest ripples can reach a value of up to 0.73. For such a (short) wave the greatest height is reached when the surface bends back to touch itself enclosing an air-bubble between two crests. This fact could be an advantage for the new method because so a greater number of reflections over the same distance could enable a higher spatial resolution (more data can be evaluated for a given area).

The minimum wind speed for an initiation of gravity waves against the laminar dissipation in the water is about 1 m/s. To induce capillary waves this value should be somewhat lower.

Waves traveling upstream against the flow show an enhancement in wave steepness and roughness characteristics [15].

### Wave Dissipation

The whole discussion about the process of wave generation due to a wind flow excluded the important phenomenon of energy dissipation so far. Energy is dissipated during all stages of wave initiation; thus it is closely connected with this process.

Dissipation in the flume could be easily observed by eye: The wave field close to the fan contained many short waves with noticeable amplitude. Observation of these waves at a distance of about 70 cm from the fan showed them more gently (less jagged) with a longer wavelength but smaller amplitude (see section 2.3.2). Some time after turning on the fan a balance between new energy input and dissipation could be noticed.

Mainly the three processes bottom friction, internal- and surface dissipation cause wave attenuation: Bottom friction contributes extensively to attenuation for the case of long waves in shallow water. The energy gets dissipated due to significant horizontal motions of the water particles in a boundary layer near the bottom. This influence can be neglected for our experiments.

Viscous stresses acting throughout the wave contribute to internal dissipation (energy transfer into heat). This kind of attenuation happens at a comparatively slow rate and is only substantial for small wavelengths. The ones initiated by the fan (0.5−3 cm) thus definitely felt the effect of viscosity.

Surface dissipation can be associated with the effect of surface tension as the restoring force for the equilibrium. Furthermore the result of wave breaking causes noteworthy dissipation of energy; however, it could not be consciously observed for our experiment. In lateral diffraction, e.g. two-dimensional dispersion of the waves in the flume, another reason for the dwindling of the waves can be found.

Ripples and capillary waves are very susceptible to viscous damping. As a rule of thumb it can be said, that the smaller the wavelength the faster the wave will decay. Thus long gravity waves are hardly affected by viscosity while capillaries are rapidly damped out.

The dissipation of energy in short gravity waves by generation of parasitic capillaries on top of them has been investigated by [4].

The rate of wave attenuation over a given distance can be roughly calculated [2].

2.4 SWIV—Theory and Principles

Containing aspects from the three preceding sections 2.1-2.3 the method of SWIV could be developed. The theoretical background that leads to the governing equation, which enables a determination of the wave celerity or flow velocity, will be described here.

Positioning a fan close above the free surface of the open-channel flow represents a potential source of energy for the flow. By turning the fan on, this energy is supplied to the water flow in form of a wind flow perpendicular the water surface. The air jet hits the moving water surface and is dispersed in all directions, e.g. 360° around the fan (FIG. 2.11).

Two basic processes can be observed in the vicinity of the fan: By hitting the region of the flow directly beneath the fan, this area shows an unstable and turbulent surface. No regular wave pattern can be observed here.

However, from the edge of this region a circular pattern of capillary-gravitational waves appears and travels with a certain group celerity a distance of up to almost one meter from the fan¹⁰ (FIGS. 2.12-2.14).
¹⁰ This value depends considerably on the fan strength. However, (gravitational) waves can be detected at much further distances from the fan. The radius of one meter mentioned here represents a value, where this phenomenon is still easily visible and the waves are not too much affected from dissipation yet.

This process is supported by the influence of the airflow now parallel to the current. Many theories and simulations about the effect of a wind flow above a water surface have been published. Concluding, such a wind fetch can be considered as a shear force along the water surface. This force interacts with the flow and little waves are created or existing waves increased. At the same time on every point of the wave pattern the effect of dissipation takes place. Due to the constant supply of energy a relatively steady field of waves can be observed around the fan after a couple of seconds.

By setting up a camera directly above the fan and providing the adequate illumination, reflections from this light source can be recorded on each of the wavelets. SWIV makes use of one important property of these reflections: They follow the celerity of each wave exactly and without time-lag. PIV software then evaluates the images of these bright spots and thus is capable to determine the properties of the flow non-intrusively (FIG. 2.13).

If now the current to be investigated is flowing with a certain velocity in a certain direction and an additional wave packet with another celerity is induced on its surface, both velocity and celerity will be superposed and add up to another apparent velocity for each place of the stream.

In all directions this superposition will yield in different velocities and only along one line—the line representing the direction of flow—two extremes for the velocity, a maximum and a minimum, can be observed. The wave packet traveling upstream directly counters the flow and the resulting velocity at the surface will be a minimum—the flow velocity has to be subtracted from the wave celerity. Downstream of the fan, the superposition yields in highest velocities that can be observed in the investigated area.

FIG. 2.14 shows this behavior qualitatively; here the fan induces a wave packet above a still water surface (left) and above a stream that is flowing constantly at a velocity smaller than the celerity of the wave packet (right).

A qualitative diagram for the velocities (celerities) along the centerline of the flume gives more clarity about the processes caused by the fan.

Two governing equations which describe this phenomenon can be derived from this diagram. The velocity of a flow and the celerity of the induced waves can be calculated as follows:
ν_{FLOW}=(ν_{Downstream}+ν_{Upstream})×0.5 [14]
ν_{CELERITY}=(ν_{Downstream}−ν_{Upstream})×0.5 [15]

These two equations are sign-sensitive. Depending on the strength of the fan or the velocity of the flow there are two observations on the upstream side of the fan possible:

For a fan stronger¹¹ than the flow itself wave patterns are traveling in all directions away from the center of the fan. Defining a coordinate system with the x-axis pointing along the direction of flow (FIGS. 2.15 and 3.5), the upstream velocities for this case must be considered as having a negative sign; downstream velocities are to be considered as positive to be able to apply the equations.
¹¹ Celerity of waves caused by the fan is higher than the velocity of the underlying flow to be observed.

For a flow with a velocity higher than the celerity induced by the fan no wave patterns can be observed on the upstream side—for this case the technique does not work (Chapter 5.5.4). In Chapter 5 the equations will be developed further before they can be used for any applications.

The technique of SWIV comprises elements from different fields of hydraulics and hydrodynamics and combines them in a new way. Still, principles and governing equations are pretty much straightforward and make the method to an interesting alternative for velocity measurements.

### 3 Experimental Design and Procedures

3.1 Facilities

All laboratory experiments were carried out in the large sediment flume located in IIHR's Model Annex. All field experiments were carried out at the Iowa River, Iowa City.

### The Flume

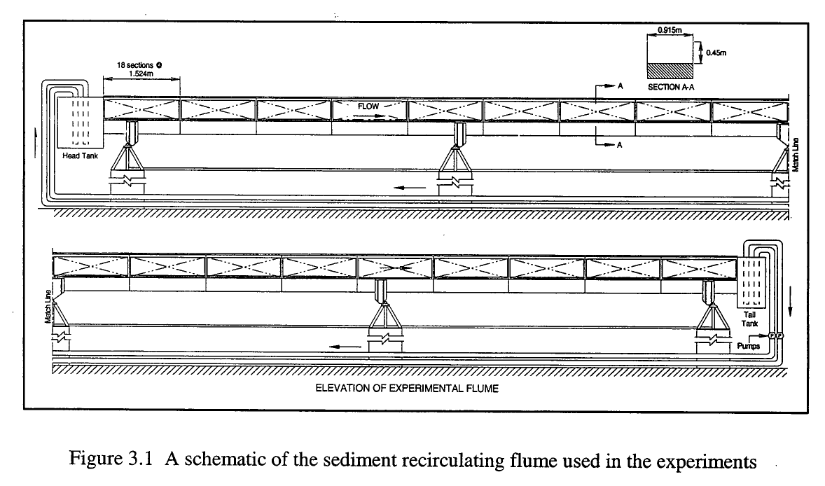

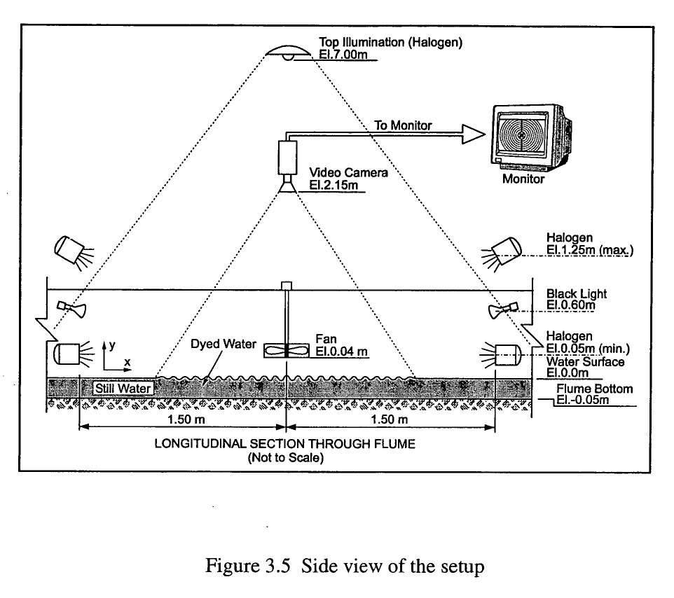

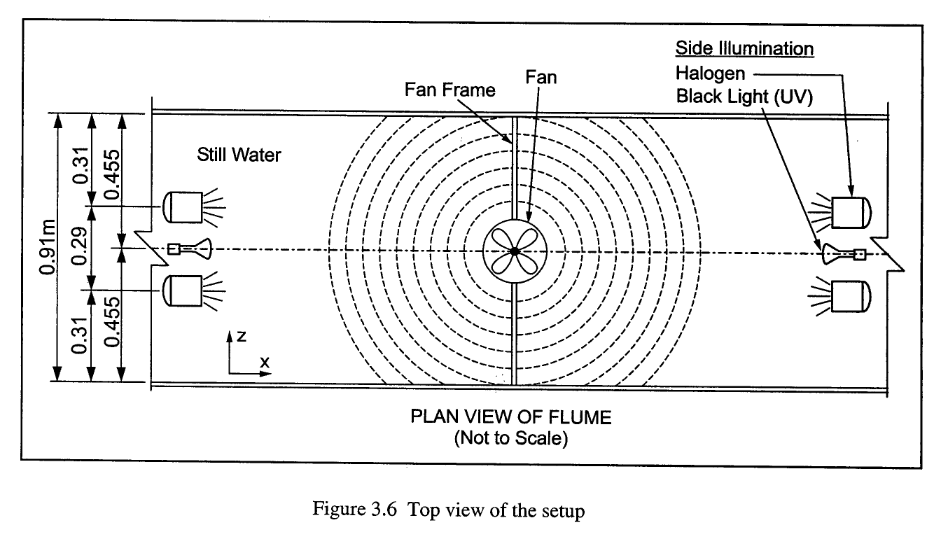

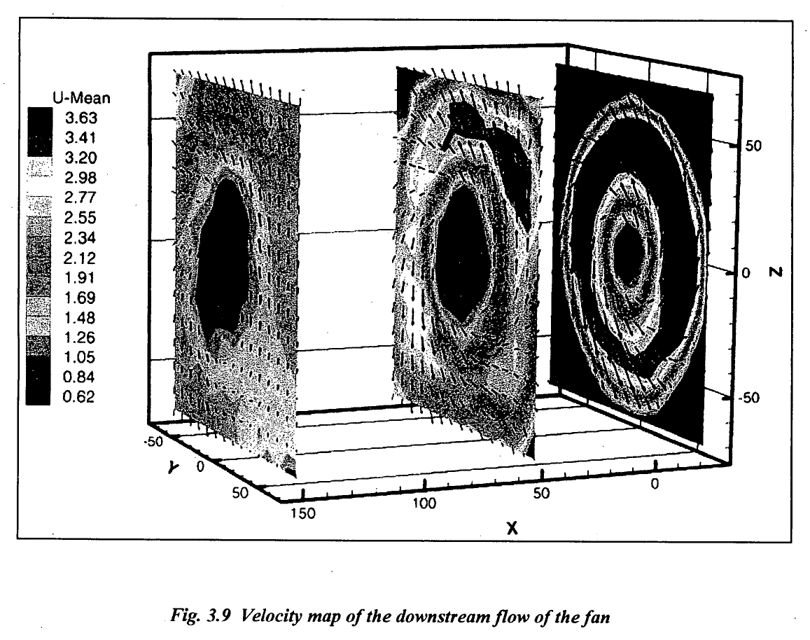

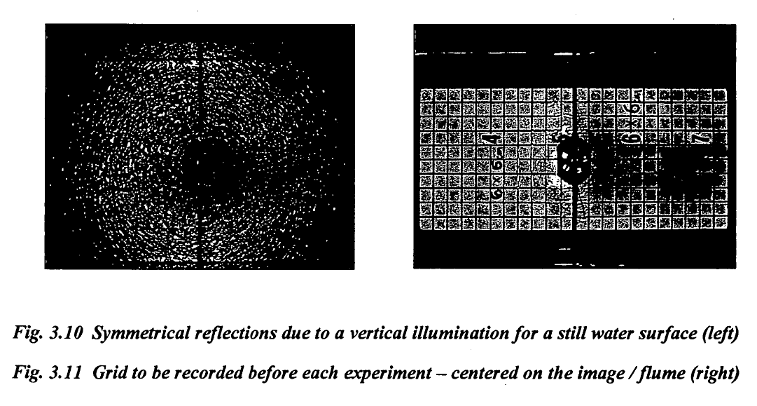

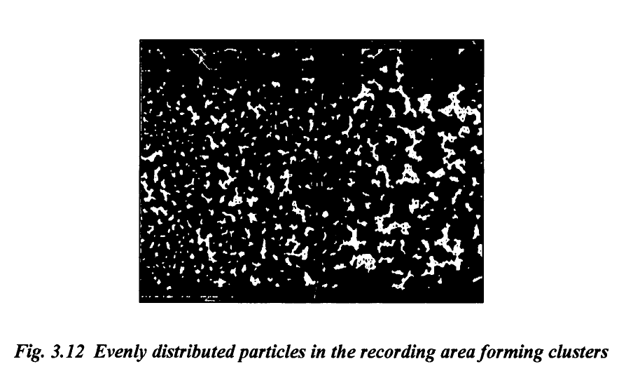

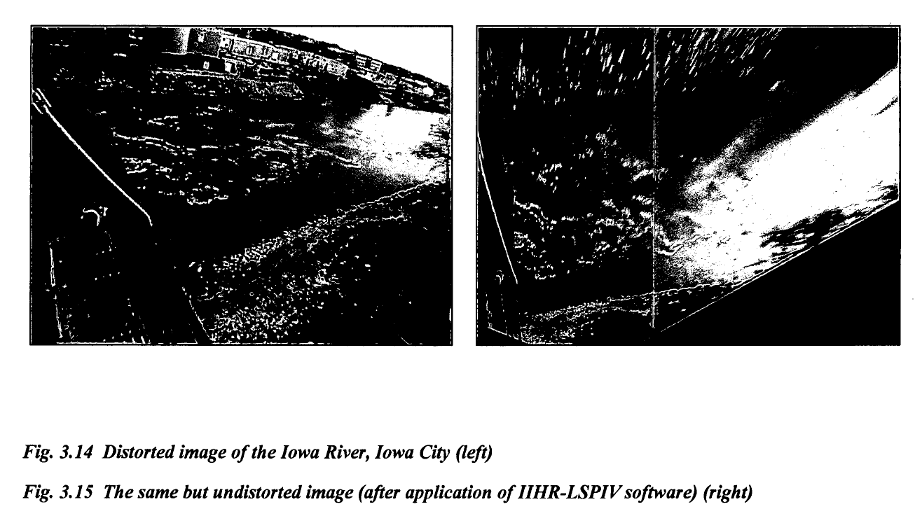

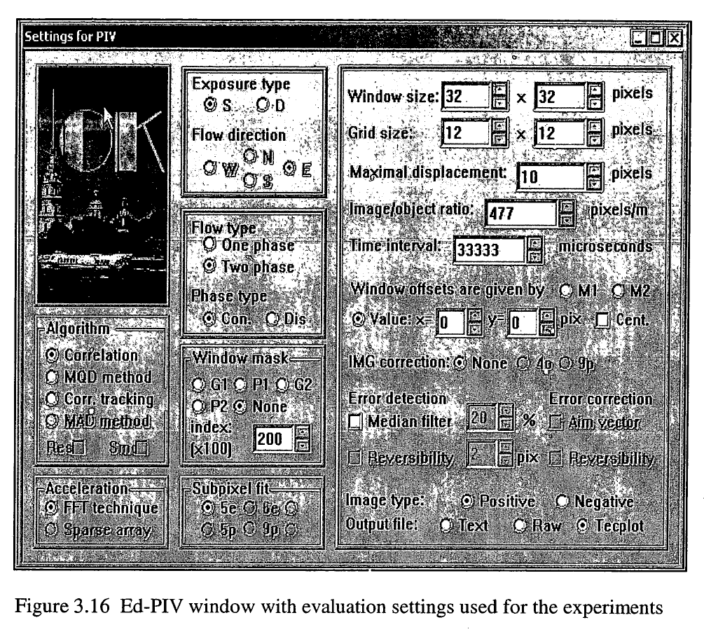

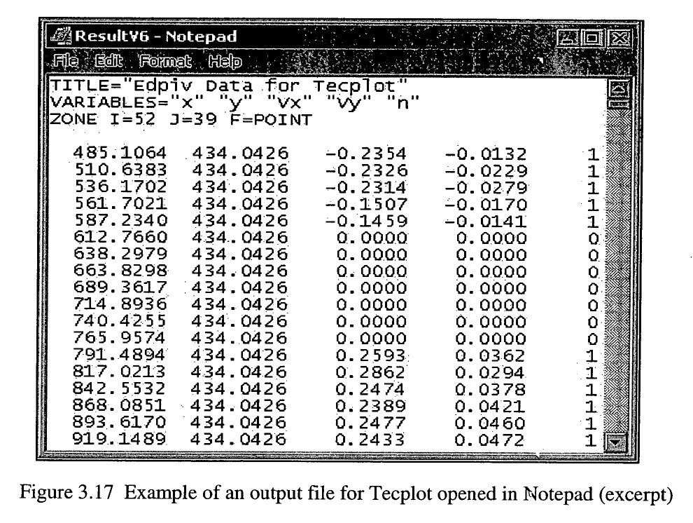

The sediment flume, as shown in FIG. 3.1 is 30 m long, 0.91 m wide and 0.45 m deep. The flume walls are made of glass to facilitate flow observation. Flume bottom is made of smooth concrete. FIG. 3.1 shows a side view and a cross section of the flume.

Two pump assemblies were used to recirculate the water. The larger pump unit has a 10 horsepower and variable-speed motor, whereas the smaller pump has a horsepower of 1 and fixed motor speed. Both pumps are located under the flume tail box. From there the flow is returned to the head box of the flume via two 0.25 m-diameter pipes. Before entering the open channel, the flow passes through straightening devices aimed at evenly distributing the flow to the flume cross section.

Four synchronized screw-driven jacks located at the ends and quarter points of the flume allow the flume to tilt around its midsection without interrupting the flow. The slope of the bed can be measured by means of a point gauge located at the downstream end of the flume.

Water-surface elevations can be measured using 8 piezometers spaced in 3.048 m intervals along the flume. The piezometers are tapped at 0.065 m above the flume base. The pressure taps are connected with tygon tubing to a bank of glass manometer tubes located near the flume.

Precisely leveled steel rails for the instrument carriage, mounted on the flume walls provide the reference frame for the present measurements. For these experiments the steel rails were used to fix the fan, the lights for illumination and the carriage for the tripod of the video camera.

FIG. 3.2 shows a photograph of the (empty) flume looking downstream towards the experimental setup. The flume can reliably develop uniform, fully developed flows over the most of its length.

The flume discharge was measured using two orifices located in the return pipe. The orifices were connected to a differential manometer (FIG. 3.3) set next to the flume. It allowed a reading of the pressure head Ah at the orifice. The calibration equations for the orifices, established in the IIHR's calibration facility are
Q=1.8436*(Δh)exp(0.4936) for the big pump and
Q=0.092*(Δh)exp(0.5) for the small pump respectively.

### The Flow

Uniform flows for a given depth were established by successively changing the flume slope for a given discharge and observing the depth of the flow along the entire length of the flume. Following a change in the flow conditions, large waves could be observed in the in the flume traveling between the headbox and the tailbox. At least 10 minutes were needed to establish a uniform flow following such a change. The experiments were started after the surface of the flow was completely calm with the large waves completely dissipated.

Extreme attention was given to the shallow water flows to ensure that the incoming flow was evenly distributed over the cross section. For very shallow flows (less than 0.025 m), additional weirs were set next to the headbox and tailbox in the flume to overcome this problem.

For relative deep water flows (larger than 0.20 m) the flow velocity was limited by the capacity of the pump. Using the small pump the maximum attainable mean velocity in the flume for a water depth of 20 cm was only about 8 cm/s. Still a sufficient number of high-quality experiments could be carried out with water depths ranging between 0.025 to 0.10 m and flow velocities of 0.02 to 0.10 m/s.

All flows were set up to be subcritical and non-turbulent¹².
¹² The maximum Froude Number in the experiments was 0.29. All Reynolds Numbers were smaller than 5000.

3.2 SWIV Arrangement

SWIV is different from conventional LSPIV through its capability to trace the free-surface velocity of the underlying flow without the use of seeding particles on the flow surface. SWIV assumes presence of free surface waves of known velocity and direction. In combination with a strategically positioned illumination this allows a tracking of the wave crests in successive video frames.

### Experimental Setup

Thus the experimental setup used herein to track the free surface waves consists of essentially three components:
a fan to create the desired waves
light sources to create reflections at the wave surface, and,
a video camera to record the wave motion.

The components of the experimental setup were grouped in an assembly positioned at a distance of 17 m from the flume entrance, where fully developed flows could be reliable obtained. The FIG. 3.4 shows a photograph of the experimental setup.

In the photograph all components of the SWIV technique are visible: The fan is placed above the water surface between two frames carrying the halogen spots. The camera is attached to an arm directly above the fan. The tv-set and the manometer (foreground) complement the setup.

The FIGS. 3.5 and 3.6 give a principle overview about the components of the SWIV technique and provide qualitative information about the dimensions of the setup. The single components of the SWIV method and their features will be described in the following sections.

### The Fan—Features

Two commercially available axial fans were used in the experiments. A small fan with 5 blades and a diameter of 11 cm (height of cylindrical guide 3.5 cm) was used as well as a stronger fan with 3 blades and a diameter of 21.5 cm (height of cylindrical guide 8.5 cm). A power controller was used to adjust the rotational speed of the fans. The FIGS. 3.7 and 3.8 show the fans used in the experiments.

Both fans were set on the flume centerline. They were fixed above the water on a horizontal traverse, sitting across and atop of the flume railways. The traverse was designed rigid enough to support the fan, but keeping its dimensions at minimum was done not to block the video camera viewing area. This was especially important because the waves produced by the fan were tracked in all directions, e.g. 360°.

All-thread rods were used to position and adjust the fans at the desired height. Use of the all-thread rods facilitated positioning the fans relatively to the water surface to accommodate various water levels in the flume. Following trial-and-error preliminary tests, an optimum distance of 4 cm between the fan and the water level was deemed as adequate and was maintained constant for all subsequent measurements.

A water level was used to set the fan in the horizontal position. Horizontality of the fan is crucial for SWIV measurements, thus efforts were made to set the fan perfectly horizontal in order to evenly distribute the outgoing jet produced by the fan on the flow free surface.

The limited width of the experimental flume (i.e., 0.91 m) caused interference of the waves propagating in the spanwise direction. Standing waves were formed along this direction in the vicinity of the walls. The wave interference was exacerbated for the stronger fan. Therefore, a motor controller was used to adjust the fan power up to an acceptable compromise between a sufficiently regular wave pattern and as few wave reflections as possible. For the small fan this device was not required—even with a power of 100% the reflections at the flume walls were negligible. In Chapter 5 this problem will be discussed more detailed.

### The Fan—Action

This paragraph is closely related to Chapter 2.3 (“Wave Theory and Wind-Water Inter-action”). However, it was included here to show the importance of the relative distance of the fan to the water surface.

A fan, running at a constant rotational speed, creates a highly swirling flow along its axis. The velocity field is associated with a pressure field with maximum values on the axis, where the total velocity is minimum. The coupled velocity-pressure field is diminished at a certain distance from the fan. FIG. 3.9 shows the velocity field created by a fan similar to the smaller one used in our experiments. Three parallel cross sections located directly at the exit, at 5 cm and at 15 cm from the exit have been investigated (the fan is located on the right side).

The axial velocity component is color coded (changing from mainly purple and red at the exit to green and a light blue in a distance of 15 cm). Tangential and radial components are shown as vectors, which demonstrate a decrease in velocity magnitude as well.

The high swirl and the circular contour of the fan can been seen very well in the cross section of the fan exit. Furthermore the downstream evolution of the flow shows besides a decrease in overall velocity magnitude a vortex core increasing in diameter and irregularity.

For the experiment the distance between the water surface and the fan exit was kept relatively small to benefit from this well shaped vortex core and comparatively high tangential and radial velocities. For this distance the already mentioned a value of 4 cm was chosen for the majority experiments.

### Illumination

The illumination of the wave crests is a critical part of SWIV. Extensive preliminary experiments were carried out to cope with the complexity of achieving proper wave crest illumination. Four distinct sources of illumination—Halogen spots, high-pressure Sodium spots, UV lights and daylight—were tested to find the optimum light type and positioning for the illumination to successfully track waves in the recordings.

### Side Illumination

Initially, it was tried to record reflections on the water surface caused by two Halogen lights positioned close to the surface, upstream and downstream from the fan location respectively. A pair of spots was attached to a custom-made wooden frame using all-thread rods, pointing at the free surface in the vicinity of the fan. The rods allowed to position the lights at variable heights from the water surface (0.05 m) up to 1.25 m.

Using a video camera equipped with automatic gain control, lights positioned too close to the fan caused the aperture of the camera to open too much, while positioning the light to far away resulted in significant loss of light intensity. For both illumination scenarios low quality recordings could be only be achieved. A distance of 1.5 m between fan and lights, however, was found to be a good compromise.

### Indirect Illumination

Another set of experiments was conducted with the Halogen lights pointing upward toward the ceiling at white boards positioned above the flume. A board was hold at an elevation of about 1.40 m above the water level. This illumination configuration provided an indirect illumination of the waves, similar to the diffuse light of a bright sky (no sun reflection).

### Vertical Illumination

Finally, a strong light source on top of the camera centered on the camera-fan axis was found to be the best illumination alternative. The light rays generated from the top light (or equivalently from a set of lights positioned atop of the camera on a circle set of the camera-fan axis) create strong reflections on the wave crests. The specular reflections are symmetrically distributed due to the co-axial SWIV configuration (see Chapter 2.4 (FIGS. 2.11-2.14)). FIG. 3.10 shows the image of uniformly distributed reflections caused by the discussed type of illumination.

A combination of the illuminations discussed above did not improve the overall performance. Therefore, the top, co-axial illumination arrangement using one light source was deemed as superior to all previous tested configurations and was used for the set of subsequently tests.

### Recording

A video camera (Sony Digital HandyCam) was used to record the laboratory and field experiments. All recordings were made in short-play mode to get best quality recordings.

The Camera was attached to an arm extending from a tripod, which was sitting on top of a carriage located downstream, right next to the recording area. The camera was centered above the fan at an elevation of 2.20 m above the flume bottom. So it became possible to record equally sized areas of interest on both sides of the fan. The camera was zoomed to frame only the area of interest in the flume. This framing was done because of to two reasons: with a zoomed image the object-image ratio (pixels per meter) becomes higher, which yields in a better spatial resolution. Furthermore, zooming a picture keeps the (error causing) distortions due to the viewing angle small. Manual focusing was used because the available autofocus mode is difficult to operate on moving surfaces without sharp defined objects in the video camera sensitive area. A grid marked on a plywood panel was placed close to the water surface to provide well defined network for the camera to focus on (FIG. 3.11).

To facilitate the steps of framing, zooming, focusing, and recording the camera was connected to a TV monitor set adjacent to the flume. All recordings were made by operating the camera by its remote control, such to avoid camera disturbance after setup.

### Dying

During the preliminary experiments it was noticed that the camera tracks both reflections on the surface and shadows (refracted incoming rays) of waves on the flume bottom as well. In order to simulate the actual field conditions accurately (where these reflections do not occur) the water in the flume was dyed dark blue to ensure that only light reflections on top of the water surface are recorded. The dye used was food-coloring dye; it was uniformly mixed into the water by running the big pump for a while (see Chapter 4.1.4).

3.3 LSPIV Arrangement

The traditional LSPIV method was used to validate the SWIV technique by giving a reference. LSPIV experiments were conducted immediately following the SWIV experiments in order to have the measurements on identical flows. The fan was shut off and the SWIV illumination was replaced by the LSPIV illumination configuration described below.

Essentially, LSPIV entails the same steps and procedures as SWIV, excepting setup and procedures associated with the illumination and flow seeding. In traditional LSPIV the flow is seeded at the surface and appropriate illumination is required to get a good resolution of the small particles carried with a flow (see Chapter 2.2, LSPIV—Explanation of the Technique).

### Seeding

LSPIV seeding was accomplished with Styropor beads. The bulk density of the expandable polystyrene particles was 12.5 kg/m³ and thus their features—very light, easy to handle and white—made them very suitable for the purpose.

A hopper positioned about 4 m upstream the test section was used to evenly distribute the particles in high velocity flows. For the low flow velocities, manual seeding was appropriate.

After their release on the free surface the electrostatic forces acting on the polystyrene particles grouped them into clusters (FIG. 3.12). This process stopped after clusters of a size of about 2-3 cm in diameter were formed (usually 3-4 seconds after release).

The distance of the seeding section from the test section was established such that the clustering process did not take place in the test section. The beads were removed after each experiment to keep the flow undisturbed and to maintain same conditions between experiments.

### Illumination

The seeding particles need to contrast the background, therefore various alternative scenarios have to be implemented, i.e., bright color particles on dark background or vice versa. For the present experiments, seeding particles were white. Therefore, bright reflections on the bottom of the flume or the water surface must be avoided because they could interfere with the images of the seeding particles.

To achieve these conditions, LSPIV recordings were conducted in a total dark environment (studio type of illumination), with controlled illumination directed toward the recorded images. Two Halogen bulbs on both sides of the fan, at a distance of 1.50 m and elevation of 1 m were used. To intensify the visibility of the white seeding beads, two UV light bulbs on both sides of the fan were added to the illumination system (FIGS. 3.5 and 3.13).

Attached to the frame for the Halogen lights the UV bulbs were set at an elevation of 0.60 m pointing downwards on the area next to the fan.

Special attention was also given to avoid spurious reflections from setup surfaces (camera arms, traverses, camera body, etc.). All of the potential reflective surfaces were painted in flat black.

3.4 Evaluation of Recorded Data

During the preliminary experiments, every recording was followed immediately by image processing to recognize, evaluate, and correct possible errors. At the same time this approach allowed identification of more advantageous settings. Two types of image processing software were used for the present experiments: Ed-PIV and IIHR-LSPIV. Both are in-house developed [25, 28]. Before the actual image processing could take place, several pre-processing steps had to be conducted first. Their purpose is to change the format and appearance of the data to meet the needs of the evaluation software and also to improve the quality of the results.

### Pre-Processing

### Capturing the Movie

The flow recordings were inspected first to retain the best video segments. The transfer of the digitized images from the video camera to PC was accomplished with the software ‘Pinnacle—Studio’ (Version 7.01.3) and a custom video card. The selected material was captured as a movie file (format: .avi) to the hard drive of the PC.

### Conversion of the Movie Files into Frames

Image processing in LSPIV is typically made by comparing subsequent frames in a recording sequence. Thus, in the next step the movie file needed to be split up into its individual frames. This was accomplished with Adobe software ‘Premiere’ (Version 5.1). After loading a movie (to be split) some important settings had to be made first.

Currently, there are basically two standard video formats: PAL (Phase Alternating Line) used mainly in Europe and NTSC (National Television System Committee) used in North America. The two systems differ in line resolution and vertical frequency (frame rate). For the present experiment the NTSC system was used with a frame rate of 30 frames per second (FPS).

Accordingly, a video sequence of 10 seconds will be split into 300 pictures (frames). Frames were produced in bitmap (.bmp) format of 640×480 pixels (width×height) and a quality of 100%. A resolution of 640×480 proved to be sufficient for the experiments needs.

### Deinterlacing

Video frames consist of two fields, e.g. the even and odd lines counting from the top of the frame. These fields are recorded (displayed) for half the time of the frame rate (e.g. 1/60 s). Fast moving objects in a frame (here: the reflections on the water waves) tend to smear and can cause processing errors. If the patterns in the recorded images move too fast, deinterlacing is used to “freeze” their images.

Deinterlacing, however, produces loss of resolution, due to the fact that only half of the TV lines in the video fields contain information. After removing one field, the missing information can be replaced by duplication or interpolation. Frame deinterlacing decreases the quality of an image, but under certain circumstances, it still provides more precise information than smeared frame images.

### Converting the Frames into Grayscale Format

A correlation between two subsequent images is done based on similar or equal patterns in both pictures. Patterns can be simple dots, lines, complex shapes, different shades, dark and bright areas and other typical distinguishable features.

To limit the effort and extent of evaluation, all pictures needed to be converted from the RGB mode to grayscale first. The RGB (Red Green Blue) mode allows to reproduce up to 16.7 millions of colors. By converting it into the grayscale mode, every pixel can contain the information about one of 256 possible gray levels. Brightness values ranging from 0 (black) to 255 (white) limit the possibilities of a given correlation.

The conversion was facilitated with Adobes software ‘Photoshop’ (Version 6.0). The batch command (used to automate actions) proved as very useful in handling the large number of frames to be converted.

### Determining the Object-Image Ratio

Every PIV software requires a known spatial reference to be capable of calculating the real velocities in a given flow. After a successful correlation the time interval between two subsequent pictures and the traveled distance of a feature in pixel-units are given. However, this distance needs to be related to real world dimensions first before it can be divided by the time interval, e.g. the frame rate.

Every experiment was preceded by a recording of a grid set close to the water level. It was recorded first after the camera was set up correctly. The single image containing the grid was used as a reference for the following experiment.

The object-image ratio could be determined with Adobes ‘Photoshop’ zooming and information tools. The grid (FIG. 3.11) showed a pattern of squares with a known dimension of 6 cm. Four points at intersecting lines were chosen. Their distance to each other is known by multiplying the number of squares by their length (6 cm). Zooming into the picture enabled a determination of their position related to the image coordinate system (origin: 0, 0 upper left corner; lower right corner: 640, 480) with an accuracy of 1 pixel. By knowing the distance between the points in pixel units and in real world units the object-image ratio could be easily calculated in a spreadsheet.

### Image Processing

### IIHR-LSPIV Software

During early stages of the preliminary experiments all evaluations were done with IIHR-LSPIV software. This had the advantage, that the software could be still modified and bugs removed; on the other hand explanations about the principle of the program were available from first hand.

Basically this program offered the same features like the software described next, with one exception: Specifically designed for LSPIV recordings, IIHR-LSPIV contained a routine to handle distorted pictures. Recordings under field conditions usually deliver distorted images. All recordings in an inclined (not perpendicular) angle to the water surface will yield in more or less distorted images (FIGS. 3.14 and 3.15).

The smaller this angle the higher the degree of distortion becomes. The software offers the possibility to calculate true velocities by undistorting the image first (which then looks somewhat strange but with realistic relations of length) and then performing the LSPIV evaluation. This image transformation requires the real world coordinates of at least 6 known points as well as their corresponding image coordinates. In the case of a field experiment a geodetic survey has to be done first (using prominent features in or next to the river); for our experiments the grid delivered these coordinates.

The result of the transformation was predictable: Because the camera was vertically centered above the water surface, the recorded images were already undistorted and so the transformation did not change the appearance of any picture. This feature of the program confirmed the accuracy of the experimental setup.

### Ed-PIV Software

From the mid of the preliminary experiments another software was used for data evaluation. This software, called ‘Ed-PIV’ (Version 3.01), proved superior to IIHR-LSPIV in terms of efficiency and required time. It has numerous features and only the important steps will be described here.

At first a list-file had to be created containing all the images that were to be evaluated. This file also contained information about how to evaluate the pictures, e.g. every picture (1 with 2, 2 with 3, 3 with 4, etc.) or pairs of pictures (1 with 2, 3 with 4, 5 with 6, etc.). By choosing the first alternative and, e.g. a given number of 300 images, 299 pairs of pictures were evaluated—a sufficiently large number to weaken the influence of possible erroneous vectors.

Ed-PIV offers the possibility to create “masks” to cover areas in the picture which are not part of the flow or which show no promising features, e.g. flume walls, fan and water surface without reflections. Masks are simple bitmap files with only two types of grayscale: 0 (black) for the area to cover and 255 (white=transparent) for the area of interest.

After loading list-file and corresponding mask-file the crucial part of the evaluation had to be done: The evaluation settings were chosen carefully; here the experiences from the preliminary experiments proved to be very helpful. FIG. 3.16 shows the screen for the settings used in (most of) the experiments.

The correlation algorithm and the Fast Fourier Transform (FFT) technique were chosen, every picture (frame) was exposed just once. A too small interrogation area (IA) might fail to detect the actual flow correctly, while a too large IA does not improve the result considerably and takes a very long time for evaluation. After trying several settings for the IA that were ranging from 16×16 pixels up to 64×64 pixels, finally a size of 32×32 pixels proved to be the best compromise.

Initially the size of the grid was set to 16×16 pixels or larger. This was done to save time and was sufficient to get an idea about the observed flows. Later the grid size was decreased to 10×10 pixels. The evaluation took considerably longer now, but yielded in much denser spatial information about the celerities of the waves around the fan.

This however, was a crucial requirement: A large number of valid vectors along the centerline of the flume provided the basis for getting any reliable information about the flow with the SWIV technique.

Before entering a pixel value into the field for maximum displacement, this number had to be found out first roughly. Loading two consecutive pictures into Adobe Photoshop and using the zoom and information tools, the coordinates of a prominent feature on both frames could be compared and a first insight about the displacement over a period of 1/30 s was possible. Then the determined number could be entered, always keeping in mind, that it should not be smaller than the actual displacement. So for safety about 5 pixels were added to the number found out in Photoshop. An adequately chosen number for the maximum displacement makes the evaluation more efficient.

In the next fields the earlier determined object-image ratio and the given time interval between two successive pictures (1/30 s=33.333 μs) were entered. No correction methods or filters were used. Before the evaluation eventually was started, the type of the output-file, Tecplot, was selected.

One evaluation took, depending on the amount of pictures and the settings used, about 15 minutes¹³. The software finally prompted the user to enter a name for the output-file (format: .dat), which could be opened by any editor, e.g. Notepad or WordPad.
¹³ Settings for 15 minutes: 300 pictures, 299 Pairs, 32×32 IA, 10×10 Grid, Maximum displacement: 12

### Post-Processing

### Ed-PIV Features

After a successful evaluation a first insight in the quality of the results could be gained. An excerpt of an output file opened in the Notepad editor is shown in FIG. 3.17.

The header of such a file contains the information to load the file correctly into Tecplot. The data itself is organized in five columns; one row represents the complete data of one grid point. The first two columns show the real world coordinates X and Y of a grid point. For the example given, the grid points are 25.5319 mm apart (spacing between two consecutive X-values). For the excerpt in FIG. 3.17 the second column shows only one value for Y because results in Ed-PIV are listed line by line.

The columns three and four contain the values for the velocity in x- and y-direction respectively. Some velocities show a negative sign due to the definition of the coordinate system: Negative x-velocities are actually pointing to the left (upstream area to the left of the fan), then an area with no velocities is shown (masked area under the fan) followed by positive x-velocities pointing to the right (downstream area to the right of the fan). The last column contains the two values of either one or zero. Only if the coefficient of correlation had a value of greater than 0.5, the correlation is considered successful (value: 1) and a velocity could be determined for this particular grid point.

### Data Visualization using Tecplot

For optical presentation of the data the software ‘Amtec Tecplot’ (Version 9.0) was applied. After loading the data file into Tecplot a multitude of features could be used. More information about Tecplot and several outputs can be found in Chapter 5.

### 4 Preliminary Tests

Before the pre-defined set of high-quality experiments finally could be carried out a multitude of tests had to be done first. Several problems had so be solved and different alternative settings were tested until the most suitable and promising setup could be found. Among other challenges principally three out of the four basic steps for LSPIV (SWIV) were painstakingly tested: Illumination and thus “seeding” of the flow as well as different alternatives for processing the data.

4.1 Illumination Alternatives

The method of illumination proved to be the crucial part for the new method to develop. Little changes in the setup could cause significant differences in the results.

### Direct Illumination near the Water Surface

The very first tests in the water flume were carried out with Halogen spots fastened with all-thread rods to the frame on top of the water flume (FIG. 3.13). By using the all-thread rods the bulbs were fully adjustable in height and could be moved from the water surface (≈0.05 m) up to a height of 1.25 m on both sides of the fan.

The distance of the spots to the fan proved to be of influence too: By setting the bulbs too close to the recording area very bright reflections on the flume bottom caused the aperture of the camera open too much; setting the spots too far away the recordings showed a significant loss in quality. As a good compromise a distance of 1.50 m was used throughout the preliminary experiments.

Initially it was tried to capture the moving reflections on every wave front by setting the Halogen spots on the same level like the waves, e.g. the water level. However, this method did not show very promising results. As possible reasons for this behavior the very small wave heights caused by the (small) fan and the position of the halogen bulbs (which were not exactly at the water level but actually up to 10 cm above) were assumed.

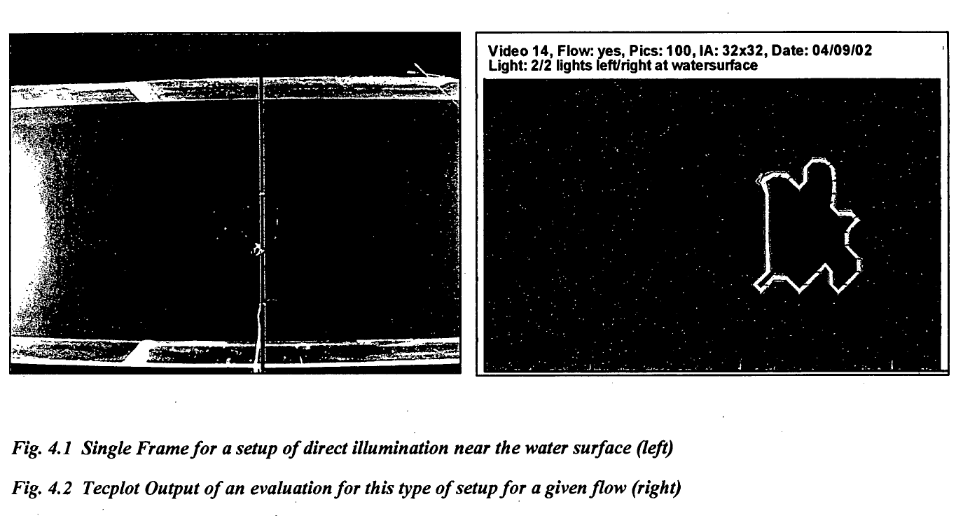

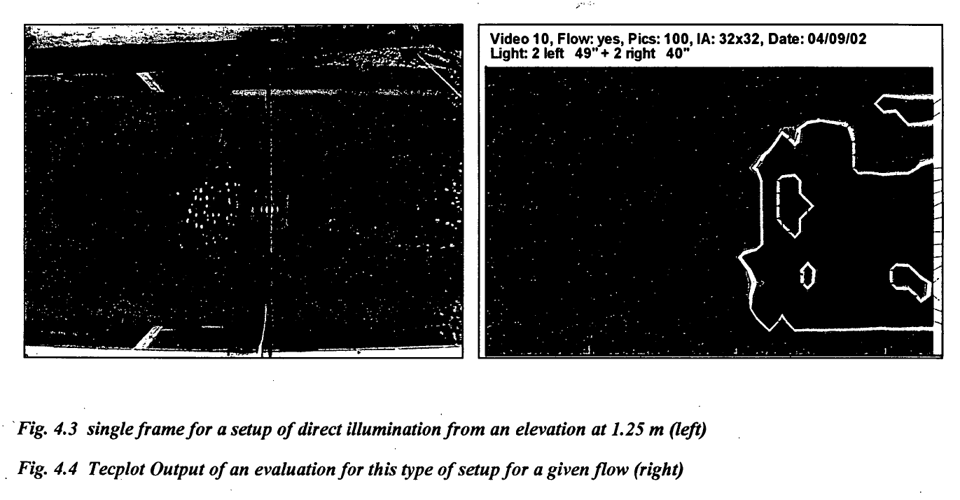

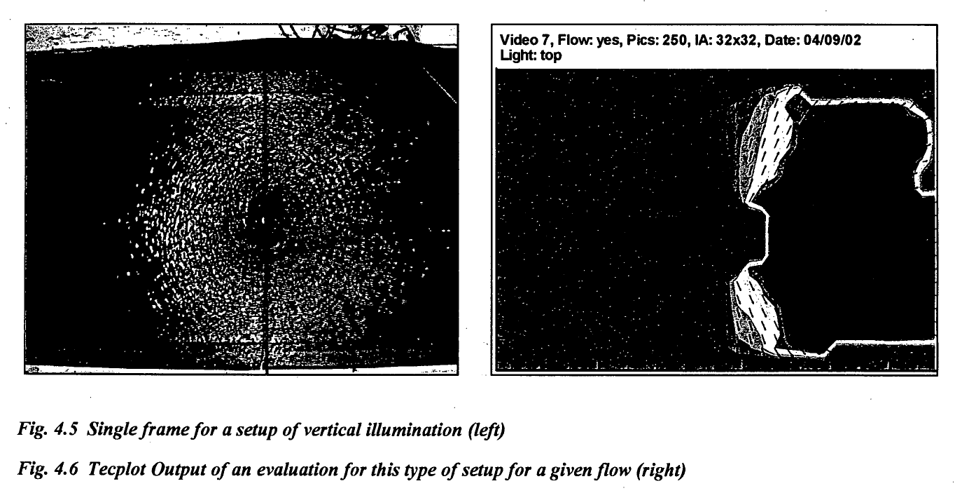

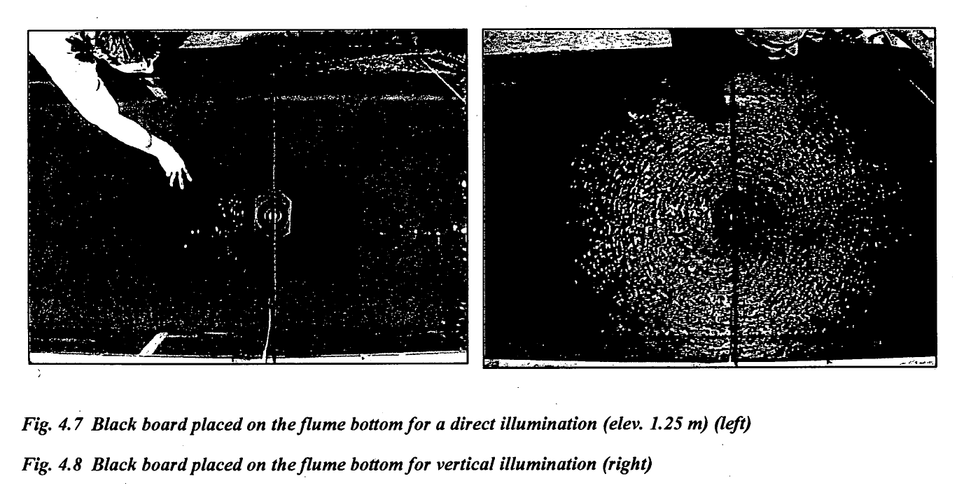

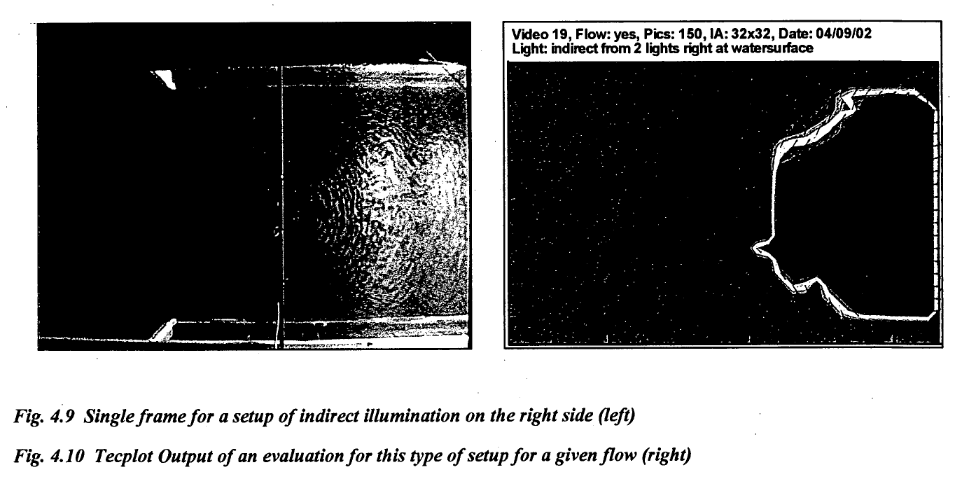

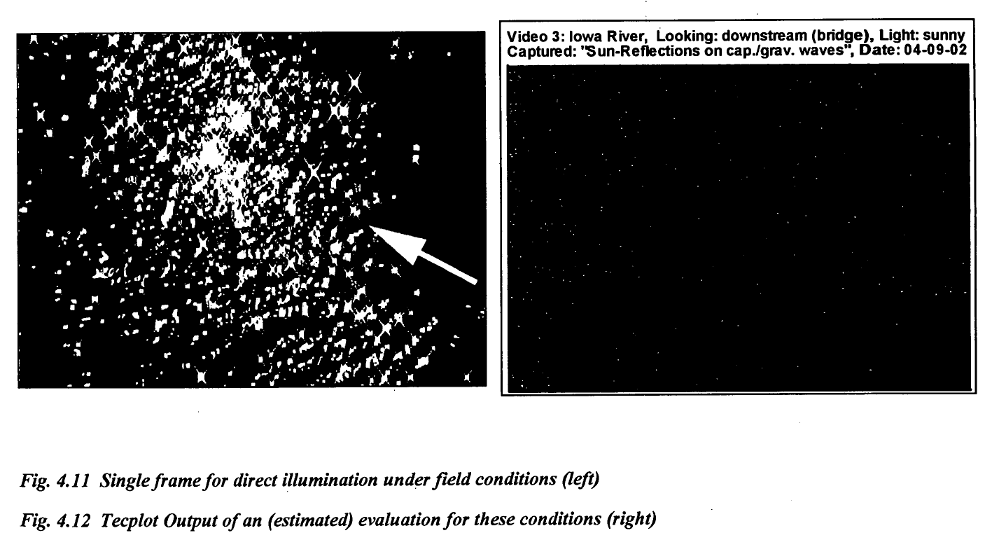

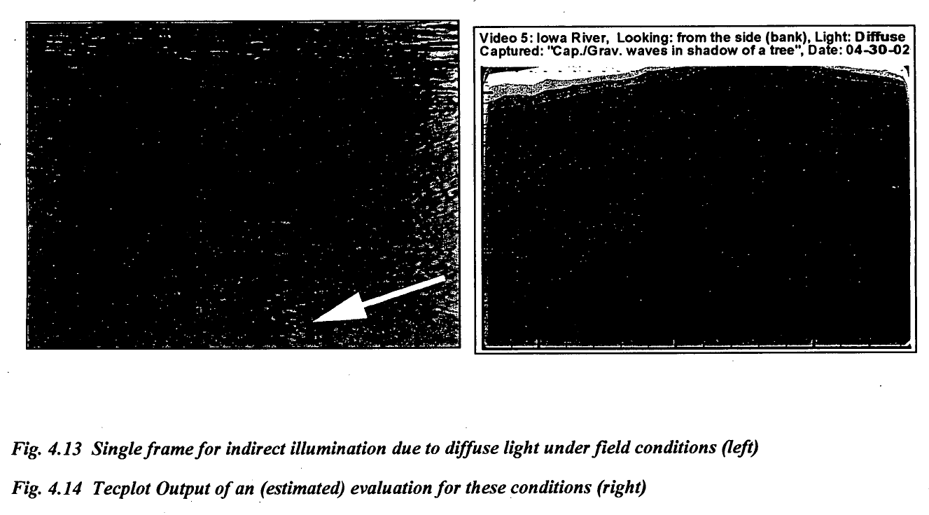

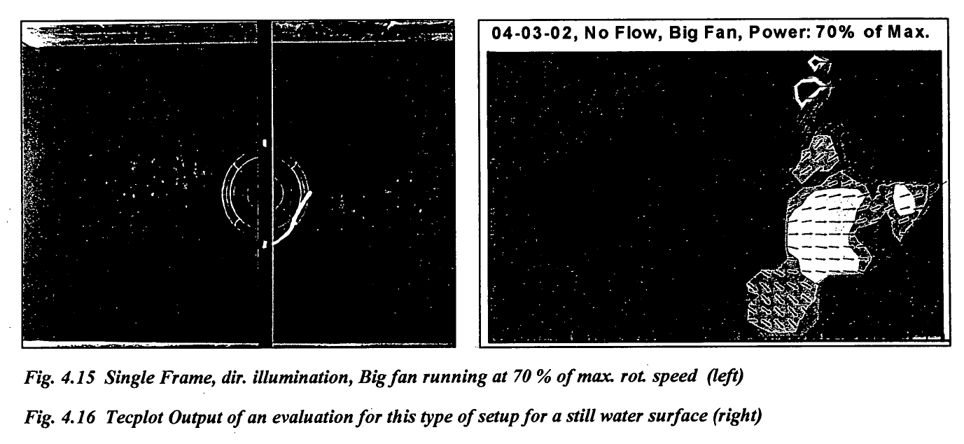

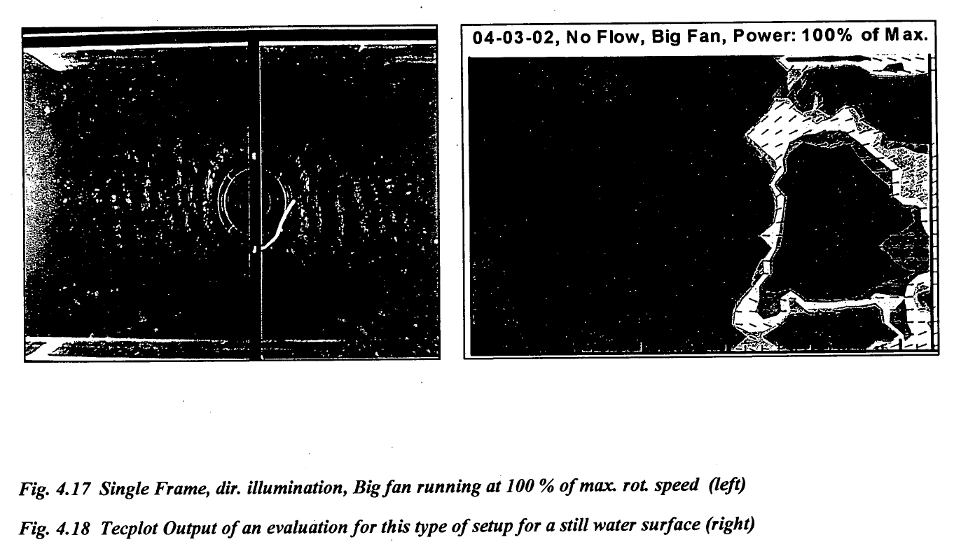

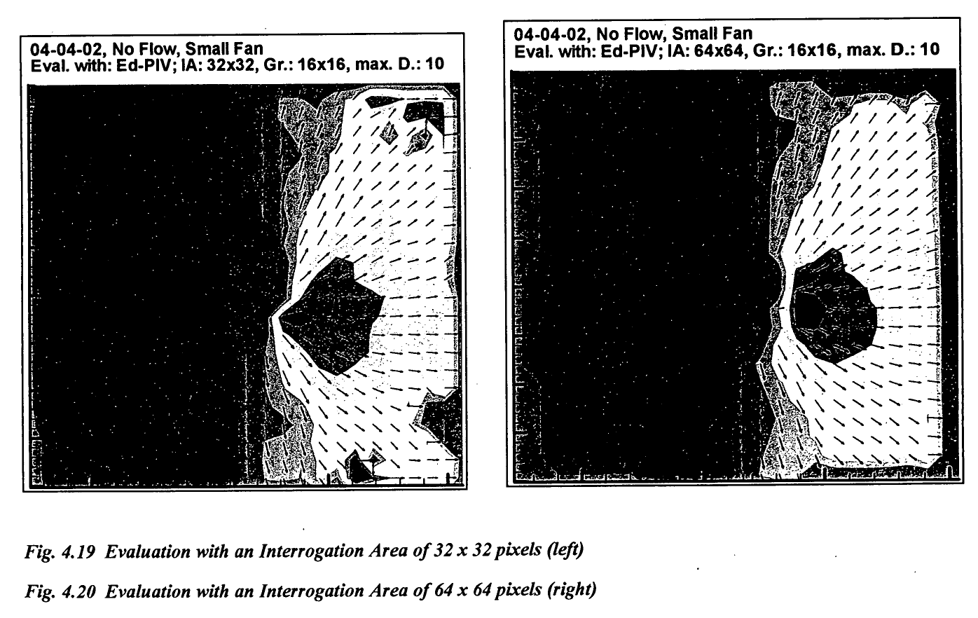

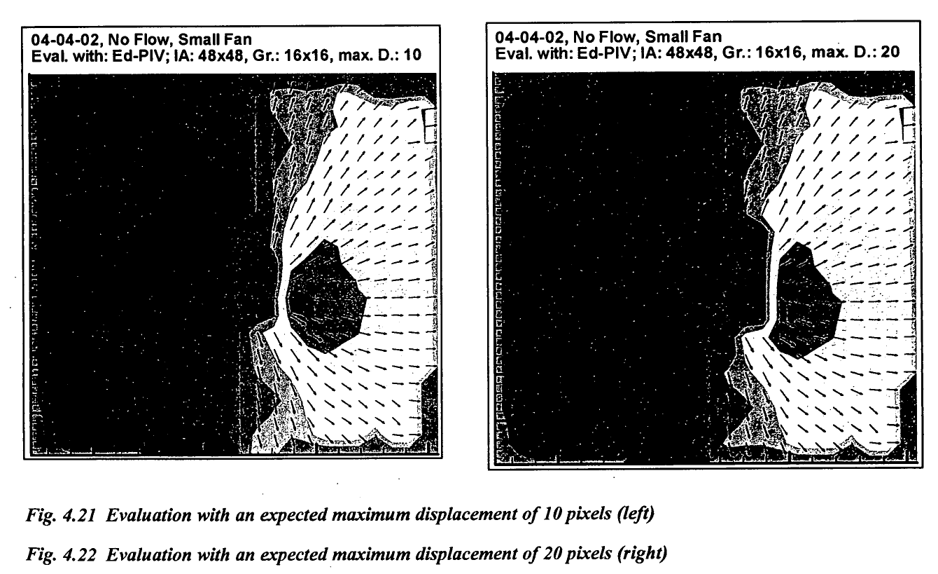

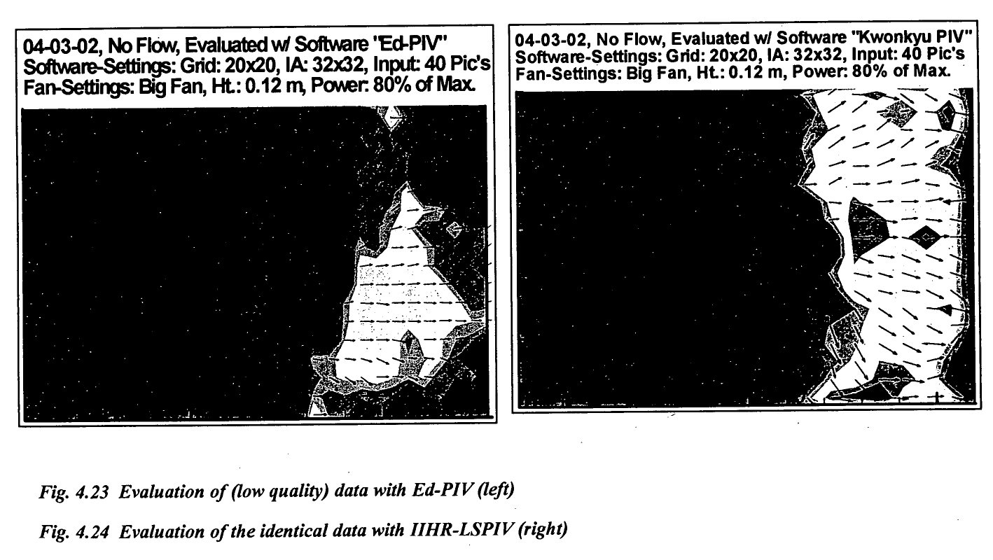

Apparently there are not many features¹⁴ visible in FIG. 4.1—except of a few wave fronts up- and downstream of the fan. Keeping in mind the rule of thumb, that if the human eye can detect some moving patterns easily the LSPIV evaluation will result in acceptable results too, the output in FIG. 4.2 is not surprising: It shows the actual flow inaccurately with an obvious lack of uniformity. Lots of spurious or missing vectors can be detected on both sides of the fan.
¹⁴ For instance reflections or typical patterns that could have been tracked by the software.

### Direct Illumination at Various Elevations

In the following several elevations of the halogen spots were tested and the best result was finally achieved with lights put to the (highest) elevation of 1.25 m on either side. The FIGS. 4.3 and 4.4 again show a frame and the output of this setting respectively.

This time FIG. 4.3 shows two interesting features: The above-mentioned wave fronts are now more clearly visible and form circles of various diameters around the fan. Additionally white reflections appear on the upstream side close to the fan. The higher the bulbs, the more reflections of this kind could be observed.

The evaluation of this setup (FIG. 4.4) shows a remarkable improvement of the vector field. Only in some downstream areas the correlation failed due to a lack of well-defined moving features. Here the software simply could not detect any or enough of such characteristic shapes around the fan. However, these shapes did exist and in the previous cases the illumination was just insufficient to make them visible to the camera.

### Vertical Illumination

Instead of using numerous halogen bulbs in a circular arrangement at high elevation around the fan, a single, very strong source of light centered above the camera and fan was chosen. The ceiling light of the Model Annex, a high pressure sodium spot, 7 m above the water surface, proved to be suitable for this purpose. The whole experimental setup was shifted beneath this light spot and the result of this new type of illumination looked very promising. The FIGS. 4.5 and 4.6 show the reflections and an evaluation for the changed type of illumination respectively.

In FIG. 4.5 the reflections on the water surface are very uniformly distributed and yield in a homogenous vector field (FIG. 4.6). Reflections can be seen in the flume walls too—prior to evaluation this area was masked off.

If the fan caused waves above a flow (and not above a still water surface), usually more reflections with a larger distance to the fan could be observed on the downstream side. It was realized, that for a still water surface useful information could be won on both sides up to a distance of about 0.70 m, while for a given flow this area was increased significantly on the downstream side (compare FIGS. 3.10 and 4.5).

### Effect of Refracted Light

For all early experiments only clear water was used to circulate in the flume. Thus, the bottom of the flume was visible for all recordings of shallow flows. This raised the question, if the images of wave fronts were recorded on the water surface or if they were actually just shadows of waves moving on the flume bottom instead.

The flume bottom—made of smooth concrete—has a comparatively bright surface. A light absorbing black board was placed on the bottom of the flume and recorded under normal experimental conditions. The result can be seen in the FIGS. 4.7 and 4.8. They show a comparison of the effect of bottom color.

As can be seen in FIG. 4.7, the wave fronts are barely visible above the board but can still be detected next to it. We believe, that the main part of the features recorded were only the shadows of wave crests on the flume bottom. However, to avoid erroneous influences and to simulate field conditions more real, all future experiments were carried out with dyed water. Even with a water depth of 5 cm the bottom of the flume was not visible any more.

FIG. 4.8 shows another picture, taken under vertical illumination. The purpose here was to show the independence of the reflections on the water surface from the bottom of the flume¹⁵.
¹⁵ See also a few of such reflections in FIG. 4.7 to the left of the fan.

### Indirect Illumination

During the preliminary tests some recordings with a completely different kind of illumination were taken. All above mentioned setups are direct, e.g. the light source points directly on the water surface. However, reflections on waves can also be caused by diffuse light, e.g. a reflective surface above the water. To test the behavior and the performance of such an illumination a white non-glossy board was placed above the upwards-pointing Halogen spots. The FIGS. 4.9 and 4.10 show the appearance of the resulting reflections and the outcome of an evaluation due to an indirect lighting above the right side of the fan.

Here only the two Halogen lights on the downstream side of the fan were used. The spots are fixed close to the water level and are pointing upwards to a white board in an elevation of about 1.40 m above the water level.

The type of reflections on the water surface shows some interesting features: While the reflections due to direct illumination appear more as single points or lines, the mirrored images appear more as small areas with softened edges. The upstream area of the fan was illuminated insufficiently, which becomes clearly visible in the Tecplot output (FIG. 4.10). While the homogeneous vector field on the downstream side a can be used for further calculations, the area to the left of the fan is lacking of quality or even existence of any data.

Nevertheless, to apply the SWIV technique successfully, the same kind of illumination and recording had to be done on the upstream side too and the best parts of each evaluation were superposed to form one complete set of data. The result of this evaluation did not differ from the outcome of a conventional setup—both kinds of illumination were possible.

### Illumination for Field Conditions

Testing some basic principles of the method under field conditions was done in the nearby Iowa River. Depending on the weather situation, one has to distinguish between direct and diffuse illumination. No artificial spots were used—lighting was done either by the sun or the cloudy sky respectively.

An example for direct illumination in outdoor conditions is a sunny day with a clear sky. FIG. 4.11 shows a view from a bridge on the surface of the Iowa River for such conditions.

The camera was aligned in a way, that sunbeams, which were hitting the river, became reflected directly into the camera lens. A breezy wind caused a homogenous fetch of waves on the surface, which appeared as moving reflections on the recording. It must be noted, that the evaluated vector field only accidentally shows the actual direction of the flow in the Iowa River because the wind was blowing from a favorable direction (FIG. 4.11, the white arrow shows the actual direction of flow).

Furthermore, the output must be considered as a qualitative result only, because here a distorted image was recorded and the object-image ratio had to be roughly estimated. However, from the uniform vector field it can be inferred, that this lighting condition is working well for our purpose.

We speak of indirect lighting, when only diffuse light penetrates clouds or obstacles and no central bright light source is found close the flow to be investigated. FIG. 4.13 contains a section of the surface of the Iowa River recorded on a cloudy day.

The recording was made from the left bank of the river. The gained images are very distorted (small viewing angle) and again the object-image ratio had to be estimated. A calm wind constantly caused some ripples on the surface. Reflections of two trees from the opposing bank appear as darker shadows on the image. They improve the phenomenon of reflections by providing an additional gradient of bright and dark features.

The Tecplot result is presented in FIG. 4.14. The vector field gives a qualitative insight about the wave celerities on this section of the Iowa River. The actual direction of flow is close to the main direction of the vector field but again only due to the complimentary direction of the wind. Obviously this kind of illumination enables an acquiring of acceptable results too.

### Illumination for LSPIV

The setup for traditional LSPIV, extensively tested and applied in a smaller water flume (width: 0.61 m) of the IIHR, was basically adapted to the 0.91 m flume used for the experiments. While all other light sources where shut off, two Halogen lights and one UV light on either side of the fan were brought into position (FIG. 3.13).

In opposite to the SWIV technique all kinds of reflections were tried to avoid because they could have caused erroneous vectors, which do not represent the true velocity of the floating beads.

4.2 Selection of the Wave Characteristics

The appropriate choice of size and strength of a fan and its careful integration into the experimental setup was a crucial step to achieve good quality recordings. Furthermore the distance of the fan from the water surface had significant influence on the outcome of an experiment (see Chapter 3.2.3).

### Features of the Small Fan

The FIGS. 4.1-4.10 show a plan view on the performance of the small fan used in the experiments. The waves caused by this fan show equal properties in all directions and the wave-reflections from the flume walls back into the flow are negligible. The small fan was always used at 100% of its maximum power. It induced wavelets with very short wavelengths and -heights (20−40 mm/3−4 mm).

### Features of the Big Fan

The strength of a bigger fan tested in the early stages of the experiments had to be regulated with a power controller. The FIGS. 4.15 to 4.18 show a picture and the corresponding Tecplot output of this fan—running at 70% and 100% of its maximum power respectively.

The illumination used for these tests were two halogen bulbs on either side of the fan at an elevation close to the water level (see FIG. 3.5). Much more suitable features were created on the water surface in FIG. 4.17 and more direct reflections (white spots) could be observed. This is mainly due to the fan strength. Running at full power, the big fan induced waves with lengths of up to approximately 100 mm and heights of about 15 mm. However, this type of fan also caused significant wave reflections at the flume walls. Here only visible in FIG. 4.17 as white reflections close to the flume wall, they could be observed for almost all experiments done at different rotational speeds of the fan. The phenomenon appeared upstream and downstream to the same extent and was easily detectable by the human eye: Waves reflected from both flume walls traveled back into the area of interest where they met and finally overlapped with waves traveling along the centerline. The vector field in FIG. 4.18 shows this effect: In all four corners of the picture there are vectors pointing back into the flow. Furthermore the velocity-contour lines in these areas are indicating velocities with too large magnitudes.

### Results

To avoid the negative effects of wave-reflections only the small fan was used in all following experiments. Its action can be described as “roughing up” the water surface with small waves. It has also the advantage of occupying less than one fifth of the flume width in opposite to the big fan (≈1/3)—every obstacle between the camera and the water surface causes a loss of data. The appropriate placement of this fan in the flume has been described extensively in Chapter 3.

4.3 Refinement of Image Processing Parameters

About half of the preliminary experiments were evaluated with the IIHR-LSPIV software. This software enabled to check for distortion of the recordings and was used to figure out the best settings to get reliable data. Later all calculations were done with the Ed-PIV software because it proved superior in terms of accuracy and demand of time.

### Choice of Size of Interrogation Area

The most important setting to be done in PIV software is the choice of the size of the interrogation area (IA). For several experiments identical data material was evaluated with different software settings and the results were compared in terms of precision, reliability and efficiency.

The FIGS. 4.19 and 4.20 show the Tecplot output of an evaluation of 100 pictures for settings that differ only in the chosen size of the IA. A smaller IA is more sensitive to effects like local wave reflections on the flume walls because the correlation is done for a smaller area only. This can be seen in the vector field and the velocity-contour lines on the upper and lower edge of FIG. 4.19. However, in terms of magnitude and direction of the vectors along the centerline both alternatives can be regarded as equal for the given conditions. Because the evaluation with a larger IA is always more time consuming—an IA of 32×32 takes less than half of the time than an IA of 64×64—the former size, 32×32 pixels, was chosen for the remainder of the experiments.

### Choice of Maximum Displacement

PIV software asks the user for an input of the largest displacement of a feature to be expected between two consecutive images. This value has to be determined in advance (Chapter 3.4.2). The effect of an unfavorable chosen value can be seen in the FIGS. 4.21 and 4.22.

Valuable data gets lost next to the fan if the chosen value is too big: For about two grid points of the centerline on every side of the fan no data will be evaluated (FIG. 4.22). For the example given, no statement about the celerity of the waves could be made over a distance of about 7 cm on either side.

For all experiments carried out with the small fan under vertical illumination, the maximum displacement was entered to be 10 pixels (even though the real displacement is smaller and according to Photoshop about 5-6 pixels). For the LSPIV experiments a smaller value was chosen: Tracking the patterns of the Styropor particles that were floating on the water surface with a velocity of less than 10 cm/s an assumed maximum displacement of 5 pixels between two subsequent pictures was entered in the software settings.

### Choice of the Type of Software

As already mentioned, was the PIV software changed during the tests. Ed-PIV (FIG. 4.23) surpassed the performance of IIHR-LSPIV (FIG. 4.24) in terms of data quality and expenditure of time.

Both of the evaluations shown were done with the same software settings and used the same (amount of) data as input. Ed-PIV used about one fourth of the time to come up with a more realistic output of the process around the fan. The vector field of the alternative software however, shows an output that can be described as “qualitative” information only. Some vectors along the centerline do not match in terms of direction and magnitude.

Ed-PIV was used for all further experiments. An evaluation of 300 pictures took about 15 minutes.

### SWIV—Method Implementation

This chapter comprises all steps that are enclosed in the SWIV technique. In the following statements the part of experimental procedure up to the step of data evaluation will be covered only very briefly (see chapters 3 and 4). Obtained results are investigated under different aspects: Types and achievable quality (accuracy) will be discussed; alternatives, limitations and problems are demonstrated and will conclude this chapter.

For the reason of clarity, only one set of data will be presented here and will provide all the information about the suitability of the technique. However, in field conditions it is strongly recommended to carry out several evaluations for a single measurement point.

5.1 Experimental Procedure

This table gives a brief overview about the procedure of one complete SWIV experiment.

TABLE 5.1
Overview about a complete SWIV experiment
under laboratory conditions

| Step | Description |
|---|---|
| 1 - Setup of fan | The fan was centered between the flume walls at a |
| and water depth | distance of 17 m from the head box (inlet) of the |
| | flume. By using a torpedo level the fan was placed |
| | horizontally above the water surface to release its |
| | kinematical (wind) energy uniformly to the |
| | underlying flow. |
| 2 - Setup of video | The camera was centered above the fan with its |
| camera | optical axis aligned perpendicular to the water |
| | surface. The aim was to record equally sized and |
| | undistorted areas of interest on both sides of the |
| | fan. |
| 3 - Zooming and | To achieve the best possible spatial resolution the |
| focusing of camera | camera was zoomed in until the whole image was |
| | covered by the flume-width. Then the camera was |
| | manually focused by using the grid positioned on |
| | the water surface. |
| 4 - Recording the | The grid was recorded for an instant of a second to |
| grid | obtain a single image of the grid. This image was |
| | later used to determine the actual object/image ratio |
| | for the given experimental setup. |
| 5 - Setup of | The illumination found most suitable for SWIV was |
| illumination I | a central light source directly above the area to be |
| | recorded. This enabled uniform reflections on top |
| | of the waves in all directions around the fan. |
| 6 - Turning on fan | Given a completely calm water surface the fan was |
| | turned on followed by a waiting time of about one |
| | minute (or until a stable pattern of reflections |
| | appeared on the tv-set). |
| 7 - Recording I | A sequence of about 15 s was recorded for the still |
| | water surface by operating the camera with a |
| | remote control. |
| 8 - Turning on | The pump was turned on and set to the required |
| pump | flow rate. A waiting time of about 10 minutes (or |
| | longer) was kept until the flow settled and appeared |
| | homogenous and uniform. |
| 9 - Recording II | A sequence of about 15 s was recorded for the |
| | moving water surface by operating the camera with |
| | a remote control. Then the fan was turned off. |
| 10 - Setup of | To verify results, for all flows a traditional LSPIV |
| illumination II | experiment, e.g. seeding the flow with beads, was |
| | carried out. Halogen spots and additional UV-spots |
| | attached to frames on the upstream- and |
| | downstream side of the fan were used for this |
| | purpose. |
| 11 - Seeding the | Given again a completely calm water surface the |
| flow | procedure of seeding could start at a distance of |
| | about 5 m on the upstream side of the fan. Beads |
| | were added manually or by use of a hopper. |
| 12 - Recording III | A sequence of about 15 s was recorded for the |
| | moving water surface homogeneously covered with |
| | beads by operating the camera with a remote |
| | control. |
| 13 - Reading of | A manometer enabled the reading of the pressure |
| pressure head | head provided by the pump. Thus the discharge |
| | known, another backup of the results was possible. |
| | Then the beads were removed on the downstream |
| | side and the pump was turned off. |
| 14 - | All experiments were accompanied by a |
| Documentation | documentation, containing information about |
| | setups, readings, incidents etc. |
| 15 - Preprocessing | Transfer of the data to a PC and preparing the |
| | images to make them suitable for an evaluation |
| | with PIV software was accomplished by special |
| | imaging software. |
| 16 - Evaluation | In-house-developed PIV-software enabled the |
| | evaluation of the data material. Post-processing |
| | (presentation) of the results concluded one single |
| | set of experiments. |

It is in the nature of field conditions (having the intention to measure flow velocities) that recordings of a still water surface are there not possible. However, to show the difference between two recordings that were taken for a non-moving and a moving water surface and to facilitate the explanation of the methods basic principle, an evaluation for a still water surface always accompanied the tests and thus was included here.

5.2 Determination of the Flow Velocity in an Open-Channel Flow

The two equations that were derived in Chapter 2.4. are quite simple in their structure, but when it comes to the actual magnitude for the two velocities ν_{Downstream} and ν_{Upstream}, a problem arises: There is no exact magnitude of the two velocities that describes the properties of the flow properly.

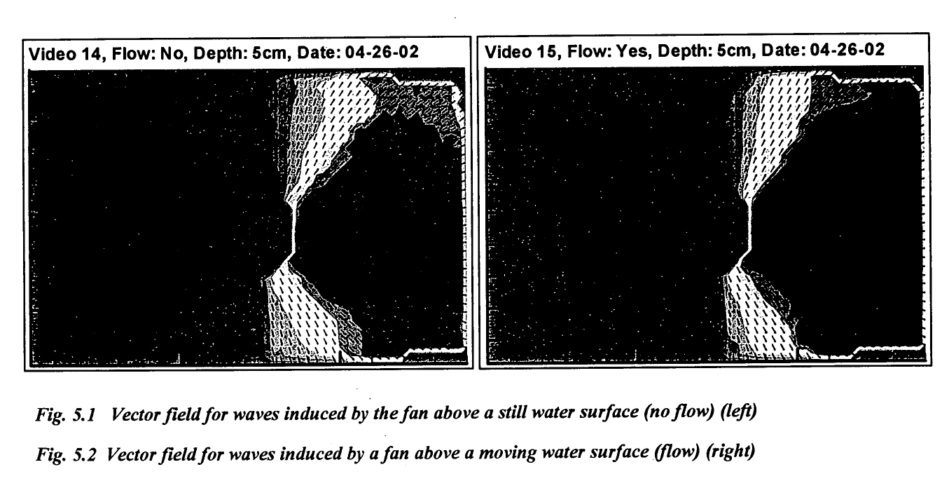

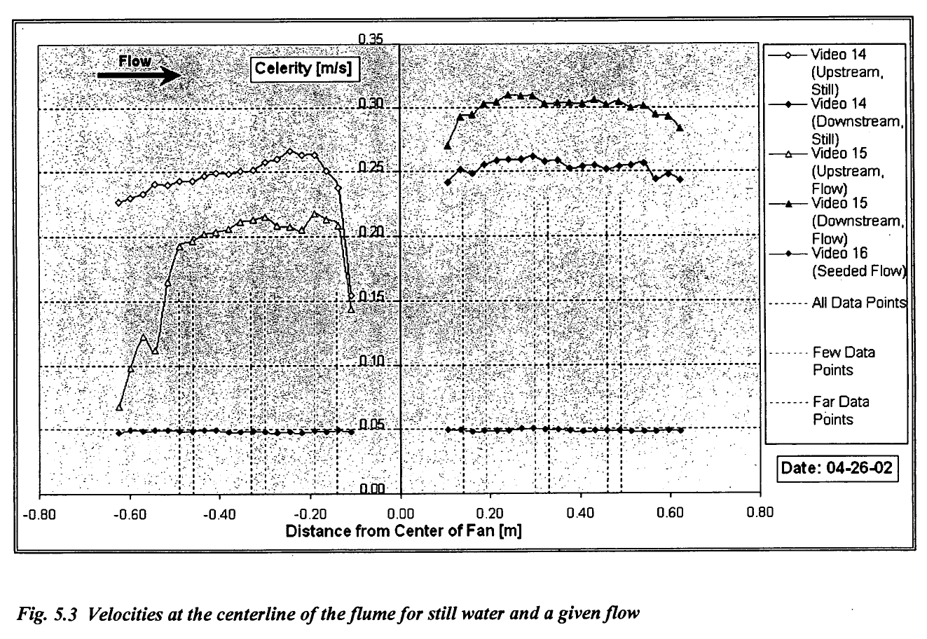

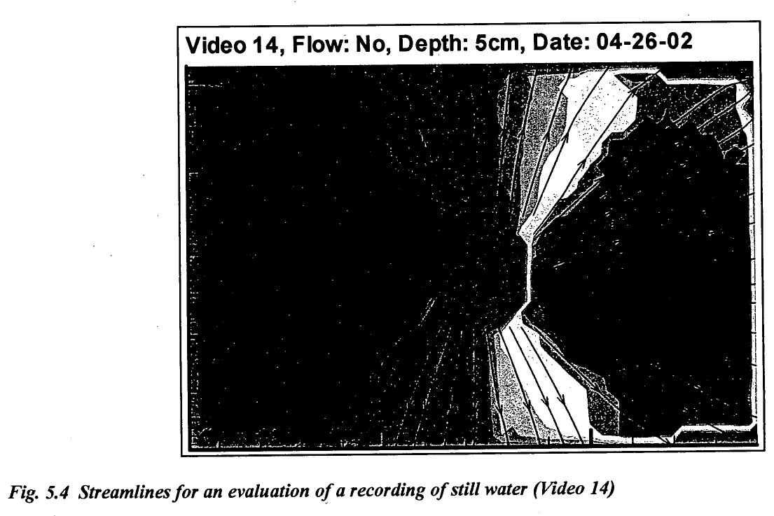

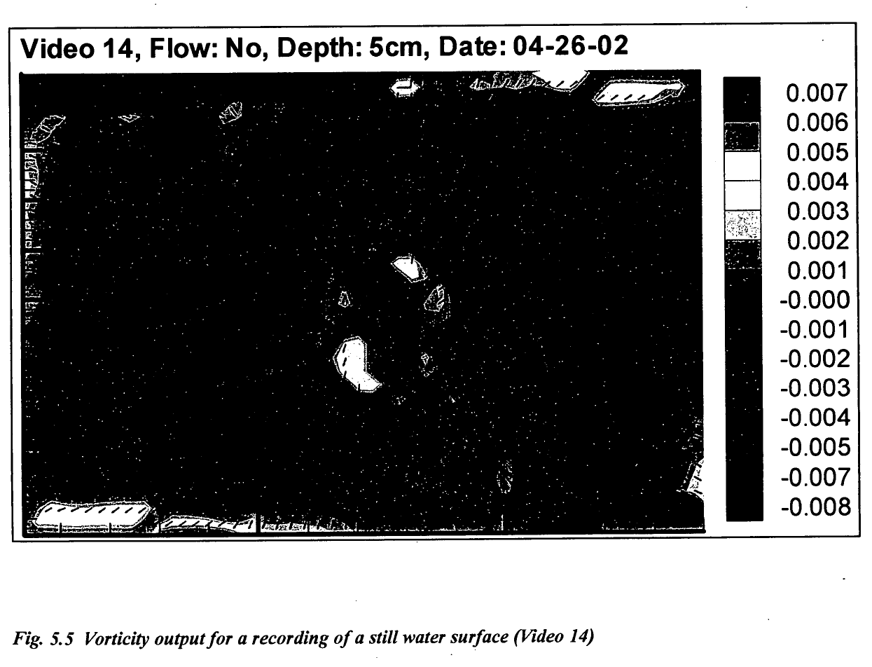

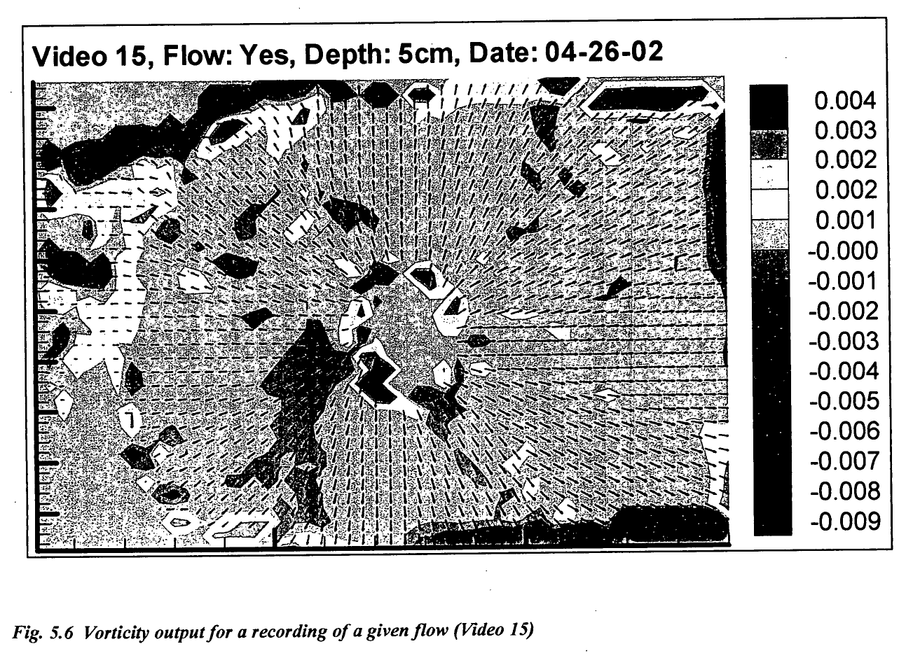

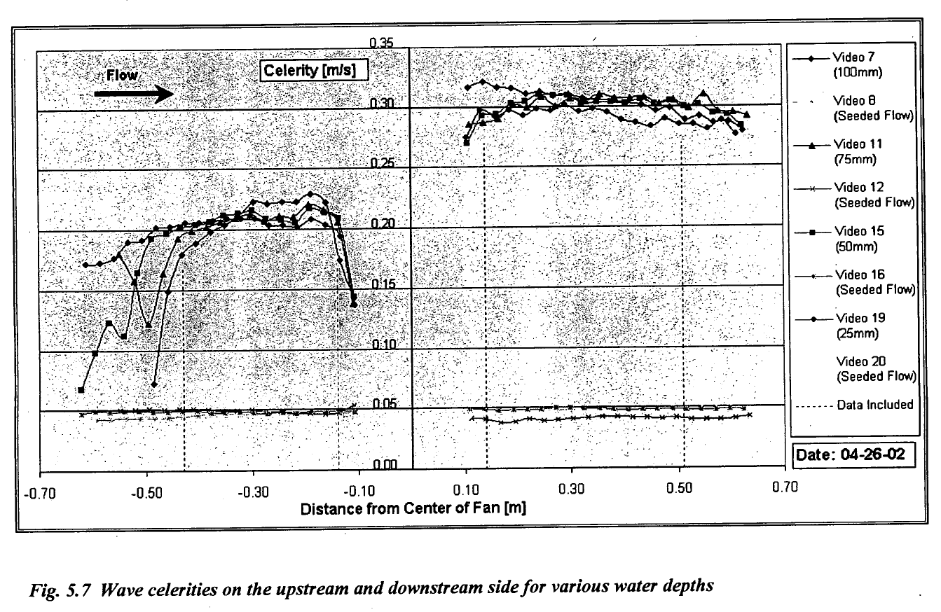

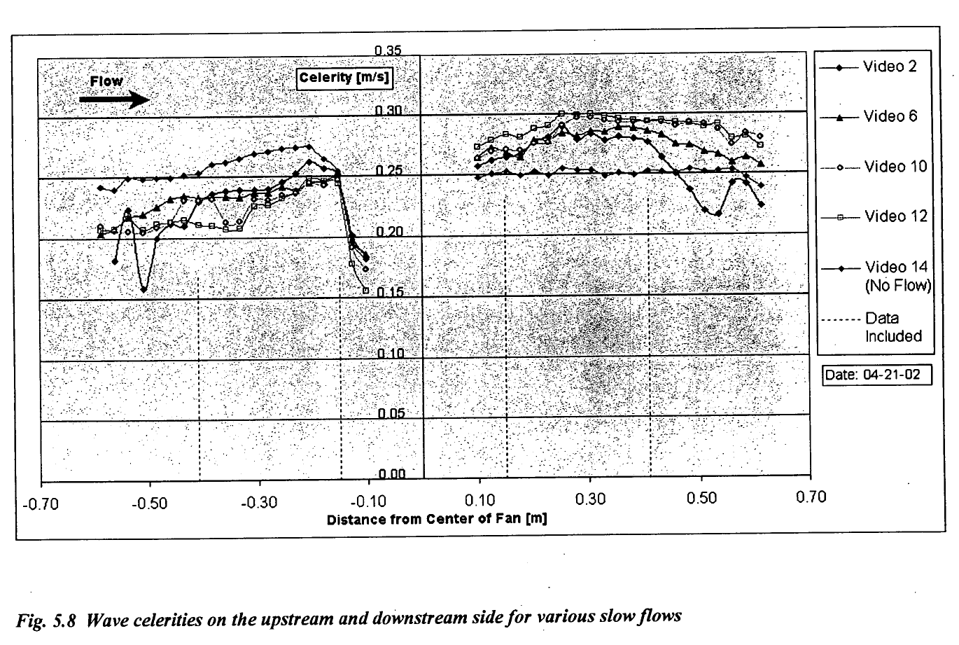

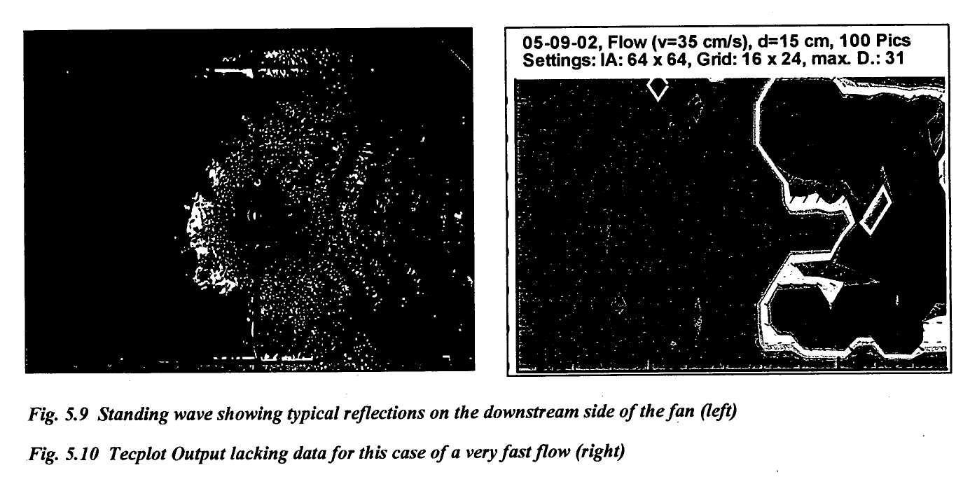

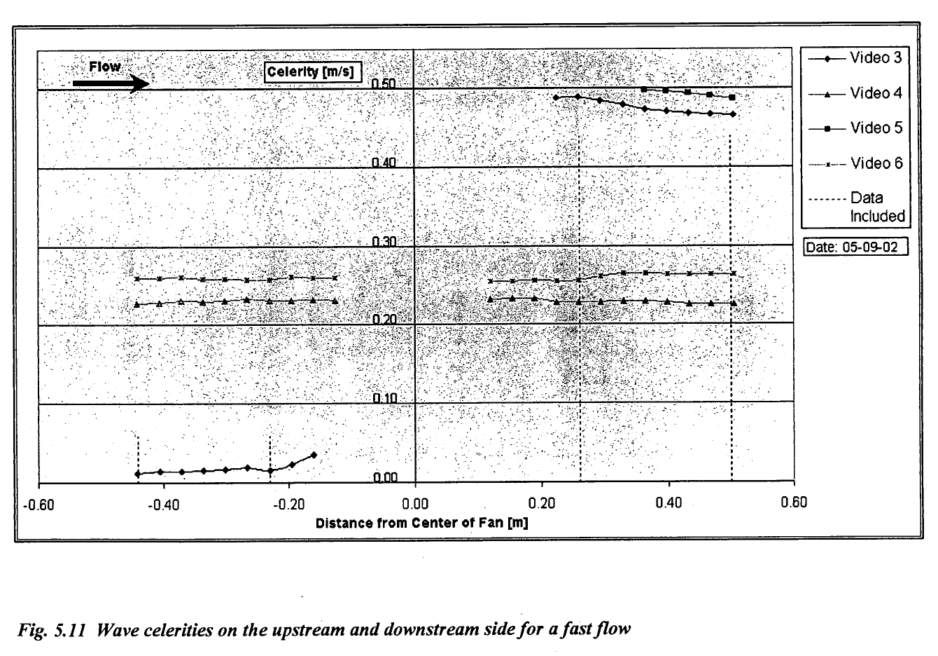

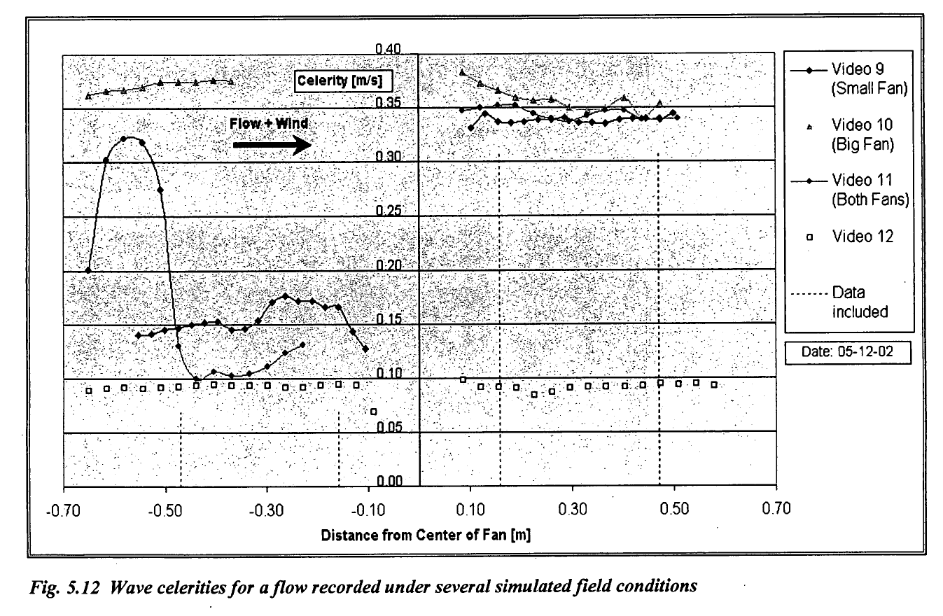

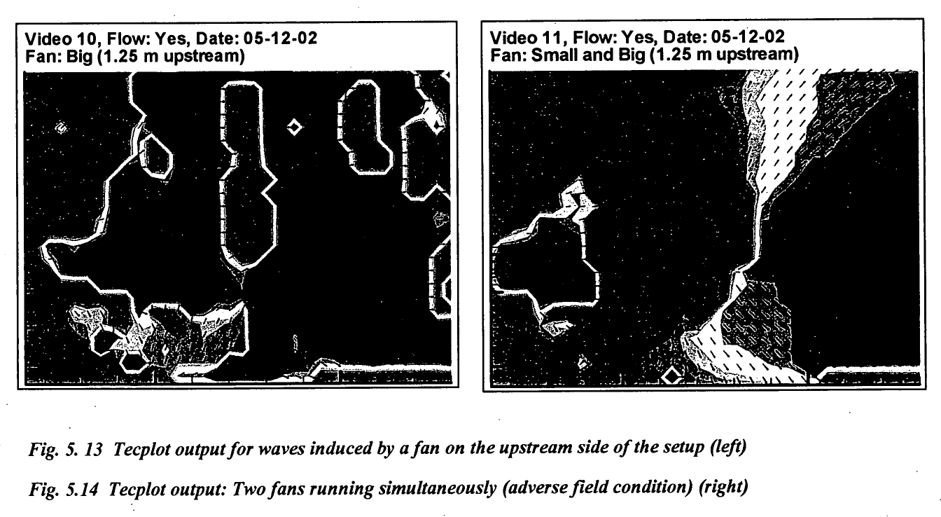

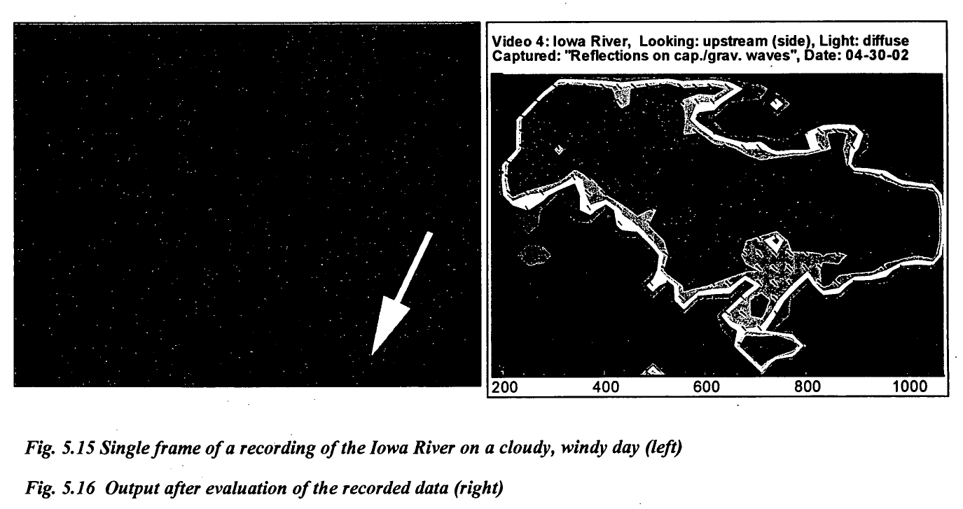

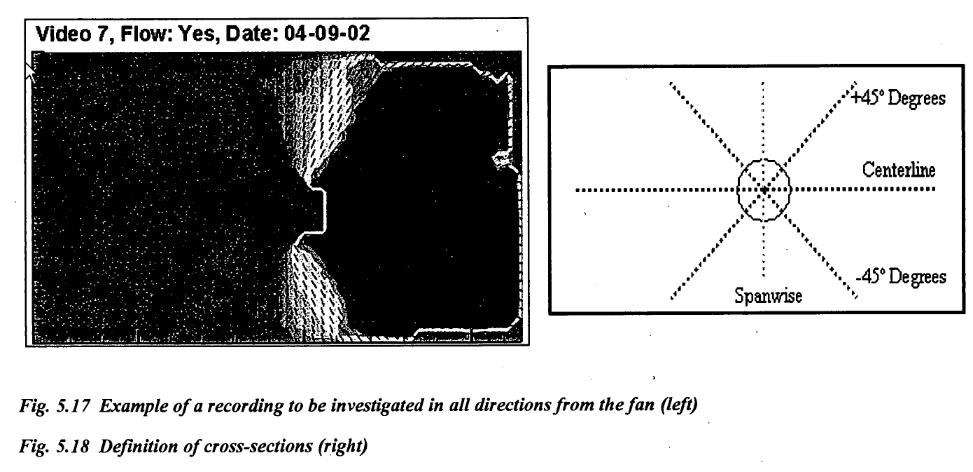

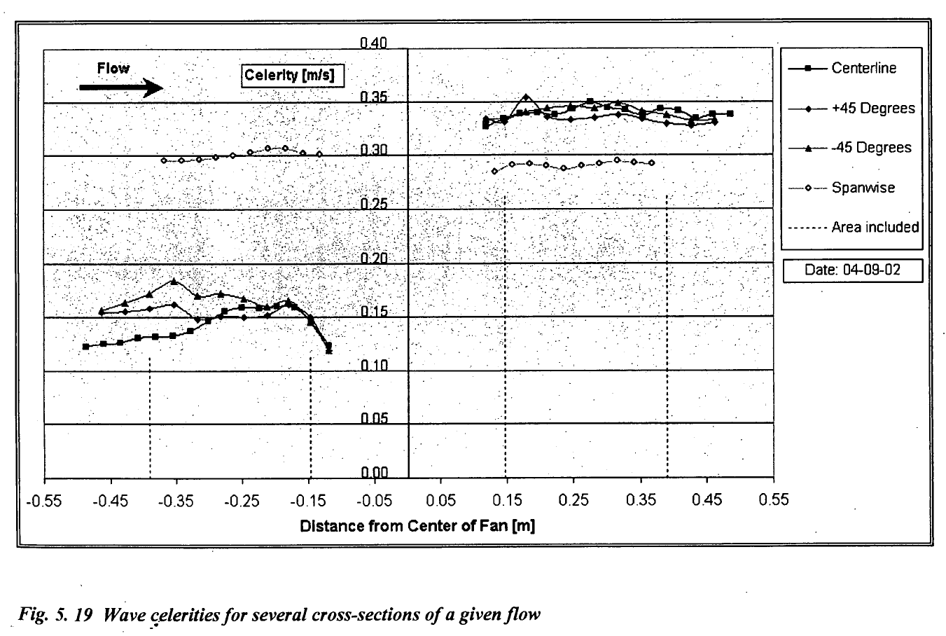

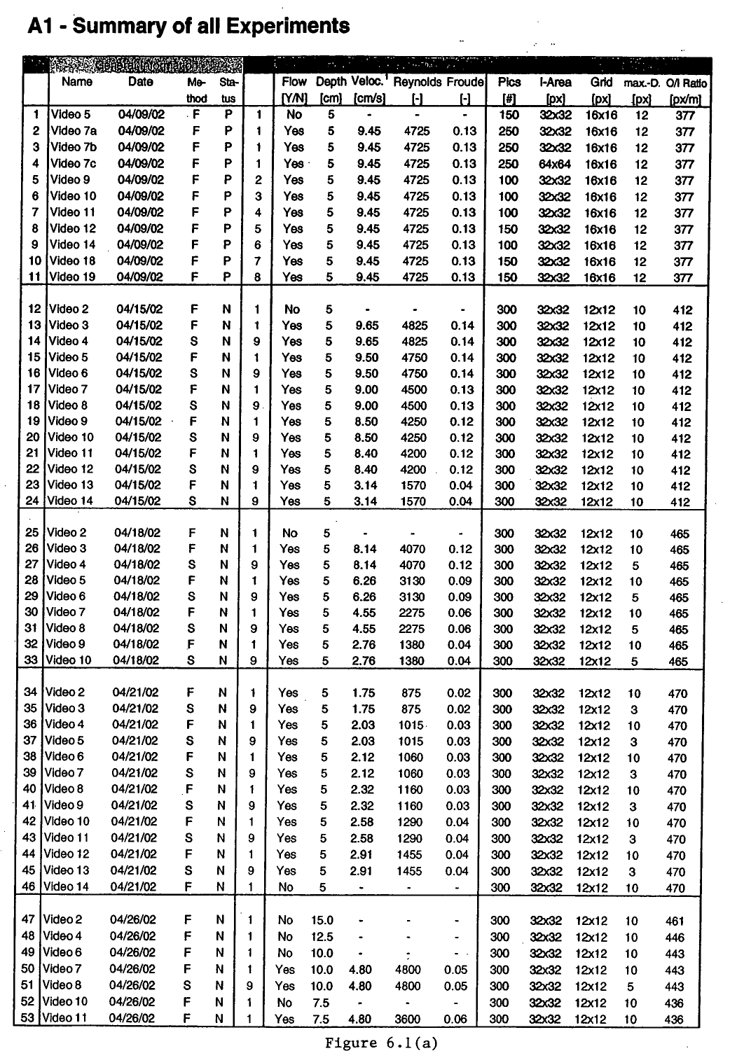

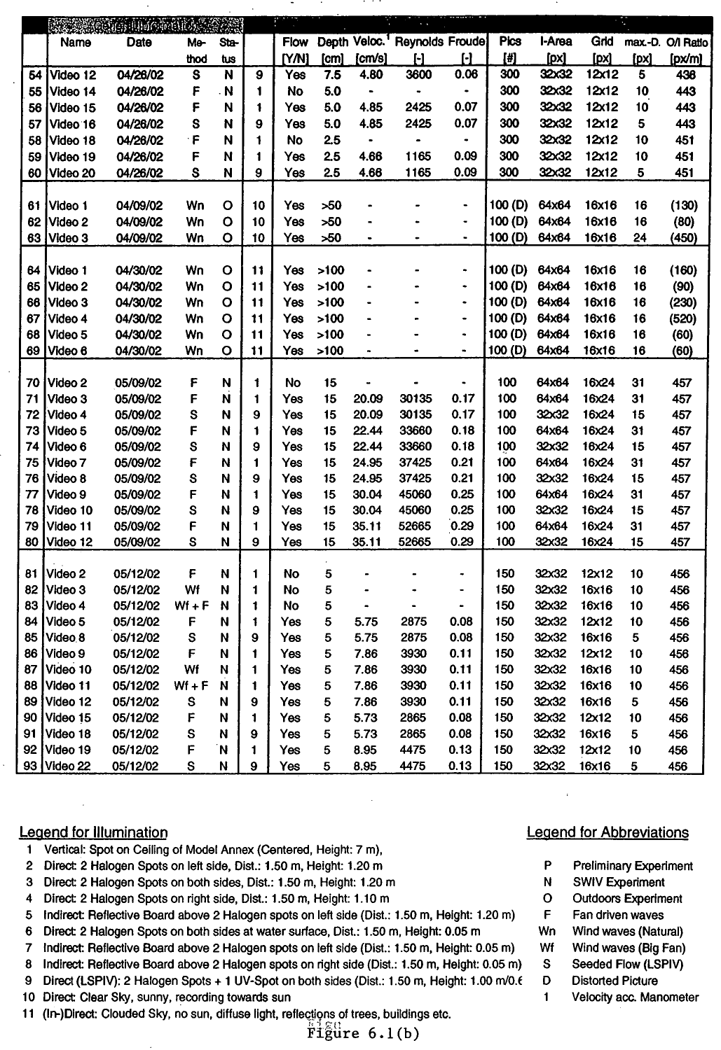

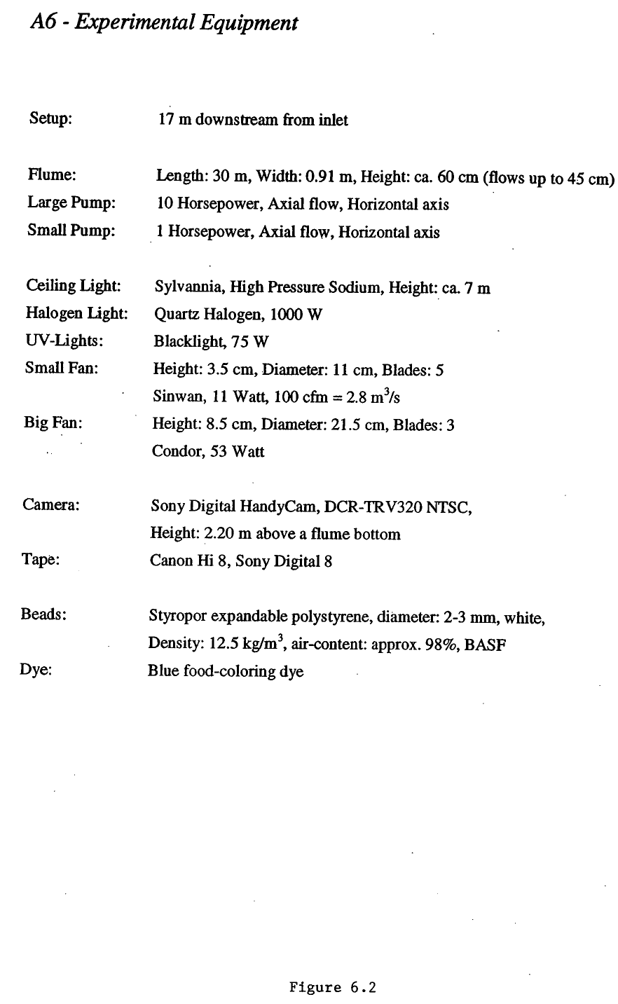

With the help of an example it will be shown here, how this problem was handled and which alternatives for a solution were found. The FIGS. 5.1 and 5.2 show the velocity outputs of an experiment carried out on April 26^{th}.

The output of FIG. 5.1 stands for a typical result after an evaluation of a recording of a still water surface. For matching distances from the center the magnitude and direction of the vectors are approximately identical on both sides of the fan. Thus, the velocity-contour lines are equally distributed too.

From a qualitative point of view, FIG. 5.2 looks similar to the previous figure. The vector field still looks analogous in terms of direction of the vectors around the fan. However, vectors on the downstream side appear much larger in magnitude and the light blue color of the velocity-contour lines on the upstream side signalizes vectors of a smaller magnitude. The green area in the center of both figures represents the position of the fan, which was masked during the evaluation to avoid erroneous vectors in this region.

Taking the data of interest (e.g. vectors along the centerline) out of the output file produced by the PIV software (FIG. 3.17) and pasting it into a spreadsheet yields in a diagram shown in FIG. 5.2. It shows the evaluated velocities along the centerline of the flume for the two recordings up to a distance of about 60 cm from the center of the fan.

The wave celerity induced by the fan over the still water surface is shown in a blue color (Video 14). It reaches a magnitude of about 26 cm/s on both sides of the fan. Due to equal energy dissipation on the downstream and upstream side the determined celerities gradually decrease with increasing distance from the fan until the edge of the recording area is reached.

The other recording with the same experimental setup but for a uniform flow was done right afterwards. The result of the evaluation is depicted in a pink colored graph (Video 15). Now the situation on the upstream side has changed: A velocity as a combination of the fan celerity decreased by the actual flow velocity is measured. On the downstream side the vectors of both velocities are pointing in the same direction and add up to velocities of more than 30 cm/s.

The appearance of the chart changed too: While the waves on the downstream side do barely experience any dissipation and remain almost constant for a long distance, the waves (and thus the reflections) on the upstream side are dissipated much quicker until they disappear almost completely at a distance of about 60 cm from the center of the fan.

Having the output of the chart in mind it is easy to recognize the problem one is facing when the two equations want to be applied. Instead of one velocity on each side of the fan a number of celerities (data points) close to the targeted velocity at different locations on either side are known and can be used for the calculation. By averaging this data points over a certain area, the targeted velocity can be determined and the equations have to be changed to:

$$\begin{matrix}{v}_{FLOW} = ( {v}_{Downstream}^{Average} + {v}_{Upstream}^{Average} ) \times 0.5 & [ 16 ] \\ {v}_{CELERITY} = ( {v}_{Downstream}^{Average} - {v}_{Upstream}^{Average} ) \times 0.5 & [ 17 ]\end{matrix}$$

To show the influence of a correct choice of the data points to be averaged, the case shown in FIG. 5.3 will serve as an example of how to apply the equations most advantageous. Concrete results for this case have been evaluated in section 5.5.1 (Opt. Measurement Range).

5.3 Determination of Wave Celerity

As already shown in Chapter 2 and in the previous section SWIV is capable of measuring the celerity of waves (Equation [17]). This is a useful feature and numerous applications are conceivable for this “side effect”.

To check for the importance of the surface tension and if the derived equations do work at all the results of the (theoretical) equations from Table 2.1 and the outcome of an SWIV experiment were compared. Taking Video 14 from section 5.2 as the reference for a measurement over a still water surface wave celerities of about 25.6 cm/s (see section 5.5.1) could be evaluated.

The equations [6] and [7] were taken and for a still water surface the celerity of the waves was calculated respectively (Video 14). Equation [6] is the general form for the wave celerity and takes only gravitational waves into account. Given a water depth of 0.05 m and a wavelength of about 0.03 m (k=209 1/m) equation [6] reads to:

$$c = \sqrt{( \frac{g}{k} ) tanh ( k \cdot h )} = \sqrt{( \frac{9.81 m \text{/} {s}^{2}}{209} ) tanh ( 209 \cdot 0.05 m )} = 21.6 \frac{cm}{s}$$

On a still water surface the fan usually induced waves with a celerity of approx.¹⁶ 25.3 cm/s (for Video 14: 25.6 cm/s). Obviously the celerity determined with equation [6] is too low.
¹⁶ Averaged value for all experiments evaluated for a still water surface.

Taking the surface tension into account by adding a second term to the formula yields in equation [7]. Additionally given a wave amplitude of approx. 3 mm, the surface tension of water (T_{W}=0.074 N/m) and the water density of 1000 kg/m³ equation [7] becomes:

$$c = \sqrt{{( 21.6 )}^{2} + \frac{k \cdot {T}_{W}}{ρ} {( 1 + \frac{{π}^{2} \cdot {a}^{2}}{4 \cdot {λ}^{2}} )}^{\frac{1}{2}}} = \sqrt{{( 21.6 )}^{2} + \frac{209 \cdot 0.074}{1000} {( 1 + \frac{{π}^{2} \cdot {0.003}^{2}}{4 \cdot {0.03}^{2}} )}^{\frac{1}{2}}} = 24.9 \frac{cm}{s}$$

This result is much closer to the actual celerity determined by the SWIV technique (25.6 cm/s). It can be concluded that the surface tension is not negligible and the equations in Table 2.1 do work for our experiments too. Wave celerities can be evaluated with SWIV to a satisfying degree.

5.4 Additional Results

### Flow Streamlines

Next to the main goal of determining the flow velocity on the free surface of an aquifer, more results and insights about the flow could be achieved. For field conditions and a very slow flow given, it might be possible that even the direction of the flow is not known and thus has to be determined first. The Tecplot feature ‘Streamlines’ enabled to check for the general direction of vectors in all directions around the fan and proved the method as feasible even for such a situation. FIG. 5.4 shows the streamlines for the example of still water (Video 14).

The streamlines show an equal distribution in all directions (360°) around the fan. As a consequence it is not required to know the flow direction—by checking in all directions the PIV software automatically will come up with the direction of the current. In section 5.5.6 (Detection of Flow Direction), a detailed examination of the behavior of the technique for different flow directions is given.

### Free Surface Vorticity

Tecplots feature ‘Vorticity’ was used to check for vortices (and other irregularities) on the water surface. The FIGS. 5.5 and 5.6 show the vorticity output for the case of still water (Video 14) and a given flow (Video 15) respectively.

As can be seen in the figures, the effect of vorticity can be neglected for both cases. While there are almost no vortices in the vicinity of the fan when it induces waves on a non-moving water surface, some irregularities can be noticed in the output for Video 15. Only next to the fan itself and along the flume wall some erroneous vectors or falsifying reflections cause some minor vortices.

5.4 Sensitivity Analysis

It has been shown, that SWIV obviously works for its intended purpose—the determination of wave celerities and the velocities at the surface for a given flow. However, several properties but also limitations or shortcomings have not been mentioned yet. Obviously some influencing factors must be considered to be able to classify the method more precisely in terms of the field of application.

The influence of the chosen measurement range, the water depth and the range of flow velocities that can be evaluated were investigated here. Additional cross-sections (besides the centerline) have been examined. An analysis about the influence of any other wave-inducing energy source, e.g. waves due to an additional wind flow, will conclude this chapter.

### Optimum Measurement Range

In FIG. 5.3 the edges of three investigated areas labeled as ‘All data points’, ‘Few data points’ and ‘Far data points’ are marked with dashed lines.

All data points' contains all the reasonable data that is located at the centerline of the flume at a distance between 14 cm and 49 cm on both sides of the fan. All points of this area were averaged on every side before the equations were applied. The calculation yielded in a velocity of 4.79 cm/s for the flow. A comparison of this value to the result of the LSPWV measurement, e.g. a recording of a seeded flow, shows a good agreement. The result of this experiment is shown in FIG. 5.3 as a green line (Video 16); the averaged velocity of the beads was determined to 4.86 cm/s. Furthermore—a second way to check for the accuracy of the method—the manometer reading (discharge through the orifice) could be converted into a flow velocity. For this case a velocity of 4.85 cm/s was determined. The second equation yields in an average wave celerity induced by the fan. Its value is 25.55 cm/s for this case.

The data set labeled ‘Few data points’ contains a smaller number of data points, e.g. the points located in an area between 19 cm and 30 cm from the fan. Only the velocities that yield in a higher accuracy were included here. Here the velocities on the downstream side were slightly lower than average and slightly higher on the opposite side. However, this procedure became only possible because the targeted speed, the velocity of the beads as a reference (4.86 cm/s), was known. A calculation yields in a magnitude of 4.80 cm/s for the flow. The wave celerity due to the fan for this data range could be determined to 25.91 cm/s.

TABLE 5.2
Overview about the evaluations for the example of FIG. 5.3

| | Area | | | | | |
|---|---|---|---|---|---|---|
| | | | Few data | | Far data | |
| | All data points | | points | | points | |
| Distance from | 14 | cm- | 19 | cm- | 33 | cm- |
| Fan | 49 | cm | 30 | cm | 46 | cm |
| Ave. Velocity | −20.75 | cm/s | −21.11 | cm/s | −20.58 | cm/s |
| Upstream | | | | | | |
| Ave. Velocity | 30.34 | cm/s | 30.70 | cm/s | 30.34 | cm/s |
| Downstream | | | | | | |
| Celerity of Waves | 25.55 | cm/s | 25.91 | cm/s | 25.46 | cm/s |
| (Fan) | | | | | | |
| Velocity of Flow | 4.79 | cm/s | 4.80 | cm/s | 4.88 | cm/s |
| (SWIV) | | | | | | |

| | |
|---|---|
| Vel. of Flow | 4.86 cm/s |
| (LSPIV) | |
| Vel. of Flow | 4.85 cm/s |
| (Manometer) | |

Finally a third data range, called ‘Far data points’ was investigated. Only the vectors located in an area between 33 cm and 46 cm from the fan were taken into account. Even though the single celerities on the upstream side are constantly decreasing a very accurate flow velocity of 4.88 cm/s and a fan velocity of 25.46 cm/s could be calculated. But again, in field conditions no reference will be given as an orientation to choose the “correct” or most appropriate area. For outdoor conditions such a step cannot be justified.

The two equations [16] and [17] can also be applied to the case of a recording of a still water surface. Then equation [16] has to yield in (near) zero velocity while equation [17] computes—as before—the fan-induced wave celerity. For the example given (Video 14) and by using the area ‘All data points’ a “flow-“velocity of 0.16 cm/s and wave celerity of 25.42 cm/s could be calculated.

Altogether more than 85 indoor experiments have been carried out and were evaluated according to the pattern described above. The exemplar shown here represents an example with high quality. There also have been other recordings where none of the methods worked and vice versa. Only some general rules could be found about how to handle the output (raw data) of the PIV software.
The assessment of the data, e.g. which data to be included, is subjective and can be different for each case
On the downstream side more data points can be used because the celerities stay more constantly (the effect of dissipation is smaller)
Data points close to the fan should be skipped (see FIG. 5.3) because PIV software can produce erroneous results for areas close to edges (here: masked area of the fan)
To choose special areas for the data points to be included cannot be justified; all data points that appear reasonable should be included
Extreme values among reasonable data should be skipped as long as a general tendency can still be seen
There is no general rule “Include all data within a radius of . . . “—recordings may differ significantly (especially when illumination changes)

### Influence of Water Depth

More than two thirds of all experiments were carried out at a constant water depth of 5 cm. Nearly all of these examinations yielded in reasonable results and proved to be repeatable. Nevertheless the influence of water depth has been investigated too.

Having the classification of waves (shallow/intermediate/deep water waves) in mind, a set of experiments with 4 different water levels—2.5 cm to 10 cm—was done. Shallow water waves¹⁷ show an interaction with the bottom of the aquifer. Thus, they could be negatively influenced, e.g. travel at a slower celerity, and the SWIV method would yield in an erroneous result. FIG. 5.7 shows the evaluated velocities along the centerline of the flume for this set of experiments respectively.
¹⁷ Definition: Ratio of water depth to wavelength exceeds the value of 0.5. See also Chapter 2.3.

Although the flow had to be set up completely new for every case¹⁸ and the actual velocities of the flow might have differed slightly, the particular graphs correspond fairly well. Furthermore included were the LSPIV results for every water depth: The graphs Video 8, 12, 16 and 20 match as well and show a constant behavior over the entire recorded area.
¹⁸ Due to changing water depths the flow rate of the pump had to be changed too to achieve a targeted velocity.

It can be concluded, that the new method is independent from varying water depths. However, for the case of a recording in very shallow water (2.5 cm, Appendix) the evaluated celerities were lower in magnitude and thus the waves were probably interacting with the flume bottom. If induced waves are being influenced by the water depth or not, depends to a high degree from the strength of the fan. The small fan used for the experiments here enabled undisturbed recordings for any water depth higher than 5 cm. Table 5.3 shows all results.

TABLE 5.3
Overview about the evaluations for recordings of different water levels

| | Water Depth | | | | | | | |
|---|---|---|---|---|---|---|---|---|
| | 10 cm | | 7.5 cm | | 5 cm | | 2.5 cm | |
| Data used in range | Upstream: 16-35 cm, Downstream: 14-37 cm | | | | | | | |
| (from-to) | | | | | | | | |
| Ave. Velocity | −21.95 | cm/s | −21.18 | cm/s | −21.17 | cm/s | −20.56 | cm/s |
| Upstream | | | | | | | | |
| Ave. Velocity | 31.12 | cm/s | 30.11 | cm/s | 30.33 | cm/s | 29.66 | cm/s |
| Downstream | | | | | | | | |
| Celerity of Waves | 26.54 | cm/s | 25.64 | cm/s | 25.75 | cm/s | 25.11 | cm/s |
| (Fan) | | | | | | | | |
| Velocity of Flow | 4.58 | cm/s | 4.47 | cm/s | 4.58 | cm/s | 4.55 | cm/s |
| (SWIV) | | | | | | | | |
| Vel. of Flow | 4.69 | cm/s | 4.51 | cm/s | 4.86 | cm/s | 4.36 | cm/s |
| (LSPIV) | | | | | | | | |
| Vel. of Flow | 4.80 | cm/s | 4.80 | cm/s | 4.85 | cm/s | 4.66 | cm/s |
| (Manometer) | | | | | | | | |

The data range that includes the reasonable information about the flow is marked dashed-blue in FIG. 5.7. Its size is different on both sides. The two velocities determined by the SWIV technique and LSPIV match very well. The maximum difference between the two values has a magnitude of smaller than 0.20 cm/s.

### Near-Zero Flow Velocities

One main target of SWIV was to develop a measurement tool for aquifers that flow with very slow velocities. Many conventional tools have shortcomings when it comes to a determination of the characteristics of such a flow. Marshes etc. would be a challenging field for the non-intrusive technique investigated here.

A set of experiments with very slow flows carried by the flume was done to check for this kind of limitation. It was tried to find out, if such small velocities are still strong enough to 5 change the wave reflection pattern on both sides of the fan, so the PIV software could detect wave reflections that are typical for each velocity. FIG. 5.8 shows the evaluated velocities along the centerline of the flume for this set of experiments.

Flows at four different velocities with magnitudes between 1.5 to 3.5 cm/s were set up in the flume, recorded and evaluated. The summary of the results is shown in Table 5.4.

TABLE 5.4
Overview about the evaluations for recordings of flows with very low velocities

| | Video | | | | | | | |
|---|---|---|---|---|---|---|---|---|
| | 2 | | 6 | | 10 | | 12 | |
| Data used in range | Upstream and Downstream: 15-41 cm | | | | | | | |
| (from-to) | | | | | | | | |
| Ave. Velocity | −24.45 | cm/s | −23.85 | cm/s | −23.21 | cm/s | −22.69 | cm/s |
| Upstream | | | | | | | | |
| Ave. Velocity | 27.76 | cm/s | 28.06 | cm/s | 28.62 | cm/s | 29.29 | cm/s |
| Downstream | | | | | | | | |
| Celerity of Waves | 26.11 | cm/s | 25.96 | cm/s | 25.91 | cm/s | 25.99 | cm/s |
| (Fan) | | | | | | | | |
| Velocity of Flow | 1.66 | cm/s | 2.10 | cm/s | 2.70 | cm/s | 3.30 | cm/s |
| (SWIV) | | | | | | | | |
| Vel. of Flow | — | | 1.92 | cm/s | 2.37 | cm/s | 2.61 | cm/s |
| (LSPIV) | | | | | | | | |
| Vel. of Flow | 1.75 | cm/s | 2.12 | cm/s | 2.58 | cm/s | 2.91 | cm/s |
| (Manometer) | | | | | | | | |

Due to the slow flow motion the graphs on both sides of the fan appear similar in magnitude. Nevertheless, compared to the case of the evaluated recording of the still water surface (Video 14) the differences are apparent and, both on the upstream and downstream side, the reverse order of the charts signals the methods existing sensitivity for the given case. For the slowest velocity (Video 2) a higher fluctuation of the chart could be observed. This can be explained by the circumstance, that for such a delicate situation even the smallest irregularities can cause large errors. The chosen data range is equal on both sides of the fan and the matching of the four independent determined velocities acceptable. Differences of up to 0.70 cm/s seem to tolerable but due to the small magnitude of the overall velocity this yields in a maximum relative error of about 20% (usually less than 10%).

Nonetheless, with the equipment used for the experiments the method also works for this special condition. Problems could occur if the used fan would be too powerful and would induce too large wave celerities (lack of sensitivity).

### Fast Flow Velocities

Even though SWIV is not intended for an application that involves high velocities it was investigated how the method performs for such a situation. Usually recordings of flows with velocities between 2 cm/s and 10 cm/s were analyzed. To test the behavior for a fast current, velocities of 20 cm/s and higher were set up in the flume prior the step of recording.

The velocity limit until the method works is closely related to the fans strength. If the velocity of the flow is higher than the induced celerity no typical wave reflections can be recorded on the upstream side of the fan.

The small fan used in the experiments generated waves with an average celerity of about 25 cm/s. For any velocity higher in magnitude no evaluation can be possible. Measurements showed, that already for flows at about 23 cm/s no result could be obtained.

On the downstream side another phenomenon could be noticed: For too fast flows a standing wave appeared right behind the fan and showed significant reflections. However, because they did not move the PIV-correlation failed on the downstream side too. The FIGS. 5.9 and 5.10 show one frame and the Tecplot output for such a case.

The example shown in the two figures is the result of flow with a velocity of about 35 cm/s. The standing wave, visible in FIG. 5.9, results in a lack of data at this area (green patch in FIG. 5.10). Even with this data given, no flow velocity could have been determined because the upstream side lacks any reasonable data (no vectors are visible here). Only for one case, a flow of about 20 cm/s, its actual magnitude could be determined (FIG. 5.11).

The example shown here (Video 3), still allows an application of SWIV. On the upstream side celerities with a very low magnitude (<2 cm/s) could be determined, while the celerities on the opposing side exceed values of 45 cm/s. The data range chosen along the centerline on the left side of the fan is between 23 and 44 cm and between 26 and 50 cm on the downstream side. By applying the velocity equation a value of 22.94 cm/s could be determined for the flow. Video 4 shows the output of the evaluation of a LSPIV experiment for the same, but now seeded, flow. The averaged velocity value over the whole recording area was found out to be 22.99 cm/s. These two values match very well; nevertheless, with about 23 cm/s the limit was reached for this type of fan.

The Videos 5 and 6 were included to present an example where this maximum value has been exceeded: For a flow with a velocity of about 26 cm/s (according to LSPIV, Video 6) no celerities could be detected on the upstream side and only a few data points could be obtained on the right side of the fan (Video 5). The magnitude of the flow and a partially developed standing wave behind the fan made the determination of the characteristics of this flow impossible. On the other hand the method of LSPIV still works for such cases.

### Influence of Wind

The SWIV technique relies on the effects of a well-defined wind-water interaction. As long as the fans axis is vertically directed to the water surface and all other influencing factors are controlled or known, reliable results are likely to be achieved. However, the optimized experimental conditions in a water flume cannot always be expected for regular field conditions. A flow that is already approaching with a wavy appearance due to some turbulences or a wind fetch that is creating additional waves makes the outcome of the results more vague or sometimes even impossible. Some outdoor recordings and the results of controlled experiments in the water flume have been assessed and will be discussed here.

### Laboratory Experiment

To simulate a wind flow moving parallel to the water surface and creating waves in the recording area the big fan was additionally setup in the water flume. While the whole experimental arrangement was not changed this fan was put vertically into place about 1.25 m upstream from the small fan with its center 15 cm above the water surface.

To be able to assess its impact on the quality of the results, one complete set of experiments consisted of 4 recordings: After the usual recording with the small fan the waves induced by the big fan were recorded separately. In the following a real field condition was simulated by turning on both fans simultaneously. The set of recordings was usually concluded with a LSPIV test. FIG. 5.12 shows the outcome of the experiment.

Video 9 shows the result of a normal recording under optimum conditions. With a data range from 16 cm to 47 cm on both sides a velocity of 8.85 cm/s could be determined for this flow. This outcome is supported by the result of the LSPIV experiment (Video 12), which yields in an average velocity of 9.19 cm/s. The big fan induced waves in the recording area with an average celerity of 36.45 cm/s (Video 10). The Output for this case is shown in FIG. 5.13.

Recording the water surface while both fans were working simulated the actual field condition. The result can be seen in FIG. 5.13 (Video 10) and FIG. 5.14 (Video 11). While the upstream side is deeply affected under the influence of an additional wind source, the magnitude of vectors on the downstream side is very similar to the result of Video 9.

An interesting phenomenon could be observed on the upstream side of the fan: While the celerity of waves induced by the small fan is high enough to make them travel away from this source of energy against the flow, from a distance of about 50 cm waves could be observed that traveled towards the fan. At this point the celerities balanced in magnitude and any wave reflections further upstream had their origin in the action of the horizontal fan (marked red for Video 11).

Nevertheless, an evaluation with the remaining and more or less reasonable data yielded in a velocity of 11.71 cm/s for this flow. A relative error of more than 20% allowed only one conclusion: Any additional wind source in the vicinity of the recording area has a negative influence. While the conditions in the flume could be considered as steady, e.g. the wind source had a constant influence from just one direction, wind under field conditions can vary in strength and direction in a couple of seconds.

A flow that enters the recording area with a rough or even wavy surface will consequently result in falsifications of the PIV evaluation. Further investigations should be carried out to find the limit to which the adverse influences are still acceptable. Otherwise only mirror-like water surfaces can be evaluated by the SWIV technique to a satisfying accuracy.

### Field Experiment

Evaluated images that were recorded at the Iowa River (Iowa City) support this conclusion. Performed under the present natural illumination (cloudy, sunny) the effect of wind driven waves was used to record reflections on the water surface. The FIG. 5.15 shows an example, recorded on a windy day under a cloudy sky, FIG. 5.16 shows the output after evaluation.

The appearance of the Tecplot output is uniform and there are barely erroneous vectors. However, the direction of the vector field does not match the actual direction of the flow of the Iowa River.

The wind driven capillary-gravitational waves recorded here are moving across the main direction of flow and the PIV software consequently determines an incorrect result. An arrow shows the actual direction of flow. Performing recordings under such conditions will yield in wrong or at least negatively affected recordings.

### Detection of Flow Direction

The advantage of SWIV is its versatility in terms of flow direction. The software will automatically determine the trend of the flow; actually it is not even an advantage to know about the direction in advance (see section 5.4.1).

For one example it was investigated, if even for the comparatively narrow flume the software could evaluate equal velocities in all directions around the fan. A recording above a moving water surface was done, but this time the evaluation was not only restricted to the centerline of the flume. The FIGS. 5.17 and 5.18 show the Tecplot output of such a recording and the definition of cross-sections that were investigated.

Besides the centerline three additional cross-sections at +45°, −45° and the spanwise direction (90°) were investigated for this purpose. Again, all the required data was taken out from the data file that was produced by the PIV software and inserted in a spreadsheet (FIG. 5.19).

The velocities for the cross-sections on the right side of the fan match very well. The celerities in spanwise direction show a different but constant appearance in terms of magnitude—velocities perpendicular to the actual flow were determined here. Furthermore the graph illustrates some obvious differences on the upstream side. Here the vectors along the centerline of the flume are lower in magnitude and more fluctuations could be observed.

However, an evaluation of the data material according to the usual procedure did yield in reasonable results. They are shown in Table 5.5.

TABLE 5.5
Overview about the evaluations for
several cross-sections of a flow

| | Cross-Section | | | | | |
|---|---|---|---|---|---|---|
| | Centerline | | +45° | | −45° | |
| Data used in range | Upstream and Downstream: 15-39 cm | | | | | |
| (from-to) | | | | | | |
| Ave. Velocity | 14.71 | cm/s | 15.43 | cm/s | 16.73 | cm/s |
| Upstream | | | | | | |
| Ave. Velocity | 34.09 | cm/s | 33.64 | cm/s | 34.21 | Cm/s |
| Downstream | | | | | | |
| Celerity of Waves | 24.40 | cm/s | 24.53 | cm/s | 25.47 | cm/s |
| (Fan) | | | | | | |
| Velocity of Flow | 9.69 | cm/s | 9.10 | cm/s | 8.74 | cm/s |
| (SWIV) | | | | | | |
| Vel. of Flow | — | | — | | — | |
| (LSPIV) | | | | | | |
| Vel. of Flow | 9.45 | cm/s | 9.45 | cm/s | 9.45 | cm/s |
| (Manometer) | | | | | | |

The velocity according to the data from the centerline was evaluated to 9.69 cm/s. This value matches well with the velocity obtained from the manometer reading (9.45 cm/s)¹⁹. Both velocities gained from cross-sections at an angle of 45 degrees yielded in lower magnitudes. Nonetheless, because these cross-sections do not follow the true direction of the flow in the flume somewhat lower results were expected in advance. A general trend is given and the method of SWIV could be proven to be independent from any direction of flow.
¹⁹ A LSPIV experiment as a second backup for the evaluation has not been carried out for this case.

5.6 Discussion

During the process of experimentation several problems and errors occurred that—if recognized—partially could be removed or kept small for all further tests. Thus, the preliminary experiments played an important role: Intended to find out about the most suitable recording conditions, the trial and error procedure also served as an instrument to detect shortcomings and the extent of their effects.

After an assessment of the quality of the experiments possible errors and shortcomings will be discussed. A summary of the limitations of the SWIV technique will conclude this chapter. Occurring problems and errors were classified and put into categories according to where they appeared. They took place during the experimental setup and procedure or during the evaluation of the data material with the PIV software (see Chapter 2.1.2).

### Correlation Analysis

A correlation analysis for all data sets gained during the experiments was carried out to assess their quality. In the Appendix the results for two correlations (with sorted data) are included. They show a comparison of the outcome of the SWIV technique with the discharge based and LSPIV based velocities respectively. Except for 2-3 significant errors (probably due to wrong manometer reading) a satisfying agreement of the results could be noticed.

### Optimum Experimental Setup

The component of illumination proved to be the most crucial in order to get high-quality data. The spot on top of the camera needs to be centered exactly above the camera; otherwise the reflections on top of the ripples will show different characteristics on either side, e.g. they would appear on different positions atop the wave (see FIG. 2.13). Furthermore the amount of achievable data would differ, because unequal amounts of reflections would be recorded on either side.

The video camera used during the research was attached to an arm that was reaching across the entire downstream side. This arm represented an obstacle, which caused some minor shadows in the area of interest. Even though the strength of the light source was very high and (due to bending) sufficient light rays provided an adequate illumination few recordings showed unsatisfactory results in this area: Single data points showed unreasonable and mostly far to small celerities. Basically, camera arm and the camera itself must be considered as blockages for a proper illumination. Further work must be done here to develop a non-interfering recording arrangement.

As mentioned in the Chapters 3 and 4 can a distorted recording area or an insufficient focused video camera lead to a falsified object-image ratio and thus to inexact results for the velocity.

The width of the flume (0.91 m) represented another limiting factor for the research. As can be seen in section 4.2.2 (Big fan) and 5.4.2 (Vorticity) the effects of wave reflections at the flume wall have been investigated. Their influence could be proved, yet for the small fan the impact of these reflections can be neglected. In field conditions they will not be present at all.

Some qualitative statements about suitable water properties were made in section 4.1.4, which mentioned the problem of shadows of the wave crests that were tracked at the flume bottom. Dying the water solved this problem (section 3.2.6).

Another observation that could be made regards the water surface itself: A thin film of dirt or dust that was floating atop the water surface can have a negative influence on potential reflections as well. Waves were still generated in this area but the properties of the wave changed. The mirror-like and smooth surface is covered by little particles that absorb the incoming light rays. As a result such areas were less likely to show homogenous reflections. Nonetheless, in the vicinity of the fan the water surface became “cleaned” due to the action of the wind stresses above the fluid.

Finally the importance of a correct setup of the fan has to be mentioned here. As was already pointed out in Chapter 3.2, the fan must point vertically towards the water surface. Otherwise the induced celerities will be different in magnitude in all directions around this energy source. The distance of the fan to the water surface needs also special attention: A very close fan might induce turbulences to the flow, while a fan set up too far away might be too weak to cause a homogenous wave pattern.

### Optimum Experimental Procedure

The correct order of experimental steps provided, satisfying and repeatable results can be achieved. The overview given in Chapter 5.1. (16 steps) proved as reliable algorithm for SWIV (and LSPIV) experiments.

Errors could have been caused by insufficient waiting times between consecutive recordings, e.g. the flow in the flume was not given enough time to settle. Before starting a new recording above an altered flow, a waiting time of at least 10 minutes has been kept. Nonetheless, this might have been an insufficient settling time for a very slow flow. After turning the fan on or off another 1 minute has been waited to be sure to record a constant ripple pattern or—in case of a LSPIV experiment—a mirror-like surface respectively.

### Optimum PIV Evaluation

The overall measurement accuracy in PIV is a combination of aspects extending from the recording process all the way to the methods of evaluation. A qualitative good recording still can be evaluated poorly. The preliminary experiments and their evaluation served as an excellent tool to make the required adjustments in the software settings to achieve best results later on. A large amount of literature exists about this topic that can also be applied to SWIV. It can be summarized, that for each type of experiment including PIV procedures new optimized settings have to be found first.

### Limitations of the SWIV Technique

The limitations of the SWIV method will be summarized here very briefly. The Chapters 5.4 and 5.5. basically comprise all advantages and drawbacks of the technique.

The new methods major drawback is its susceptibleness to any influences (e.g. an additional wind flow) that change the appearance of the water surface. Results will be evaluated inaccurate or even wrong. Gained data material has to be evaluated carefully—for our experiments the areas of useful data sometimes changed in size and position. Debris or dirt floating on the water will have an influence on the results with to a more or less severe extent. Insufficient illumination will yield in areas at which no or erroneous data can be evaluated only. Fast flows with velocities higher than the fan-induced celerity cannot be investigated. Very shallow, transparent flows can cause results deviating from the actual properties of the current.

These facts limit the SWIV application to field conditions with special properties. They have been mentioned in Chapter 1.

### 6. SUMMARY AND CONCLUSIONS

6.1 Summary

A new method capable of determining wave celerities and the free-surface velocity of an open-channel flow has been developed. The technique is based on the principles of image velocimetry and wave theory elements. This combination of underlying principles is reflected in the name of the method: Surface Wave Image Velocimetry (SWIV). SWIV stems from Large Scale Particle Image Velocimetry (LSPIV), an image-based method already successfully applied to a range of laboratory and field applications.

The motivation and objectives for this project are generated by a critical need in hydraulic measurements, namely, measurements of very low, and often time, shallow flows. For those situations, the available techniques are either inaccurate or impossible to use. Specifically, there are no means to measure free-surface velocity in natural scale low-velocity flows. Such conditions are common in lakes and marshes where the velocities are below 3 cm/s (most often near zero).

SWIV is not limited to the area of application mentioned above. SWIV is actually a general measurement method for wave velocities in field or laboratory. The relevance of the present study for the application of SWIV to measure wave celerities consists in the fact that it thoroughly delineates the optimum conditions required for illumination and recording. In addition it investigates some additional factors that can be encountered in the measurement of the wave velocities, such as the effect of wave- or current superposition.

For laboratory conditions, the only reliable measurement alternatives for low flows are PIV and LSPIV. However, especially for field conditions these modern techniques are expensive and complex to set up. The present innovation is also based on PIV concepts, however, it uses an inexpensive video-based system and conventional illumination.

In combination with a straightforward wave principle, the velocity of the free surface in a moving channel can be determined. A commercially available fan was used to create small but uniformly distributed capillary-gravitational waves on the water surface. With appropriate illumination typical reflections on each of these wavelets can be recorded by the camera and by using PIV software their velocity can be quantified.

The theoretical background of SWIV has been investigated in the second chapter. Typical PIV components illumination, seeding, recording and evaluation have been explained. An algorithm for PIV image processing and possible sources of errors for imaging techniques have been discussed. An overview about common modes of operation involving PIV serves as a transition to a detailed explanation of the technique of LSPIV—the method representing the origin of SWIV. Using an example from a previous paper the features, advantages and drawbacks of LSPIV have been explained.

A discussion about the wind-water interaction caused by the fan gives an insight about the processes occurring at the water surface. Wave properties and types of the induced waves are investigated, the difference between wave celerity and group velocity has been discussed in detail. Associated processes, such as wave generation and dissipation are also presented. Next, components of the SWIV technique and the underlying principles are discussed.

Following an introduction of the facilities provided by the IIHR, Chapter 3 details the SWIV experimental setup. The appropriate setup of the fan in the flume and its action above the water surface has been discussed. The steps of illumination, recording and evaluation for SWIV and LSPIV have been explained systematically. The particular steps of an appropriate data evaluation conclude this chapter.

Chapter 4 summarizes results and insights gained during the preliminary tests conducted in a systematic order. The tests aimed at improving the SWIV arrangement, minimizing errors, and finding the optimal parameters for the image processing. Various illumination settings and features of the fan were checked out parallel to an continuous improvement of the software settings. Laboratory as well as field experiments have been carried out during all stages of the development of the technique.

A thorough implementation of SWIV for measurements of the free surface velocity in an open channel flow is demonstrated in the next chapter. The complete experimental procedure is given before the purpose of the technique—determination of wave celerities and flow velocities—and its realization are explained comprehensively in the following sections. Additional results have been covered briefly before the particular features of SWIV are discussed in a detailed sensitivity analysis. Here the advantages but also shortcomings or limitations of the method have been shown. The following discussion is based on a correlation analysis.

Results have been found to be of a satisfying accuracy and in the following sections the optimal conditions for high quality evaluations have been given. Limitations of the SWIV technique—derived from the results of the sensitivity analysis—conclude the chapter about the implementation of the method.

6.2 Results & Conclusions

A new innovative technique for accurate determination of the free surface wave velocities was developed during this thesis. SWIV outgrows from the parent image-based technique, LSPIV that has been extensively tested in laboratory and field conditions for providing instantaneous velocity field on large areas in open channel flows. SWIV aims at providing the same results, but without use of seeding, which was one of the major LSPIV drawbacks when applied to natural scale flow measurements.

Seeding is replaced in SWIV by another approach of free surface tracking. Small perturbations (ripples or small waves) are artificially created on the free surface. Their movement is determined using conventional PIV principles. When the wave propagation superposes on an underlying channel flow, the resultant velocity incorporates both elementary motions. An ingenious technique design allows to accurately measure the underlying open channel velocity using the principle of motion superposition.

The thesis presents all aspects of the technique, i.e., underlying principles, optimal configurations and operating conditions, main and additional results, and limitations. The main conclusions regarding SWIV, as obtained during conduct of the study, are summarized below:
no need for seeding
simple to setup
flexible, cost- and time effective flow (and wave-) diagnostic tool
readily usable with minimum on site operations
self-contained
non-intrusive, two-dimensional velocity measurements
completely digital techniques with capabilities of on-line operation
easy to interpret raw information
inexpensive compared to alternative measurements
enable wave measurements, that are difficult to obtain with existing methods
can be applied for measurements of free surface velocities in open channel flows

Especially important is the capability of SWIV to measure velocities in very slow flows, where there are no alternative techniques.

The experimental investigation carried out during the thesis revealed that the current version of SWIV is still sensible to external influences. For instance an additional wind flow or insufficient illumination can cause spurious data or even a total loss of information about the flow. A careful setup of the system is a crucial step towards the acquisition of high-quality data. All limitations and advantages of the new technique have been shown and explained in detail.

6.3 Recommendations for Further Work & Outlook

The developed technique is an independent method encompassing principles of imaging techniques and wave theory elements. This new combination could develop to a challenging field for further applications. Especially the processes at the water surface (wind flow over capillary-gravitional ripples) deserve a closer investigation to be able to setup an experiment more advantageous.

So far the technique has been capable of providing high-quality results for laboratory conditions. A complete field experiment has not been done yet. The major drawback of SWIV, its susceptibleness and sensitivity to external influences, has to be solved first. This step should be carried out parallel to the development of a prototype for field applications. Designing such a prototype is basically a straightforward problem by appropriately scaling the lab setup.

The size of such a prototype could vary considerably. Starting from a small arrangement investigating a couple square meters much larger systems could be possible: From a helicopter, positioned a couple meters above the aquifer and inducing uniformly distributed waves, several hundred square meters of the water surface could be recorded and later evaluated. The feature of measuring wave celerities could enable the assessment of the processes along a shore and thus, e.g. enable qualitative statements about the sedimentation processes in this area.

SWIV has very promising potential for velocity measurements in laboratory and field conditions where free surface waves are present. Such a tool could become a powerful instrument in planning, design, operation, and management of water resources engineering works.

### 7 REFERENCES

7.1 Wave Theory & Wind-Water Interaction

[1] Banner, M. L., Peirson, W. L.: “Tangential stress beneath wind-driven air-water interfaces”, J. Fluid Mech., 1998, Vol. 364, pp. 115-145
[2] Crapper, G. D.: “Introduction to Water Waves”, Ellis Horwood Ltd., 1984, UK
[3] Crapper, G. D.: “An exact solution for progressive capillary waves of arbitrary amplitude”, J. Fluid Mech., 1957, Vol. 2, Part 6
[4] Dias, F., Kharif, C.: “Nonlinear gravity and capillary-gravity waves”, Annual Review of Fluid Mechanics, 1999, 31, pp. 301-346
[5] Gastel, K. V., Janssen, P. A. E. M., Komen, G. J.: “On phase velocity and growth rate of wind-induced gravity-capillary waves”, J. Fluid Mech., 1985, Vol. 161, pp. 199-216
[6] Ingard, K. U.: “Fundamentals of Waves and Oscillations”, Cambridge Univ. Press, 1988, UK
[7] Ippen, A. T.: “Estuary and Coastline Hydrodynamics”, McGraw-Hill Inc., 1966, USA
[8] Hara, T., Mei, C. C.: “Wind effects on nonlinear evolution of slowly varying gravity-capillary waves”, J. Fluid Mech., 1994, Vol. 267, pp. 221-250
[9] Henderson, F. M.: “Open channel flow”, MacMillan Series in Civil Eng., 1966, N.Y., USA
[10] Janssen, P. A. E. M.: “The period doubling of gravity-capillary waves”, J. Fluid. Mech., 1986, Vol. 172, pp. 531-546
[11]Kinsman, B.: “Wind Waves—their generation and propagation on the ocean surface”, Prentice-Hall Inc., 1965, USA
[12] Lighthill, J.: “Waves in Fluids”, Cambridge University Press, 1978, UK
[13] Miles, J. W.: “On the generation of surface waves by shear flows”, ???
[14] Nappo, C. J.: “An introduction to atmospheric gravity waves”, July 2001, ???
[15] Nicolas, K. R., Lindenmuth, W. T., Weller, C. S., Anthony, D. G.: “Radar imaging of water surface flow fields”, Experiments in Fluids 23, 1997, pp. 14-19
[16] Schooley, A. H.: “Relationship between surface slope, average facet size, and facet flatness tolerance of a wind-disturbed water surface”, J. of Geophys. Res., Vol. 66, No. 1, January 1961
[17] Valenzuela, G. R.: “The growth of gravity-capillary waves in a coupled shear flow”, J. Fluid Mech., 1976, Vol. 76, Part 2, pp. 229-250
[18] Zhang, X.: “Capillary-gravity and capillary waves generated in a wind wave tank: observartions and theories”, J. Fluid Mech., 1995, Vol. 289, pp. 51-82
   7.2 PIV & LSPIV
[19] Adrian, R. J.: “Particle-imaging techniques for experimental fluid mechanics”, Annual Review of Fluid Mechanics, 1991, 23, pp. 261-304
[20] Buchhave, P.: “Particle image velocimetry—status and trends”, Experimental Thermal and Fluid Science 5, 1992, pp. 586-604
[21]Creutin, J. D., Muste, M., Li, Z.: “Traceless quantitative imaging alternatives for free-surface measurements in natural streams”, 2002, ???
[22] Dantec Dynamics: “Non-invasive velocity measurement in microfluidic systems”, www.dantecdynamics.com
[23] Fujita, I., Aya, S.: “Refinement of LSPIV technique for monitoring river surface flows”, Proceedings of ASCE, Minneapolis, Minn., 2000
[24] Fujita, I., Tsubaki, R.: “A novel free-surface velocity measurement method using spatiotemporal images”, ???
[25] Gui, L., Merzkirch, W.: “A comparative study of the MQD method and several correlation-based PIV evaluation algorithms”, Experiments in Fluids, 28, 2000, pp. 36-44.
[26] Liu, Z.-C., Landreth, C. C., Adrian, R. J., Hanratty, T. J.: “High resolution measurement of turbulent structure in a channel with particle image velocimetry”, Experiments in Fluids 10, 1991, pp. 301-312
[27] Muste, M., Fujita, I., Ettema, R., Kruger, A.: “Particle-image velocimetry for whole field measurement of ice velocities”, Cold Regions Science and Technology 26, 1997, pp. 97-112
[28] Muste, M., Fujita, I., Kruger, A.: “Large-scale particle image velocimetry for flow analysis in hydraulic engineering applications”, J. of Hydraulic Res., Vol. 36, 1998, No. 3, pp. 397-414
[29] Muste, M., Xiong, Z., Kruger, A., Fujita, I.: “Error estimation in PIV applied to large-scale flows”, The 3^{rd} Int. Workshop on PIV, Santa Barbara, 1999, pp. 619-624
[30] Muste, M., Xiong, Z., Bradley, A., Kruger, A.: “Large-scale particle image velocimetry—a reliable tool for physical modeling”, Proceedings of ASCE, Minneapolis, Minn., 2000
[31]Raffel, M., Willert, C. E., Kompenhans, J.: “Particle image velocimetry: a practical guide”, Springer Verlag, N.Y., 1998
[32] Stevens, C., Coates, M.: “Applications of a maximized cross-correlation technique for resolving velocity fields in laboratory experiments”, Journal of Hydraulic Research, Vol. 32, 1994, No. 2, pp. 195-212
[33] Westerweel, J., Draad, A. A., Th. van der Hoeven, J. G., van Oord, J.: “Measurement of fully-developed turbulent pipe flow with digital particle image velocimetry”, Experiments in Fluids 20, 1996, pp. 165-177
[34]Willert, C. E., Gharib, M.: “Digital PIV”, Experiments in Fluids 10, 1991, pp. 181-193

[35] Zhang, X.: “Capillary-gravity and capillary waves generated in a wind wave tank: observations and theories”, J. Fluid Mech., 1995, Vol. 289, pp. 51-82

LIST OF SYMBOLS & ABBREVIATIONS

| | |
|---|---|
| x | Coordinate system: positive direction downstream |
| z | Coordinate system: positive direction from water |
| | surface upwards |
| v | Velocity, Celerity |
| vₓ | Velocity in x-direction |
| v_{y} | Velocity in y-direction |
| v_{Upstream} | Velocity on the upstream side of the fan |
| v_{Downstream} | Velocity on the downstream side of the fan |
| L, λ | Wave length |
| H, a | Wave height, amplitude |
| t | Time |
| ω | Radian Frequency |
| U | Group Velocity |
| T_{w} | Surface Tension of Water |
| Q | Discharge (of the pump) |
| F | Froude Number |
| IA | Interrogation Area |
| ADV | Acoustic Doppler Velocimetry |
| CCD | Charge Coupled Device |
| FPS | Frames per second |
| LDV | Laser Doppler Velocimetry |
| LSPIV | Large Scale Particle Image Velocimetry |
| LSV | Laser Speckle Velocimetry |
| NTSC | National Television System Committee |
| PAL | Phase Alternating Line |
| PIV | Particle Image Velocimetry |
| PTV | Particle Tracking Velocimetry |
| SWIV | Surface Wave Image Velocimetry |
| T | Wave period |
| h | Water depth |
| k | Wave Number |
| c | Wave Celerity |
| g | Acceleration due to gravity |
| ρ | Water density |
| Δh | Head (at the orifice) |
| R | Reynolds Number |
| Δt | Time interval between two frames |

1. A method of deriving velocities of free surface liquid flow comprising:
a. record successive images of a controlled surface wave on a free surface of an open channel flow sufficiently to identify spread of fronts of the controlled surface waves on the recorded images;
b. quantify velocity of the surface waves; and
c. infer a velocity vector field of underlying flow from the quantified velocity of the surface waves.

2. The method of claim 1 wherein the liquid flow is a water.

3. The method of claim 2 wherein the water is in a body of water.

4. The method of claim 1 wherein the liquid flow is can be between a relatively low rate and higher.

5. The method of claim 4 wherein the relatively low rate is approximately 0.5 cm per second.

6. The method of claim 1 wherein the liquid flow is nonexperimental.

7. The method of claim 6 where the nonexperimental liquid flow is in a river, lake, or marsh.

8. The method of claim 1 wherein the liquid flow is experimental.

9. The method of claim 1 wherein the controlled surface wave is of known properties.

10. The method of claim 1 wherein the controlled surface wave is naturally created.

11. The method of claim 10 wherein the natural creation of the controlled surface wave is by wind and/or gravity.

12. The method of claim 1 wherein the wave, at least in part, is artificially created.

13. The method of claim 12 wherein the artificial creation of the wave is nonintrusive.

14. The method of claim 12 wherein the artificial creation of the wave is with air pressure.

15. The method of claim 14 wherein the air pressure is created by a fan.

16. The method of claim 14 wherein the air pressure is created by a rotating helicopter rotor.

17. The method of claim 1 wherein the wave is a controlled pattern of surface waves.

18. The method of claim 17 wherein the pattern is concentric.

19. The method of claim 1 wherein the wave is multi-directional.

20. The method of claim 1 wherein the wave is a not multi-directional.

21. The method of claim 1 wherein the method of recording images is by vision or imaging system.

22. The method of claim 1 wherein the step of recording successive images is by video.

23. The method of claim 21 wherein the video is digital.

24. The method of claim 23 wherein the digital video has an appropriate resolution to distinguish the propagation of the surface waves.

25. The method of claim 1 wherein the successive images are taken at appropriate frames per second commensurate with the velocity of the surface waves.

26. The method of claim 1 wherein the resolution of the video sufficient to derive spread of fronts of the surface wave.

27. The method of claim 1 further comprising illuminating the controlled surface waves.

28. The method of claim 27 wherein the illumination is natural or ambient light.

29. The method of claim 27 wherein the illumination is artificial light.

30. The method of claim 29 wherein the artificial light is from the visible spectrum.

31. The method of claim 29 wherein the artificial light is from the non-visible spectrum.

32. The method of claim 31 wherein the light from the non-visible spectrum is ultraviolet light.

33. The method of claim 1 wherein the step of quantifying velocity comprises deriving propagation velocity or celerity of a said wave.

34. The method of claim 33 wherein two velocity components are measured.

35. The method of claim 34 wherein the two velocity components in a free surface plane are determined.

36. The method of claim 33 wherein quantification of velocity is by image velocimetry.

37. The method of claim 36 wherein the image velocimetry comprises an image velocimetry algorithm.

38. The method of claim 37 wherein the algorithm utilizes a directional approach.

39. The method of claim 37 wherein the algorithm utilizes a global approach.

40. The method of claim 1 wherein the velocity vector field is derived using wave theory elements or suitable calibrations.

41. The method of claim 40 wherein velocity vector field is resolved in the direction of flow of the controlled surface wave.

42. The method of claim 40 wherein the velocity vector field is derived in all directions.

43. The method of claim 40 wherein the velocity vector field is the total velocity vector of a moving body of water in laboratory or field conditions.

44. The method of claim 1 further comprising post-processing of the velocity vector field.

45. The method of claim 44 wherein the post-processing comprises filtering out parts of the images.

46. The method of 45 wherein the parts of the images comprise bottom or side reflections.

47. The method of claim 1 further comprising extrapolating information about the underlying flow of the liquid associated with the controlled surface wave.

48. The method of claim 1 wherein the free surface liquid flow is a body of water.

49. The method of claim 48 wherein the body of water can range from shallow to deep,

50. An apparatus for obtaining information useful to derive free surface velocity in an open channel flow of a moving liquid body comprising:
a. a controlled surface wave generating device to convert mechanical energy to a controlled surface waves on a free surface of an open channel flow;
b. an imaging device adapted to record successive images of the controlled surface waves with sufficient resolution to derive velocities of fronts of the controlled surface waves;
c. so that the images can be evaluated to (i) derive wave celerity and (ii) use celerity to derive a velocity vector field of flow of the liquid.

51. The apparatus of claim 50 wherein the controlled wave generating device comprises a non-intrusive mechanism to convert mechanical energy to air pressure energy.

52. The apparatus of claim 51 wherein the mechanism is a fan or blower.

53. The apparatus of claim 51 wherein the mechanism is a helicopter.

54. The apparatus of claim 50 wherein the control wave generating device comprises a mechanically movable portion applied to the liquid.

55. The apparatus of claim 54 wherein the mechanically movable portion is moveable with the liquid.

56. The apparatus of claim 54 wherein the mechanically movable portion is moveable into and out of the liquid.

57. The apparatus of claim 50 wherein the imaging device is a video camera.

58. The apparatus of claim 57 wherein the video camera is a digital video camera.

59. The apparatus of claim 57 wherein the resolution of the camera is sufficient to derive spread of fronts of the controlled surface waves.

60. The apparatus of claim 50 further comprising an illumination device.

61. The apparatus of claim 50 wherein the illumination device comprises a lamp capable of illuminating the liquid or part thereof.

62. The apparatus of claim 50 wherein the liquid is water.

63. The apparatus of claim 62 wherein the water is in a river, lake or marsh.

64. The apparatus of claim 50 further comprising a processor having software adapted to:
a. evaluate images from the imaging device by an image velocimetry algorithm to quantify propagation velocity or celerity of the controlled surface wave;
b. derive velocity vector field from quantify propagation velocity using wave theory elements or calibrations.

65. The apparatus of claim 64 wherein the image velocimetry algorithm comprises a directional approach or global approach.

66. The apparatus of claim 64 further comprising filtering out selected information from the images.

67. The apparatus of claim 64 further comprising extrapolating flow from the velocity vector field.

68. A system for gathering information useful to derive velocity of a free surface liquid flow comprising:
a. an air jet generator;
b. a video camera;
c. an illumination source;
d. the air jet generator adapted to produce a controlled surface wave;
e. the video camera having sufficient resolution to resolve spread of fronts of a controlled surface waves,
f. the illumination source enhancing resolution of fronts of a controlled surface waves.

69. The system of claim 68 further comprising a processor adapted to evaluate images from the video camera and perform image velocimetry to quantify celerity of the controlled surface wave and use wave theory elements or calibrations to infer velocity vector field of the liquid.

70. The system of claim 68 wherein the system is portable.

71. The system of claim 67 wherein the system is incorporated into a helicopter, the helicopter rotor comprising the air jet generator.

72. An apparatus for gathering information to derive velocities of a free surface liquid flow, comprising:
a. means for creating a controlled surface wave on the liquid flow;
b. means for capturing successive images of the controlled surface wave;
c. means for deriving celerity of the controlled surface wave and inferring velocity vector field for the liquid flow.

73. A method of determining a velocity vector field of a body of water, comprising:
a. creating a controlled surface wave on a free surface of an open channel flow;
b. quantifying velocity of the surface wave;
c. inferring velocity vector field of underlying flow.

74. The method of claim 73 wherein the directional approach is used.

75. The method of claim 73 wherein the global approach is used.

76. The method of claim 73 further comprising using video to capture images of the controlled surface wave.

77. The method of claim 73 further comprising post processing the video.

78. An apparatus for determining a velocity vector field of a body of water comprising:
a. a generator of an air jet capable of creating a pattern surface wave on the water;
b. a surface wave velocity measurement device based on imaging the surface wave.

79. The apparatus of claim 78 wherein the velocity measurement device is video.

80. The apparatus of claim 79 further comprising an illumination source used in combination with a video device to accentuate portions of the controlled surface wave.

81. The apparatus of claim 78 further comprising a processor having software adapted to derive velocity of the surface wave by image velocimetry to derive celerity, and to infer velocity vector field using wave theory elements or calibrations.
